(19) United States
(12) Patent Application Publication
(10) Pub. No.: US 2026/0115504 A1
(43) Pub. Date: Apr. 30, 2026

(54) MASKLESS RESPIRATORY, SKIN, AND EYE PROTECTION DEVICE FOR AEROSOLS AND VAPORS INCLUDING CHEMICAL, BIOLOGICAL, RADIOLOGICAL, NUCLEAR, AND EXPLOSIVE (CBRNE) CONTAMINANTS

(71) Applicant: Patient Knowhow, Inc., San Mateo, CA (US)

(72) Inventor: Devabhaktuni Srikrishna, San Francisco, CA (US)

(21) Appl. No.: 19/314,055

(22) Filed: Aug. 29, 2025

Related U.S. Application Data
(63) Continuation of application No. 19/245,714, filed on Jun. 23, 2025.
Application No. 19/245,714 is a continuation-in-part of application No. 18/913,327, filed on Oct. 11, 2024, now Pat. No. 12,343,573.

(51) Int. Cl. A62B 18/00; A62B 23/00

(52) U.S. Cl. CPC A62B 18/003; A62B 18/006; A62B 23/00

(57) ABSTRACT

A respiratory, skin, and eye protection device having at least one filter and at least one fan to maximize filtration while minimizing power consumption, noise generated, and device footprint. The least one filter is configured to simultaneously achieve an aerosolized particle contamination filtration efficiency of about 50% or greater for particles having a size of about 0.3 μm and a vapor contamination filtration efficiency of about 50% or greater for one or more of Novichok nerve agent (A232), thickened venomous nerve agent (TVX), sulfur mustard agent (HD), thickened sulfur mustard agent (THD), soman nerve agent (GD), and sarin nerve agent (GB). During the operation and monitoring of the respiratory, skin, and eye protection device, at least one fan is activated when concentrations of select aerosolized chemical, biological, radiological, nuclear, and explosive (CBRNE) agents are detected.

### CROSS-REFERENCE TO RELATED APPLICATIONS

The present invention is a continuation-in-part of U.S. application Ser. No. 18/913,327 filed on Oct. 11, 2024, the subject matter of which is herein incorporated by reference in its entirety.

### FIELD OF THE INVENTION

The present invention relates generally to a respiratory, skin, and eye protection device that utilizes an assembly comprising at least one filter and at least one fan to simultaneously protect against aerosolized and vapor contamination, including chemical, biological, radiological, nuclear, and explosive (CBRNE) agents, as well as a method of operating and monitoring thereof.

### BACKGROUND OF THE INVENTION

Chemical, biological, radiological, nuclear, and explosive (CBRNE) agents refer to hazardous materials, either naturally occurring or artificially produced, that can cause significant harm to humans (and animals) through chemical poisoning, biological infection, exposure to radioactive particles containing radioactive substances, or the fallout effects of a nuclear explosion.

In general, CBRNE agents may be delivered intentionally or released accidentally in the air in aerosolized or vapor form, or onto surfaces in liquid (condensed) form, which in turn evaporates at varying rates depending on the volatility of the agent.

Chemical, biological, or radiological agents include non-persistent (e.g. sarin nerve agent (GB)), persistent (e.g. venomous nerve agent (VX)), low-volatility (e.g. Novichok nerve agent (A232)), infectious (e.g. anthrax), contagious (e.g. coronavirus), and radioactive (e.g. cesium chloride), capable of being delivered by a variety of methods including airburst, ground burst, covert or unmanned aerial systems (UAS), drone, unexploded ordinances (UXO), and pandemics, etc.

Historically, CBRNE agents have been used in warfare, prompting militaries and medical treatment facilities to develop and implement protective systems to minimize casualties due to CBRNE incidents.

More recently, the public has become more aware of the threat of CBRNE agents due to the coronavirus (COVID-19) pandemic, prompting the widespread and increased use of respiratory, skin, and eye protection to include face masks (e.g., N95 respirators), goggles, and face shields.

CBRNE agents can enter the body through several different routes including inhalation, skin (percutaneously), eyes (ocular), gastrointestinal tract, injection, and irradiation. There has been a significant focus to develop respiratory protection systems since the amount of vapor or aerosolized CBRNE agent, when inhaled, is an order of magnitude lower (or more) compared to when absorbed through the skin or eyes, for initial symptoms, incapacitation, and/or death to occur.

Various forms of CBRNE protection exist to include collective protection (COLPRO) systems and individual protective equipment (TPE). Nevertheless, there are several shortcomings with existing COLPRO and IPE as explained below.

COLPRO systems provide safe indoor environments (e.g., in buildings, tents, containers, ground vehicles, ships, and aircraft) for individuals or assets against the threats posed by CBRNE incidents or attacks. Some common examples of COLPRO systems include filtration and ventilation systems for shared facilities and specially designed protective shelters or vehicles. However, there is varied use of COLPRO systems throughout the different branches of the United States military, and it is reported that only a fraction of command posts, medical treatment facilities treating, ships, and other critical infrastructure operate these COLPRO systems.

Even when COLPRO systems are in service, issues that may arise include interior contamination (e.g. clothing desorption), lengthy entry/exit procedures, cross-infection of contagious viruses/bacteria, and component-failures (e.g., malfunctioning of fans and filters).

COLPRO systems may use supplemental, continuous air cleaning, at a total clean airflow rate measured in cubic feet per minute, in a sealed room to remove vapor or aerosolized pandemic/CBRNE agents (contaminants) and reduce their ambient concentration. The air changes per hour (ACH) is defined as the total clean airflow rate divided by the volume of the room, expressed per hour. To use a nuclear analogy, the “half-life” of the contaminant concentration in the air (aerosol or vapor) is inversely proportional to the air changes per hour or ACH (=logₑ(2)/ACH) of the air cleaning. The half-life illustrates that the higher the ACH, the faster any “vapor spikes” or aerosol spikes are mixed, diluted, and attenuated, which reduce cumulative exposure to room occupants. In steady state, the residual level of particle concentration remaining depends directly on the rate of contaminant entry into the room (leak) or bioaerosol exhalation by the infected person(s), and inversely on the total clean airflow rate (e.g., the product of the ACH and the volume of the room). A higher air changes per hour (ACH) rate in a room increases the protection factor against aerosol and vapor spikes by reducing contaminant concentrations more rapidly, thereby lowering the dose inhaled or absorbed by occupants. For example, there was a 50-fold reduction in an unsealed, leaky household room of particles having a size of 0.3 μm (e.g., the most penetrating particle size, explained more below) within 40 minutes after closing the windows and then running 9 ACH of air filtration.

Even so, a typical COLPRO system at about 5 ACH does not fully address cross-infection among occupants especially at close-contact. Asymptomatic, contagious viruses/bacteria can infect without early warning from obvious symptoms (e.g. coronavirus) via lungs or eyes, especially if prolonged or at close-range requiring use of respirators or full-face protection. Nevertheless, with some exceptions, a rate of more than 5 ACH of filtered, recirculated air using centralized heating ventilation and air conditioning (HVAC) systems is uneconomical because the cost of energy needed to transport the air remotely to an HVAC rises approximately as the cube of ACH (ACH³). This is not including the costs of conditioning the air temperature at these higher airflow rates. COLPRO systems also use central filtration and a protective membrane (or is sealed to prevent outdoor contamination from entering inside), both single points of failure that further require excess power to overcome airflow resistance for transporting air to each room (via long, narrow hoses or ducts).

The techniques, technologies, and real-world constraints to solve toxic aerosol and vapor problems for the military also have similarities with civilian applications and vice versa. In January 2025, the fires in Los Angeles, CA resulted in both aerosol and vapor toxicity on a metropolitan scale and exposed the difficulties of IPE (e.g. N95) because it could not be worn 24×7 in homes/shelters, necessitating capabilities similar to indoor COLPRO as used by the military. COLPRO protects tightly sealed indoor spaces from toxic aerosols and vapors simultaneously for relief from the burdens of continuous IPE use, but many (if not most) rooms are loosely sealed with leaks and gaps to the outdoors or other adjacent rooms. In addition to aerosol (particulate) pollution from wildfire smoke, in the weeks after the January 2025 fires in the Los Angeles, CA, area residents reported a persistent “smell” which was suspected to have included volatile organic compounds from the smoke adsorbed into objects in their local environment (ground, buildings, etc.), which subsequently desorbed over a prolonged period. Even when there is not an emergency, several aerosols and vapors can be persistently present indoors with varying degrees of toxicity that need to be removed from the volume of occupied indoor spaces with an indoor air filtration system.

The removal rate, measured as air changes per hour (ACH) separately for both aerosols and vapors, needs to be efficient in terms of not only initial cost but also operational burden imposed on end-users of the indoor air filtration system. For an indoor air filtration system, achieving a fixed air changes per hour (ACH) requires scaling up the indoor air filtration system's clean air delivery rate (CADR) in units of cubic feet per minute (CFM) separately for both aerosols and vapors proportional to the volume of the room. However, this needs to be accomplished without excessively scaling up any of the trifecta, i.e., the (1) power consumed in watts (2) noise generated in dBA, and (3) floorspace/volume taken up in square feet and cubic feet respectively, of the indoor air filtration system. Conversely, an indoor air filtration system becomes unscalable/unsuitable especially for larger rooms if designed inefficiently in terms of the following metrics: CFM per watt, CFM per dBA, CFM per square foot, or CFM per cubic foot. The major challenge faced by those of ordinary skill in the art to design a highly efficient indoor air filtration technology simultaneously for aerosols and vapors in terms of the trifecta represented by these metrics can be explained by the following vicious cycle: each extra layer of particulate and vapor contamination filter material added to an airstream (in series) to increase filtration efficiency also introduces air resistance, which in turn decreases airflow velocity (and CADR), and therefore must be then counteracted by increasing fan airflow and air pressure, which in turn increases power consumed, noise generated, and/or size (floorspace/volume) which can make the system inefficient. This “filtration-compactness” challenge is left unaddressed in the prior art whereas the novel elements of the present invention directly overcome this challenge for the first time to the best of the inventor's knowledge.

For example, U.S. Pat. No. 10,774,846 to Hur et al., the subject matter of which is herein incorporated by reference in its entirety, does not address this filtration-compactness challenge. Fan Filter Assembles (FFAs), a variation of the system described by Hur et al., are used in COLPRO systems and are externally placed to circulate filtered air into tightly sealed indoor spaces requiring protection, as described in “Security Engineering: Procedures from Designing Chemical, Biological, and Radiological Protection for Buildings” by the U.S. Army Corps of Engineers, the subject matter of which is herein incorporated by reference in its entirety. Advertised specifications of FFAs from military manufacturers in multiple sizes are shown in the table below, using one or more aerosol and vapor contamination filters with ASZM-TEDA (e.g., M98 and M48) and mixed-flow or centrifugal fans for simultaneous aerosol/vapor removal of chemical agents such as Novichok nerve agent (A232), thickened venomous nerve agent (TVX), sulfur mustard agent (HD), thickened sulfur mustard agent (THD), soman nerve agent (GD), and sarin nerve agent (GB).

| | CADR | | Length × | |
|---|---|---|---|---|
| | (advertised | Power | Width × | |
| FFA | for aerosols | consumed | Height (in | Noise |
| Model | and vapors) | (approximately) | inches) | Generated |
| FFA-100 | 100 CFM | 400 Watts | 24 × 15 × 15 | Not Available |
| FFA-400 | 400 CFM | 2400 Watts | 37 × 31 × 30 | 75 dBA |
| FFA-580 | 600 CFM | 1600 Watts | 62 × 25 × 37 | Not Available |
| FFA-1000 | 1000 CFM | 2000 Watts | 83 × 25 × 37 | Not Available |

An M98 filter is a substantially cylindrical filter about 22 inches in diameter and about 10 inches height manufactured to specifications defined by the U.S. Army. Similarly, an M48 filter is a cylindrical filter about 12 inches in diameter and about 13 inches height manufactured to specifications defined by the U.S. Army. In theory, an FFA system could in principle be repurposed such that the inlet and outlet thereof recirculate indoors to function similar to a portable air cleaner. However, in the inventor's opinion, it would not have been apparent to the skilled artisan to know how to overcome FFA's excessive power consumption while also overcoming the air resistance of the cylindrical filters (in addition to FFA's excessive volume or floorspace consumption) based on an understanding of the currently available technology. This presents difficulties to scaling up FFAs for use as indoor filtration systems of leaky rooms in remote locations, such as a forward operating base or a tactical operations center, where power may be scarce and/or costly and space may be limited, especially if multiple FFAs are required to achieve the desired ACH.

In addition to military suppliers, several commercially available systems for simultaneous aerosol and vapor filtration were surveyed by the Bay Area Air District. These commercially available systems are described in “BAAQMD Portable Air Cleaner Bulk Pricing List,” authored by the Bay Area Air District, the subject matter of which is incorporated by reference in its entirety, with the advertised clean air delivery rate (CADR) for each model noted in CFM. However, these advertised CADR values are typically tested for aerosol filtration only (sometimes referred to as “HEPA filter”) where the filter exceeds aerosolized contamination filtration efficiency of about 50% or greater but not simultaneously for vapor filtration. In many such air filtration systems, the vapor filtration is typically at a much lower CADR due to the insufficient quantity of activated carbon incorporated into the vapor filter (sometimes referred to as “Carbon filter”) by the manufacturer, resulting vapor contamination filtration efficiency of less than 50%. Whereas if more activated carbon were added to increase the vapor filtration efficiency, the air resistance of the combined aerosol/vapor filter increases reducing the advertised CADR. Furthermore, when such systems are independently tested by industry standard certification, they typically are tested in test chambers having a size of about 1,000 cubic feet (1,008 cubic feet) as described in “Frequently Asked Questions about Testing of Portable Air Cleaners,” authored by the Association of Home Appliance Manufacturers (AHAM), the subject matter of which is incorporated by reference in its entirety. Such tests chambers of about 1,000 cubic feet can be too small to observe the differences in CADR arising from mixing of a moving airstream that also allows particles and vapors to enter (mix) from adjacent, stationary contaminated air. Due to such mixing effects, higher airspeed at the outlet directed away from the inlet of the air filtration system can improve the CADR significantly but may only be observable in more typically sized rooms having a volume about 2,000 to 3,000 cubic feet or greater.

Individual protective equipment includes protective clothing, protective masks (e.g., respirators such as an N95 respirator and gas masks such as a M50 Joint Service General Purpose masks), decontamination and first-aid kits, detectors (e.g., Joint Chemical Agent Detectors (JCADs)), and dosimeters to protect individuals against CBRNE agents.

Mission oriented protective posture (MOPP) gear is a subset of IPE worn by military forces to operate in a CBRNE environment and is classified based on the level of protection to include MOPP Ready (e.g., protective mask carried and suit, gloves, and boots are available within a certain amount of time) and MOPP Level 0 (e.g., no protection worn, a protective mask is carried, and suit, boots, and gloves are immediately available) through MOPP Level 4 (e.g., all protection worn).

During a CBRNE incident, it is oftentimes recommended to shelter-in-place (SIP), i.e., taking refuge in a small interior room with no or few windows, or closed windows/doors. However, unless inside a COLPRO system for the entire period, individual protective equipment will be required for several hours or days while sheltering-in-place, which is unsustainable for most people over extended periods.

Additionally, extended IPE use by personnel can lead to heat build-up, physical exertion, breathing resistance, reduced mobility and flexibility, human error, hunger, and thirst, which will cause personnel to seek a clean environment or otherwise risk CBRNE exposure when eating, hydrating or going to the bathroom. The use of IPE for prolong periods also can result in “severely degraded” work rates from fatigue, mistakes, and heat/humidity stress in warmer climates within 24 to 36 hours. Furthermore, persistent CBRNE agents have a 1-to-4-day period of unpredictable “vapor spikes” or undetectable low levels but may otherwise be cumulatively symptom-inducing, incapacitating, or amount to a lethal exposure. The residual hazard of off-gassing from CBRNE agent deposits on outdoor or indoor surfaces in various locations remain for extended periods and may change with wind direction. Furthermore, each subsequent CBRN incident/attack will restart this clock, prolonging the requirement to use IPE.

There is also the issue of insufficient early warning to don protective masks or other IPE. For instance, the United States military heavily relies on the JCAD for point detection (i.e., detecting hazards on a surface or in the air, such as in a room, requiring close proximity to the target). The JCAD is a device that automatically detects, identifies, and alerts operators to the presence of chemical warfare agents (e.g., nerve and blister vapors), as well as at least one blood chemical agent vapor and at least one toxic industrial chemical vapor. However, the JCAD can only detect vapor agents and there are a limited number of these detectors in the inventory. It especially becomes problematic to determine the level of IPE protection required for military forces and the civilian population when the concentration of the CBRNE agent in the air is initially unknown.

Even when early warning of exposure to a CBRNE agent is provided, the military standard of 8 or 9 seconds of putting on a protective mask during apnea (i.e., while not breathing) can still result in symptoms or incapacitation if the concentration of detected agent in the air (e.g., sarin and VX) is high enough. Most civilians typically do not have gas masks, respirators, or COLPRO nor have the training to use and operate them. The latency will increase further if the gas mask is out of reach or if the gas mask is not ready to don, and if the servicemember (or civilian) is sleeping (adding 1 to 2 seconds for adults to wake up to an alarm).

Respirators such as N95 masks remain useful for reducing risk to both near-field and far-field exposures, whereas air filtration can mitigate far-field exposure in a well-mixed environment. However, most personnel cannot wear respirators for an extended period, nor can they be worn continuously under all circumstances such as while sleeping, eating, or undergoing dental procedures. In addition, respirators can add breathing resistance, may become intolerably hot in warm climates, may cause skin irritation, conceal facial expression and lips (for lip reading), and may cause difficulty with people hearing the user of the respirator speak. Ceiling fans can mitigate this shortcoming of indoor air cleaning, without using respirators or other IPE, by displacing accumulations of infectious particles near high-emitting infectors. For example, a mannequin placed directly underneath a ceiling fan was exposed to about 95% fewer aerosol particles from a simulated cough 5 feet away when the fan was on compared to when it was off. However, there was only a 20% reduction when the mannequin was not directly underneath the ceiling fan. Even with ceiling fans properly positioned, indoor air cleaning at sufficiently high ACH is still necessary to remove the displaced bioaerosols from accumulating in the room.

As another option, portable air filters can be used economically, to push above 5 ACH to 12 ACH and beyond, for in-room air cleaning methods. The cost of recycling indoor air, by locally cleaning it within the same room rather than in a remotely located HVAC system, scales up linearly proportional to target ACH (ACH to the power of 1 or ACH¹). Portable air cleaners usually include at least one filter and at least one fan inside an enclosure. Fault-tolerance with portable air cleaners is based on a leak-resilience principle: quick dilution and removal of chemical and particle emissions, both external and internal with supplementary air filtered exchanges. Portable air cleaners are able to improve fault-tolerance, power-efficiency, and reduce CBRNE exposure by orders of magnitude using decentralized, directionally-optimized air filtration elements in each room. Working together, portable air cleaners can combine to reach an ACH of more than 10 (like passenger jets in flight resilient to leaks in airframes and internal sources) and protection can be economically scaled up past central filtration such as used in COLPRO systems.

The clean air delivery rate (CADR) is a measurement of how well a portable air filter removes air contamination inside a room. Existing portable air filters either are too noisy, take up too much space within a room, or are too expensive. It is thus desirable to maximize the CADR (and the ACH) while minimizing the portable air filter footprint (e.g., for berths on a ships and submarines), the noise produced, the energy used (power consumed), the procurement cost, and the consumable filter cost.

Based on the supply chain issues that arose during the coronavirus pandemic, there is a need to develop a respiratory, skin, and eye protection device, as an alternative to traditional IPE and COLPRO systems, that rely on more readily available filters and fans and that have a secondary market to enable surge scalability when needed.

There is also a need for a respiratory, skin, and eye protection device that can overcome the shortcomings of conventional IPE and COLPRO systems for use as a substitute to or in conjunction with existing technology, while also effectively protecting a user from select vapor and aerosolized CBRNE agents.

### SUMMARY OF THE INVENTION

It is an object of the present invention to provide an improved respiratory, skin, and eye protection device for reducing near-field and far-field exposure to select vapor and aerosolized CBRNE agents. The improved respiratory, skin, and eye protection device can protect in circumstances where traditional respiratory (e.g., N95, gas mask), skin protection (e.g., body suit), and eye protection (e.g., goggles) becomes difficult to use such as while sleeping, eating, or undergoing dental procedures. In addition, respirators can add breathing resistance, may become intolerably hot in warm climates, may cause skin irritation, conceal facial expression and lips (for lip reading), and may cause difficulty with people hearing the wearer speak.

It is another object of the present invention to provide an improved respiratory, skin, and eye protection device by increasing the air contamination filtration efficiency using a stacked fan and filter assembly.

It is still another object of the present invention to provide an improved respiratory, skin, and eye protection device that can provide respiratory, skin, and eye protection for a user from select vapor and aerosolized CBRNE agents without the need of having to don (additional) individual protective equipment (IPE).

It is still another object of the present invention to provide an improved respiratory, skin, and eye protection device that can provide long-term respiratory, skin, and eye protection for a user from select vapor and aerosolized CBRNE agents while maximizing comfort.

It is still another object of the present invention to provide an improved modular filter assembly for filtering contamination from ambient air in the surrounding environment.

It is still another object of the present invention to provide an improved modular filter assembly for filtering contamination from ambient air in the surrounding environment that takes up less floor space and volume, generates less noise, and is more power-efficient, about an order of magnitude more power-efficient than prior art such as collective protection (COLPRO).

It is still another object of the present invention to provide an improved modular filter assembly that is about an order of magnitude more power-efficient than prior art filter assemblies such as collective protection (COLPRO).

To that end, the present invention relates generally to a personal respiratory, skin, and eye protection device comprising:
a frame for accommodating a user of the respiratory, skin, and eye protection device;
an air processing assembly comprising:
   an air processing assembly inlet for receiving ambient air;
   an air processing assembly outlet;
   at least one fan that generates an airflow in an inhalation zone of the user during inhalation; and
at least one filter stacked together with the at least one fan between the air processing assembly inlet and the air processing assembly outlet in a stacking direction, wherein the air processing assembly is disposed above the inhalation zone with respect to the direction of the airflow generated by the at least one fan in the inhalation zone, wherein the air processing assembly is in-line with the inhalation zone,
wherein the at least one filter reduces contaminated air in the inhalation zone and comprises an aerosolized particle contamination filter configured to achieve an aerosolized particle contamination filtration efficiency of about 50% or greater for particles having a size of about 0.3 μm,
wherein substantially all air released from the air processing assembly outlet in the inhalation zone has been filtered by the at least one filter, and
wherein the air processing assembly is coupled to the frame and processes substantially all ambient air in a direction of generated airflow by the at least one fan before entering the inhalation zone.

The present invention also relates generally to a modular filter assembly for filtering contamination from ambient air in the surrounding environment defined to be a region of ambient air within about 3 feet of the modular filter assembly and outside the modular filter assembly, comprising:
at least one fan with a maximum diameter less than about 30 inches as measured perpendicular to the rotational axis of the at least one fan;
at least one substantially cylindrical filter with maximum diameter between about 8 inches and about 30 inches, wherein at least one of the at least one substantially cylindrical filter comprises an aerosolized particle filter,
wherein at least one of the at least one substantially cylindrical filter comprises a vapor contamination filter, wherein the vapor contamination filter comprises activated carbon;
at least one inlet for receiving ambient air from the surrounding environment;
at least one outlet for releasing filtered air into the surrounding environment;
wherein the at least one fan is stacked with the at least one substantially cylindrical filter, wherein a cross-sectional shape of the substantially cylindrical filter is one of substantially circular, substantially square, substantially triangular or any other similar cross-sectional shape known to the skilled artisan, wherein a rotational axis of the at least one fan is substantially parallel to a central axis of the at least one substantially cylindrical filter,
wherein at least one point of the inlet and at least one point of the outlet are within about 30 inches of the central axis of the at least one substantially cylindrical filter,
wherein the airspeed is about 500 feet per minute or greater as measured within about 3 inches of the vertices of an equilateral triangle with side of length between about 7 inches and about 26 inches whose plane is substantially perpendicular to the central axis of the at least one substantially cylindrical filter and within one inch of where the at least one fan exchanges air with the immediately surrounding environment,
wherein the airspeed is about 10 feet per minute or greater as measured within about 3 inches of the vertices of an equilateral triangle with side of length between about 7 inches and about 26 inches whose plane is substantially perpendicular to the central axis of the at least one substantially cylindrical filter and within about one inch of where the at least one substantially cylindrical filter exchanges air with the immediately surrounding environment,
wherein the airspeed as measured simultaneously at another point in the immediately surrounding environment is less than about 10 feet per minute,
wherein the at least one fan substantially generates a filtered airflow at the outlet that has been substantially filtered by the at least one substantially cylindrical filter,
wherein the filtration efficiency of the filtered airflow is about 50% or greater as measured with a test aerosol comprised of particles having a size of about 0.3 microns relative to the test aerosol concentration outside the immediately surrounding environment, and
wherein the filtration efficiency of the filtered airflow is about 50% or greater as measured with test vapor relative to the test vapor concentration outside the immediately surrounding environment.

The present invention also relates generally to a modular filter assembly for filtering contamination from ambient air, comprising:
a modular filter assembly inlet for receiving ambient air;
a modular filter assembly outlet; and
at least one radiator fan stacked with at least one filter between the modular filter assembly inlet and the modular filter assembly outlet,
wherein the at least one filter comprises one or more filter cartridges,
wherein each of the one or more filter cartridges comprises a vapor contamination filter layer,
wherein the vapor contamination filter layer comprises an activated carbon layer,
wherein the at least one filter is configured to achieve a vapor contamination filtration efficiency of about 50% or greater,
wherein a seal is interposed between the at least one filter and the at least one radiator fan to substantially seal an interface therebetween; and
wherein the modular filter assembly substantially releases air in a surrounding environment that has been filtered by the at least one filter.

The present invention also relates generally to a stackable assembly for filtering contamination from ambient air:
two lateral components;
a front component comprising at least one front seal capable of sealing or substantially sealing an interface between the front component and the two lateral components;
a back surface that does not comprise an aerosolized contamination filter; and
a top plate comprising a top seal for sealing or substantially sealing an interface between the top plate, the two lateral components, and the front component; and
a bottom plate comprising a bottom seal for sealing or substantially sealing an interface between the bottom plate, the two lateral components, and the front component,
wherein at least one of the two lateral components and the front component comprises at least one filter and at least one fan,
wherein the at least one filter comprises an aerosolized contamination filter configured to achieve an aerosolized contamination filtration efficiency of about 50% or greater for particles having a size of about 0.3 μm.

The present invention also relates generally to a fan outlet shroud for a stacked filter and fan assembly comprising:
a base plate for covering an outlet of at least one fan, wherein a center of the base plate comprises a circular aperture, wherein a diameter of the circular aperture is smaller than a diameter of the outlet of at least one fan; and
an extension attached to the base plate at the circular aperture forming a sealed or substantially sealed connection, wherein the extension comprises a channel extending the length of the extension substantially through the center of the extension, wherein the at least one fan generates an airflow through the channel and the circular aperture.

The present invention also relates generally to a containment apparatus for enclosing a hazardous material emitting air contamination comprising:
an enclosure for isolating the hazardous material comprising:
   at least three closed faces comprising a transparent material, wherein a sealed or substantially sealed connection is formed between each of the at least three closed faces, and
   an open face for receiving the hazardous material when a periphery of the open face contacts a surface supporting the hazardous material, wherein the periphery of the open face comprises a sealant for forming a sealed or substantially sealed connection between the enclosure and the surface; and
an air processing assembly disposed on or enclosed within the enclosure comprising:
   an air processing assembly inlet for receiving contaminated air in the enclosure,
   an air processing assembly outlet, and
   at least one fan and at least one filter coupled together between the air processing assembly inlet and the air processing assembly outlet,
wherein the at least one filter reduces contaminated air in the enclosure and comprises a vapor contamination filter configured to achieve a vapor contamination filtration efficiency of about 50% or greater for one or more of Novichok nerve agent (A232), thickened venomous nerve agent (TVX), sulfur mustard agent (HD), thickened sulfur mustard agent (THD), soman nerve agent (GD), and sarin nerve agent (GB), and
wherein the air processing assembly outlet only releases air in the enclosure that has been filtered by the at least one filter.

### BRIEF DESCRIPTION OF THE DRAWINGS

The drawings described herein are for illustrative purposes only of selected embodiments and not all possible implementations and are not intended to limit the scope of the present disclosure.

The above set forth and other features of the present invention are made more apparent in the ensuing the Detailed Description of the Preferred Embodiments when read in conjunction with the attached Drawings, wherein:

FIG. 1 depicts a side view of respiratory, skin, and eye protection devices, in accordance with an embodiment of the present invention.

FIG. 2 depicts a side view of a respiratory, skin, and eye protection device, in accordance with an embodiment of the present invention.

FIG. 3 depicts a side view of a respiratory, skin, and eye protection device, in accordance with an embodiment of the present invention.

FIG. 4 depicts a top view of a respiratory, skin, and eye protection device, in accordance with an embodiment of the present invention.

FIG. 5 depicts a perspective view of a bottom of a respiratory, skin, and eye protection device, in accordance with an embodiment of the present invention.

FIG. 6 depicts a perspective view of a respiratory, skin, and eye protection device, in accordance with an embodiment of the present invention.

FIG. 7 depicts a perspective view of a respiratory, skin, and eye protection device, in accordance with an embodiment of the present invention.

FIG. 8 depicts a perspective view of a respiratory, skin, and eye protection device, in accordance with an embodiment of the present invention.

FIG. 9A depicts a side view of a respiratory, skin, and eye protection device, in accordance with an embodiment of the present invention.

FIG. 9B depicts a side view of a respiratory, skin, and eye protection device, in accordance with an embodiment of the present invention.

FIG. 10 depicts a side view of a respiratory, skin, and eye protection device, in accordance with an embodiment of the present invention.

FIG. 11A depicts a top view of a radiator fan, in accordance with an embodiment of the present invention.

FIG. 11B depicts a top view of a mixed-flow fan, in accordance with an embodiment of the present invention.

FIG. 11C depicts a connection means, in accordance with an embodiment of the present invention.

FIG. 11D depicts a connection means, in accordance with an embodiment of the present invention.

FIG. 12 depicts a perspective view of a filter, in accordance with an embodiment of the present invention.

FIGS. 13A-B depict a perspective view of respiratory, skin, and eye protection devices, in accordance with an embodiment of the present invention.

FIG. 14 depicts a perspective view of a respiratory, skin, and eye protection device, in accordance with an embodiment of the present invention.

FIG. 15 depicts a perspective view of a respiratory, skin, and eye protection device, in accordance with an embodiment of the present invention.

FIG. 16A depicts is a top view of a fan shroud base plate, in accordance with an embodiment of the present invention.

FIGS. 16B-C depict a perspective view of fan shrouds, in accordance with an embodiment of the present invention.

FIGS. 17A-B depict a perspective view of a fan shroud, in accordance with an embodiment of the present invention.

FIG. 18 depicts a perspective view of a respiratory, skin, and eye protection device, in accordance with an embodiment of the present invention.

FIG. 19 depicts a top view of a respiratory, skin, and eye protection device in a disassembled state, in accordance with an embodiment of the present invention.

FIG. 20 depicts a flowchart showing a method of monitoring and operating one or more respiratory, skin, and eye protection devices based on a current value of the at least one fan, in accordance with some embodiments.

FIG. 21 depicts a flowchart showing a method of monitoring and operating one or more respiratory, skin, and eye protection devices based on at least one aerosol/vapor detection sensor, in accordance with some embodiments.

FIGS. 22A-B depict examples of a decay curve and fit minimizing the sum of percent error for aerosol (FIG. 22A) and vapor (FIG. 22B) measurements.

FIG. 23 depicts examples of the simultaneous change in vapor and aerosol CADR measurements alongside the power consumed.

Identical reference numerals in the figures are intended to indicate like parts, although not every feature in every figure may be called out with a reference numeral.

### DETAILED DESCRIPTION OF THE PREFERRED EMBODIMENTS

The inventor of the present invention has found that respiratory, skin, and eye protection devices for protection against select vapor and aerosolized CBRNE agents utilizing different configurations of fans and filters that require less power to operate and utilize less expensive materials, while generating less noise and providing superior comfort to a user during extended use.

The inventor of the present invention has also found that these respiratory, skin, and eye protection devices can achieve a high air contamination filtration efficiency of specific vapor and aerosolized CBRNE agents posing a threat to national security.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected.

It should be understood that the disclosed embodiments are merely illustrative of the present disclosure, which may be embodied in various forms.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−30% or less, +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, and the like, are used for ease of description to describe one element or feature's relationship to another element(s) or feature(s). It is further understood that the terms “front” and “back” are not intended to be limiting and are intended to be interchangeable where appropriate.

As used herein, the terms “comprise(s)” and/or “comprising,” specify the presence of stated features, integers, steps, operations, elements, and/or components, but do not preclude the presence or addition of one or more other features, integers, steps, operations, elements, components, and/or groups thereof.

As used herein, the term “electrically connected” refers to a connection that supplies power to a device from a source like a wall outlet or battery, a connection that supplies a signal, such as voice, video, and data, and combinations of one or more of the foregoing.

As used herein, the term “substantially the same size” and the term “substantially” with respect to any dimension recited herein refers to within +/−1 inch of the size. In other embodiments, however, where the term “substantially the same size” is indicated herein, the measurements or position may be within about 1/64, about 1/32, about 1/16, about ⅛, about ¼, about ⅜, about ½, about ⅝, about ¾, about ⅞, about 1.25, about 1.5, about 1.75, or about 2 inches or less, as other examples, or within about 1, about 5, about 10, about 15, about 20, about 25, about 30, about 40, or about 50 percent (%), as still other examples.

As used herein, the term “substantially through the center” refers to within +/−1 inch of the center. In other embodiments, however, where the term “substantially through the center” is indicated herein, the measurements or position may be within about 1/64, about 1/32, about 1/16, about ⅛, about ¼, about ⅜, about ½, about ⅝, about ¾, about ⅞, about 1.25, about 1.5, about 1.75, or about 2 inches or less, as other examples, or within about 1, about 5, about 10, about 15, about 20, about 25, about 30, about 40, or about 50 percent (%), as still other examples.

As used herein, the term “substantially perpendicular” refers to within about a 20 degree angle of being perpendicular. In other embodiments, however, where a “substantially perpendicular” is indicated herein, the measurements or position may be within about 1, about 5, about 10, about 15, about 20, about 25, or about 30 degrees of being perpendicular, as other examples, or within about 1, about 5, about 10, about 15, about 20, about 25, about 30, about 40, or about 50 percent (%) of being perpendicular, as still other examples.

As used herein, the term “substantially sealed” refers to the amount of permitted gas or air that is able to pass through an interface to be within about 0.001, about 0.01, about 1, about 2, about 10 percent, or about 25 percent of the amount of permitted gas or air that is able to pass through an unsealed interface.

As used herein, unless otherwise defined above, the terms “substantial” and “substantially” refer to within about 70 percent or more of the total amount. In other embodiments, however, the term “substantial” and “substantially” refer to about 75, about 80, about 85, about 90, about 95, or about 99 percent (%) or more.

As used herein, the term “filtration efficiency” refers to the percentage (%) of containment removed by the at least one filter.

As used herein, the term “immediately surrounding environment” is referred to be a region of ambient air within about 5 feet, about 4.75 feet, about 4.50 feet, about 4.25 feet, about 4.00 feet, about 3.75 feet, about 3.50 feet, about 3.25 feet, about 3 feet, about 2.75 feet, about 2.50 feet, about 2.25 feet, about 2.00, about 1.75 feet, about 1.50, about 1.25 feet, or about 1.00 foot of the modular filter assembly and outside of the modular filter assembly.

As used herein, the term “mixed-flow fan” refers to a fan in which air flows through the impeller or skewed fan blade in a direction that is intermediate between purely axial (parallel to the fan shaft) and purely radial (perpendicular to the fan shaft).

As used herein, the term “respiratory, skin, and eye protection device” refers to one or more of an air processing assembly, a personal respiratory, skin, and eye protection device, a modular filter assembly, a wall-adjacent portable air cleaner, and a hazardous material containment apparatus.

The inventor has found there are different scalable fans and filters that can be used in respiratory, skin, and eye protection devices and are readily available in the supply chain because they have a secondary market, described herein. As a result of the secondary market, in addition to being in a scalable supply, these fans cost less due to economies of scale and come with improved quality control, product features, reliability, durability, and ruggedness.

For example, the axial fan is a scalable fan that has a motor-driven rotating shaft (axis) on which are mounted skewed fan blades that pull air in and force it out in a direction parallel to the shaft.

Three types of axial fans include box fans, case fans, and automotive cooling fans. Box fans are used in and supported primarily by the consumer market with a range of airflow and noise characteristics running on alternating current. An example of a box fan includes the Lasko 20-inch Box Fan. Case fans are used inside portable and gaming computers for cooling with significant airflow but low noise and low power consumption, typically powered by 12-volt direct current (DC), are also small and lightweight. Examples of case fans include the Arctic™ P12™ Case Fan and Arctic™ P12™ Max Case Fan, the technical specifications thereof are shown in the table below:

| Specification | P12 | P12 Max |
|---|---|---|
| Dimensions (mm) | 120 × 120 × 25 | 120 × 120 × 25 |
| Weight (g) | 139 | 184 |
| Operating Temperature (° C.) | 0-40 | 0-40 |
| Fan Speed (rpm) | 1800 | 400-3,300 (PWM |
| | | controlled), 0 |
| | | rpm below 2% PWM |
| Airflow (CFM \| m³/h) | 56.3 \| 95.7 | 81.04 \| 137.69 |
| Static Pressure (mmH₂O) | 2.2 | 4.35 |
| Noise Level (Sone) | 0.3 | 0.6 |
| Bearing Type | Fluid Dynamic | Fluid Dynamic |
| | Bearing | Bearing |
| Voltage (V DC) | 12 | 12 |
| Startup Voltage (V DC) | 2.8 | 3.9 |
| Current (A) | 0.16 | 0.29 |
| Connector Type | 3-Pin Connector | 4-Pin PWM Connector |
| Cable Length (mm) | 400 | 400 |

Automotive cooling fans (i.e., radiator fans, engine cooling fans, electric fans, condenser fans, cooling fan assemblies, pusher fans, and puller fans) are used for cooling radiators in cars or motorcycles and supported by the automotive industry, have a high level of airflow, power consumption, noise, and weight, and are also typically powered by 12-volt DC. An example of an automotive cooling fan can be found in U.S. Pat. No. 8,152,484 to Bilodeau et al., the subject matter of which is herein incorporated by reference in its entirety, as well as the Spal 30101522 Puller Fan. Case fans are airflow fans and are optimized to move as much air as possible without forcing the air to move in a certain direction whereas automotive cooling fans are static pressure fans and are optimized for higher pressure/resistance applications.

A second type of fan, centrifugal fans (i.e., radial fans), have a motor driven hub which contains impellers that throw off air into the fan housing that is then directed to an outlet. Centrifugal fans discharge air at a 90 degree angle (perpendicular) to the air intake. Centrifugal fans are typically used in high pressure/resistance applications.

The inventor has found that axial fans are preferred over centrifugal fans in respiratory, skin, and eye protection device applications because they generate less audible noise, require less power, are less expensive, and have more compact designs. Furthermore, axial fans generate higher airflow rates and move a greater volume of air, making it possible to achieve a greater number of air changes per hour. Additionally, axial fans can be stacked in series to increase the static pressure, thus optimized for higher pressure/resistance applications. Axial fans can also be used in parallel in order to increase the total airflow volume. In one embodiment, the axial fans have a fan speed ranging from about 200 to about 3,300 rotations per minute (rpm), generate a volumetric airflow rate ranging from about 45 to about 90 cubic feet per minute (CFM), generate a static pressure ranging from about 2 to about 5 millimeters of water (mm H₂O), and generate an audible noise of about 40 decibels (dBA) or less, preferably about 20 dBA or less.

Mixed-flow fans, a third type of fan, also has a motor-driven rotating shaft (axis) on which are mounted at least one skewed fan blade, and combines the characteristics of both axial and centrifugal fans. A mixed-flow fan draws air in axially (parallel to the fan's axis) but then alters the flow direction to incorporate a radial component, meaning the air also flows outwards from the center, before exiting the fan. This design allows mixed-flow fans to achieve a balance of high airflow and moderate pressure capabilities. A mixed-flow fan can efficiently generate high airflow similar to an axial fan when a high-air exchange rate is needed. A mixed-flow fan can also generate a high-pressure similar to a centrifugal fan when force is needed to move air at the high air exchange rate through vapor contamination filters with significant amount of activated carbon which add significant air resistance. Mixed-flow fans are used in and supported by the consumer market with a range of airflow and noise characteristics running on alternating current (AC) and are widely used in a range of other industries. One type of mixed-flow fan is sold as a duct fan used inside ventilation systems with low noise and low power consumption, typically powered by alternating current. An example of a duct fan that is a mixed-flow fan is the AC Infinity™ 10-inch Cloudline™ Pro S10 duct fan which is about 16 inches height (about 12 inches long×12 inches width) with a maximum power consumed of about 250 watts. In the inventor's opinion, the skilled artisan would not have the knowledge to have used duct fans to simultaneously filter aerosols and vapors at high CADR in a compact manner, nor would the skilled artisan be motivated to substitute or replace the cylindrical duct filters with another filter.

In some embodiments, the inventor has found that mixed-flow fans are preferred over axial and centrifugal fans in modular filter assemblies for filtering contamination from ambient air in the surrounding environment because they generate less audible noise, require less power, are less expensive, and have more compact designs. Furthermore, mixed-flow fans generate higher airflow rates and move a greater volume of air, making it possible to achieve a greater number of air changes per hour. Additionally, mixed-flow fans can be stacked in series to increase the static pressure, thus optimized for higher pressure/resistance applications. Mixed-flow fans can also be used in parallel in order to increase the total airflow volume.

In one embodiment, the mixed-flow fans have a diameter of up to 60 inches. In other embodiment, the mixed-flow fans have a diameter ranging from about 4 to about 24 inches, preferably about 6 to about 16 inches, even more preferably about 8 to about 12 inches. In one embodiment, the mixed-flow fans generate a maximum volumetric airflow rate ranging from greater than about 0 to about 88,000 CFM, preferably about 700 to about 3,000 CFM, even more preferably about 800 to about 1,600 CFM. In one embodiment, the mixed-flow fans consume a maximum power of about 360 watts or less, preferably about 250 watts or less, more preferably about 100 watts or less, even more preferably about 70 watts or less, and most preferably about 35 watts or less. In one embodiment, the mixed-flow fans generate an audible noise of about 90 decibels (dBA) or less, about 80 decibels (dBA) or less, about 70 decibels (dBA) or less, preferably about 60 decibels (dBA) or less, and even more preferably about 40 dBA or less. In one embodiment, the speed of the mixed-flow fan can be reduced continuously or at discrete speed settings between from the maximum airflow rate to zero, with corresponding reduction in power consumption and noise generated.

There are scalable filters that are specifically designed to maximize the capture of either aerosolized particles or vapors.

An example of an aerosolized particle filter is a filter having a minimum efficiency reporting value (MERV) rating equal to 13 or greater, preferably a MERV rating ranging from 13 to 16. These filters are used in the HVAC industry and are superior at capturing aerosolized particles having a size of about 0.3 micrometers (μm), which is considered to be the “most penetrating particle size” (of the aerosolized particle contamination filter). A particle size of about 0.3 μm is too small to be easily captured by inertial impact (like larger particles) but not small enough to be significantly affected by Brownian motion (like smaller particles), making it the most difficult size to filter out effectively by most air filters. The MERV rating is based on the ability of the filter to capture larger particles between 0.3 and 10 μm. For instance, a filter with a MERV rating of 13 can capture greater than or equal to 50% of particles ranging from 0.3 to 1 μm versus a filter with a MERV rating of 16 can capture greater than or equal to 95% of particles ranging from 0.3 to 1 μm. The inventor has found that filters with a MERV value of 13 to 16 provide the best balance of filtration efficiency with the least amount of airflow resistance. Filters with a MERV value ranging from 13 to 16 are also used in the HVAC industry.

Another example of an aerosolized particle filter is a high efficiency particulate air (HEPA) filter. These filters are used in homes and hospitals and may often be advertised to have a filtration efficiency of 99.97% for airborne particles that are 0.3 μm or larger in size although in practice the filtration efficiency may be significantly lower. However, MERV filters with a rating value of 13 to 16 are preferred over HEPA filters because they are less expensive and do not require as much pressure to operate permitting greater clean airflow rates.

In one embodiment, the aerosolized particle contamination filter is configured (i.e., designed to perform the recited function of) to achieve an aerosolized particle contamination filtration efficiency of about 50% or greater for particles having a size of about 0.3 μm, preferably about 75%, more preferably about 80%, even more preferably about 85%, even more preferably about 90%, even more preferably about 95%, most preferably about 99% or greater.

In one embodiment, aerosolized particle filters can be in the form of a cartridge or a panel. Cartridge filters are typically cylindrical/tubular and comprise filter media, end caps, a core, gaskets/O-rings, and a support cage. Panel filters comprise a frame (e.g., square or rectangular), filter media, and optionally, some form of backing/support for the filter media. Panel filters have a thickness ranging from about 1 inch to about 5 inches.

In one embodiment, the filter media may be pleated, meaning that the filter media is folded into a series of pleats to increase surface area. Furthermore, the filter media may be electrostatically charged and therefore utilize static electricity to increase the capture of particles by the filter media. Additionally, filters can be stacked in series to increase the filtration efficiency.

Vapor filters comprise activated carbon as an adsorbent and typically consists of a housing containing a bed of granular activated carbon, designed for efficient contact between the vapor and the carbon surface. The high efficiency gas adsorber (HEGA) filter is a type of vapor contamination filter that uses woven activated carbon cloth. In multiple embodiments, the vapor filter comprises at least about 10 pounds, at least about 15 pounds, at least about 20 pounds, at least about 25 pounds, at least about 30 pounds, or at least about 35 pounds of activated carbon.

Based on the direction of output airflow generated by the at least one fan, it is desirable to stack or otherwise dispose the vapor contamination filter downstream of the aerosolized particle filter to maximize capture of chemical aerosol/vapor agents (e.g., that may evaporate from liquid aerosol particles trapped by the aerosolized particle filter). However, if the vapor contamination filter is placed upstream from the aerosolized particle filter, the aerosolized particle filter can trap any of the activated carbon that may break loose.

The activated carbon acts as a porous media where vapors are trapped and held onto the large surface area within the carbon particle using adsorption. The filtration efficiency of the activated carbon is determined by the type and amount of contaminant in the gas stream, the type and amount of adsorbent, and the residence time (the time that the gas stream is in contact with the carbon). In one embodiment, a residence time of about 0.125 seconds is sufficient. In some instances, vapors adsorbed may be trapped temporarily by the activated carbon has been observed to eventually be desorbed (released) from the activated carbon after a time delay and at a slower rate than which the vapor was initially adsorbed.

In order to more permanently capture specific chemical agents using chemisorption, the activated carbon may be impregnated with an impregnant selected from the group consisting of copper, silver, zinc, molybdenum, triethylenediamine (TEDA), zeolite, potassium iodine, chromium, and combinations of one or more of the foregoing. For example, the United States Army uses ASZM-TEDA having the following composition:

| Impregnant | Content (wt. %) |
|---|---|
| Cu | 6.0 |
| Ag | 0.1 |
| Zn | 6.0 |
| Mo | 2.5 |
| TEDA | 3.5 |

Various grades (A, N, T) of carbon are available for the vapor filter. A-grade carbon is activated 8×16 carbon mesh used to adsorb heavy solvents, elemental iodine, and most odors. N-grade carbon is 8×16 carbon mesh made with specially impregnated activated carbon used to adsorb organic radioactive iodide. T-grade carbon uses 12×30 carbon mesh made with ASZM-TEDA used to adsorb chemical warfare agents. A-grade and N-grade carbon may still adsorb chemical warfare agents but not to the same degree as T-grade carbon. Vapor filters may also be dimethyl methylphosphonate (DMMP) certified by the United States Army Combat Capabilities Development Command (DEVCOM), Aberdeen Proving Grounds. During DMMP certification, vapor filters are destructively evaluated using DMMP as chemical nerve agent simulant.

In one embodiment, the vapor contamination filter is configured (i.e., designed to perform the recited function of) to achieve a vapor contamination filtration efficiency of about 50% or greater, preferably about 75%, more preferably about 80%, even more preferably about 85%, even more preferably about 90%, even more preferably about 95%, most preferably about 99% or greater, for one or more of Novichok nerve agent (A232), thickened venomous nerve agent (TVX), sulfur mustard agent (HD), thickened sulfur mustard agent (THD), soman nerve agent (GD), and sarin nerve agent (GB).

### 1. Air Processing Assembly

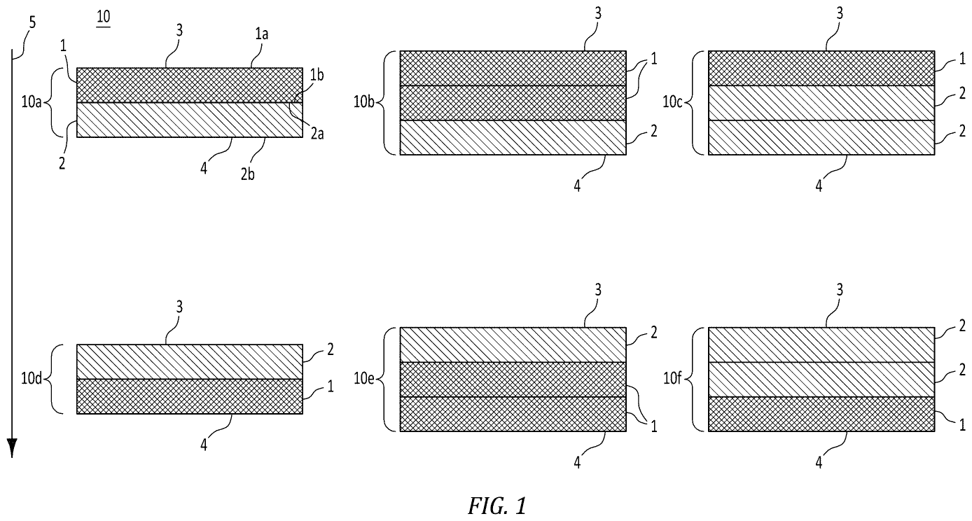

As shown in FIG. 1, an air processing assembly (10) comprises at least one fan (1) and at least one filter (2) stacked together in various configurations (10a-10f), depending on the required static pressure and/or filtration efficiency. For example, the air processing assembly can have one fan stacked on top of one filter (10a) or can have two fans stacked on top of one filter (10b). In one embodiment, the at least one fan and the at least one filter are stacked such that the respective centers of each of the foregoing are aligned. The air processing assembly has an air processing assembly inlet (3) and an air processing assembly outlet (4) based on an input airflow (5) generated by the least one fan. The at least one fan and the at least one filter are stacked together between the air processing assembly inlet and the air processing assembly outlet. The at least one filter and the at least one fan can be any combination of filter and fan described herein to include any filter and fan configurations and any filter materials.

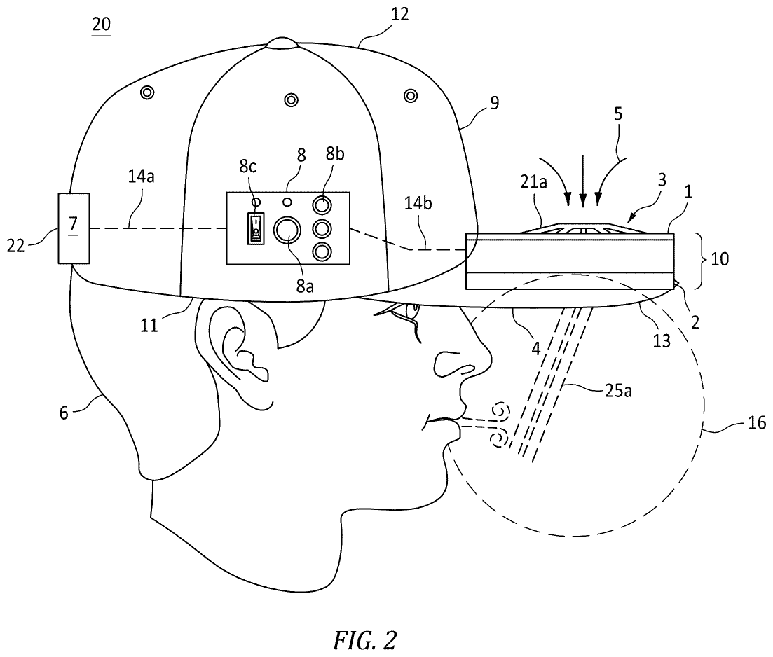

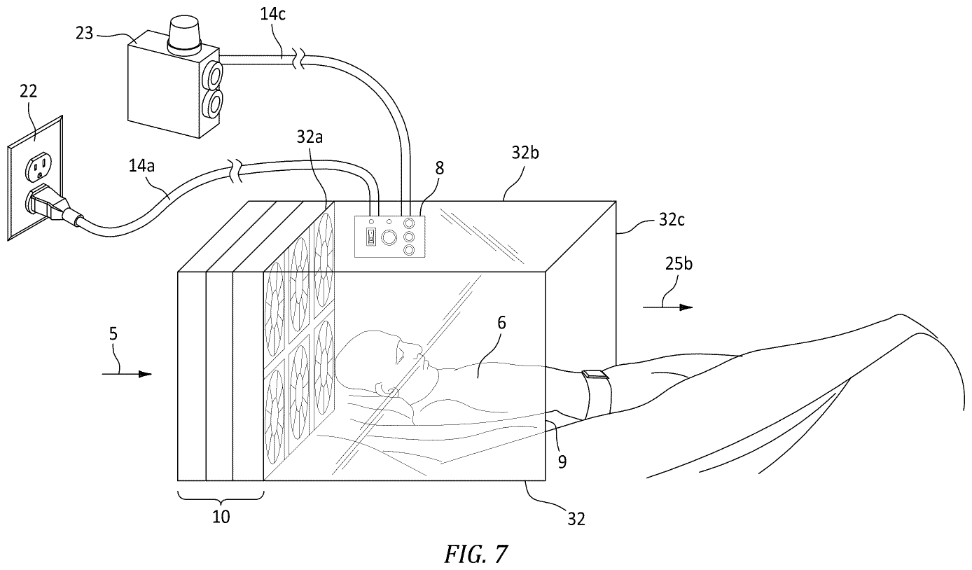

In one embodiment, as shown in FIG. 1, the at least one filter comprises a filter inlet (2a) and a filter outlet (2b), and the at least one fan comprises a fan inlet (la) and a fan outlet (1b), and the filter inlet and the filter outlet are equal to or greater than the fan inlet and the fan outlet. In one embodiment, the air processing assembly inlet comprises an inlet guard (21a) (as shown in FIG. 2) and the air processing assembly outlet comprises an outlet guard (21b) (as shown in FIG. 6). The primary purpose of the inlet guard is to prevent debris from entering the air processing assembly. The primary purpose of the outlet guard is to provide additional protection to a user of the respiratory, skin, and eye protection device and prevent fingers and other body parts from indiscriminately entering the air processing assembly. In one embodiment, the inlet guard has a mesh size ranging from about 0.5 to about 3, preferably about 20 to about 200 and the outlet guard has a mesh size ranging from about 0.5 to about 3. However, any material known to the skilled artisan can be used as an inlet guard and an outlet guard to achieve these purposes such as hardware cloth sized about 0.5 inches and below, preferably about 0.25 inches and below, metal wire fan finger guard grill, aluminum screening, and combinations of one or more of the foregoing.

### 2. Personal Respiratory, Skin, and Eve Protection Device

### A. Wearable Personal Respiratory, Skin, and Eve Protection Device

As shown in FIG. 2, the air processing assembly (10) can be implemented in a personal respiratory, skin, and eye protection device (20) that can be worn by the user. In some embodiments, the wearable personal respiratory, skin, and eye protection device provides an aerosolized particle contamination filtration efficiency of at least 75% or preferably at least 85%, or even more preferably at least 95% for particles having a size of about 0.3 μm and therefore provides protection from ambient and close-contact aerosol air inhalation without obstructing the face of the user. In some embodiments, the wearable personal respiratory, skin, and eye protection device generates a noise level ranging about 70 decibels (dBA) or less, preferably about 60 decibels (dBA) or less, more preferably 50 decibels (dBA) or less, even or preferably 40 decibels (dBA) or less, when the at least one fan is in operation, measured within about 3 inches from an ear of the user. In some embodiments, the wearable personal respiratory, skin, and eye protection device is also lightweight and requires minimal power. In one embodiment, the wearable personal respiratory, skin, and eye protection device weighs between about 0.5 to about 10 pounds, preferably about 0.5 to about 1.5 pounds and has a power requirement ranging from about 0.1 amps to about 0.9 amps (about 1.2 watts to about 10.5 watts), preferably about 0.1 amps to about 0.6 amps (about 1.2 watts to about 7.2 watts). Therefore, the user can still nourish themselves, freely communicate, and perform physical activity, while still being protected from air contamination without developing discomfort or exhaustion from the personal respiratory, skin, and eye protection device, without heat stress in warm/hot climates, and without being physically tethered to an airline for air supply or an alternating current (AC) power supply. The wearable personal respiratory, skin, and eye protection device is therefore suitable for daily use, especially at school, the office, the hospital, and at home with sick family members, where there is a likelihood of exposure.

In one embodiment, the at least one fan (1) comprises one or more axial fans. In one embodiment, the at least one filter and the at least one fan can be any combination of filter and fan previously recited to include any filter and fan configurations and any filter materials. The air processing assembly is coupled to a frame (9) which accommodates a user (6) of the personal respiratory, skin, and eye protection device. Although the at least one fan is depicted as being stacked on top of the at least one filter such that the at least one fan is disposed at the air processing assembly inlet, the at least one filter may be stacked on top of the least one fan. The air processing assembly is in line with an inhalation zone (16) of the user during inhalation and is disposed above the inhalation zone with respect to the direction of output airflow (25a) generated by the at least one fan in the inhalation zone (i.e., above the inhalation zone in front of the face of the user).

In one embodiment, the inhalation zone is about a 10-inch radius around the nose and mouth of the user, wherein the majority of the air is drawn into their lungs, in conformity with the definition used by the United States Department of Labor. In one embodiment, the air processing assembly processes substantially all ambient air in a direction of output airflow generated by the at least one fan before entering the inhalation zone. Furthermore, the air processing assembly outlet only releases air in the inhalation zone that has been substantially filtered by the at least one filter. Therefore, the air processing assembly is attached to the frame in such a manner such that ambient air must substantially first enter the processing inlet before entering the inhalation zone. For example, there should be no significant gaps between the frame and the air processing assembly that would allow substantially contaminated air to enter the inhalation zone. Although the interface between the at least one fan and the at least one filter does not necessarily need to be sealed, in one embodiment substantially all of the input airflow generated airflow from the at least one fan passes through the at least one filter. One technique to avoid having to seal the interface between the at least one fan and the at least one filter is to ensure that the at least one filter is larger than the at least one fan when stacked such that a periphery of the at least one filter extends past the at least one fan on all sides. If used, in one embodiment the interfaces between two or more stacked fans and the interfaces between the two or more stacked filters are brought in close contact with limited spacing or directly in contact, if not sealed. Any means known to the skilled artisan can seal/substantially seal and/or couple the interface between the at least one fan and the at least one filter, between two stacked fans, and between two stacked filters, including acrylic sealants, silicone sealants, polyurethane sealants, butyl sealants, and polysulfide sealants. In one embodiment, tape is used to seal and/or couple the at least one fan and the at least one filter, between two stacked fans, and between two stacked filters, however, any fastener and adhesive can be used known to the skilled artisan.

In one embodiment, the output airflow (25a) generated by the at least one fan is directed towards the face of the user. The inventor discovered by tilting the at least one fan (or otherwise redirecting the output airflow generated by the at least one fan) towards the face of the user, even by a slight amount such that the output airflow generated by the at least one fan is directed towards the face of the user, the filtration efficiency for particles having a size of about 0.3 μm increased. In one or more embodiments, the at least one fan (or the output airflow generated by the at least one fan) is tilted about 1 degree or more, about 2 degrees or more, about 5 degrees or more, about 10 degrees or more, about 15 degrees or more, or about 20 degrees or more towards a major surface of the face of the user with respect to a direction parallel to the height of the user when standing and/or with respect to the stacking direction of the at least one filter and the at least one fan. In one embodiment, the at least one fan generates a velocity (or airspeed) of output airflow ranging from about 10 to about 1,000 feet per minute (ft/min), more preferably from about 50 to about 500 feet per minute (ft/min), as measured at any point in the inhalation zone, more preferably at nose level. As discovered by the inventor, an output airflow of the velocity described herein is ideal to protect the user from airborne CBRNE agents.

In an embodiment, the frame comprises an attachment mechanism (11), a protrusion (13) coupled to the attachment mechanism, and a crown (12) surrounding a top portion of the head of the user, coupled to the attachment mechanism and the protrusion. However, in other embodiments, the frame may just comprise the attachment mechanism (e.g., a clip for attaching to an article of clothing such as a hat or a pair of eyeglasses) or the frame may just comprise the attachment mechanism and the protrusion (e.g., a visor). In one embodiment, the attachment mechanism may be a strap or a band that couples the personal respiratory, skin, and eye protection device to a head of the user. In one embodiment, the protrusion may be a brim of a hat.

As shown in FIG. 2, the frame may be a baseball hat. However, the frame may have several other configurations that are capable of being worn by the user and known to the skilled artisan. For example, the frame may also be a helmet to add additional blunt force protection in hazardous areas wherein there is a potential for head injury such as on construction sites or an operational environment for the military.

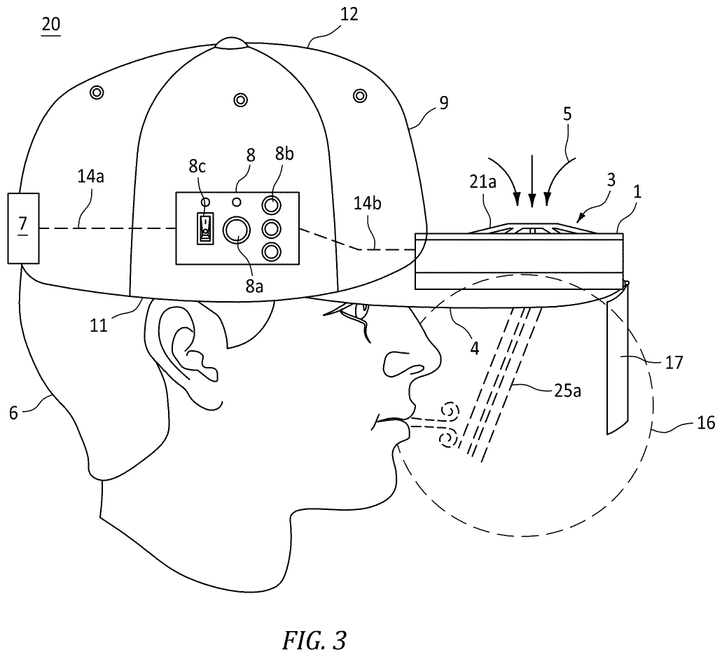

As shown in FIG. 3, the wearable personal respiratory, skin, and eye protection device may comprise a face shield (17) made of a semi-transparent material that is coupled to the frame, extending from the frame towards the inhalation zone. For example, the face shield may cover the face from the forehead down to the tip of the nose, the bottom lip, the bottom of the chin, or the larynx. The inventor discovered that by adding a face shield, the filtration efficiency for particles having a size of about 0.3 μm increased. In one embodiment, the face shield is either coupled to an end of the protrusion or is coupled to the attaching mechanism. In some embodiments, the face shield may be made of any material known to the skilled artisan to include polycarbonate, polyethylene terephthalate (PET), glycol modified polyethylene terephthalate (PETG), polypropylene thermoplastics, and one or more of the foregoing. Any means known to the skilled artisan can couple the face shield to the frame including acrylic sealants, silicone sealants, polyurethane sealants, butyl sealants, and polysulfide sealants. In one embodiment, tape is used to couple the face shield to the frame, however, any fastener and adhesive can be used known to the skilled artisan. In one embodiment, the face shield is integral to the frame.

In one embodiment, the frame comprises an electromagnetic interference (EMI) shielding material configured (i.e., designed to perform the recited function of) to shield the user from EMI generated by the at least one fan or other electrical components to a specific absorption rate (SAR) of 1.6 watts per kilogram (W/kg) or below. The electromagnetic interference (EMI) shielding material can either be integrated with the frame (e.g., as a fabric) or can be added as a layer to the attachment mechanism, crown and/or the protrusion. The EMI shielding material can be nickel, copper, aluminum, carbon black, iron, and any combination of the foregoing.

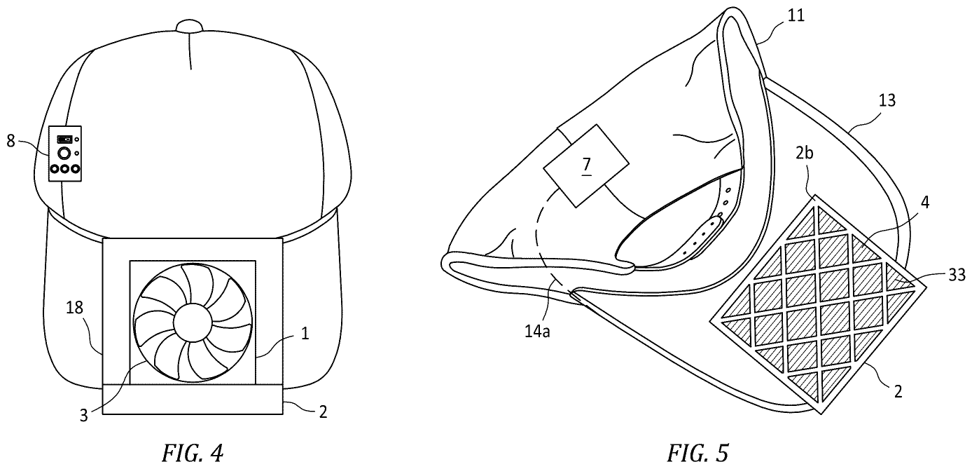

As shown in FIG. 4, in some embodiments, the protrusion comprises at least one reinforcement member (18) disposed on one or more sides of the air processing assembly. The at least one reinforcement member reinforces the protrusion to support the weight of the air processing assembly. Otherwise, the air processing assembly may obstruct the field of view of the user by causing the protrusion to sag. This is especially apparent when two or more fans or two or more filters are stacked. In some embodiments, the at least one reinforcement member may be any rigid material known to the skilled artisan such as plastic, metal or wood. In one embodiment, the at least one reinforcement member is coupled to the protrusion and the at least one filter. Optionally, the at least one reinforcement member is coupled to at least one lateral side of the attachment mechanism. Any means known to the skilled artisan can couple the at least one reinforcement member to the frame including acrylic sealants, silicone sealants, polyurethane sealants, butyl sealants, and polysulfide sealants. In one embodiment, tape is used to couple the at least one reinforcement member to the frame, however, any fastener and adhesive can be used known to the skilled artisan. The air processing assembly inlet guard (21a) is not depicted in FIG. 4 to facilitate showing the skewed fan blades of the at least one fan.

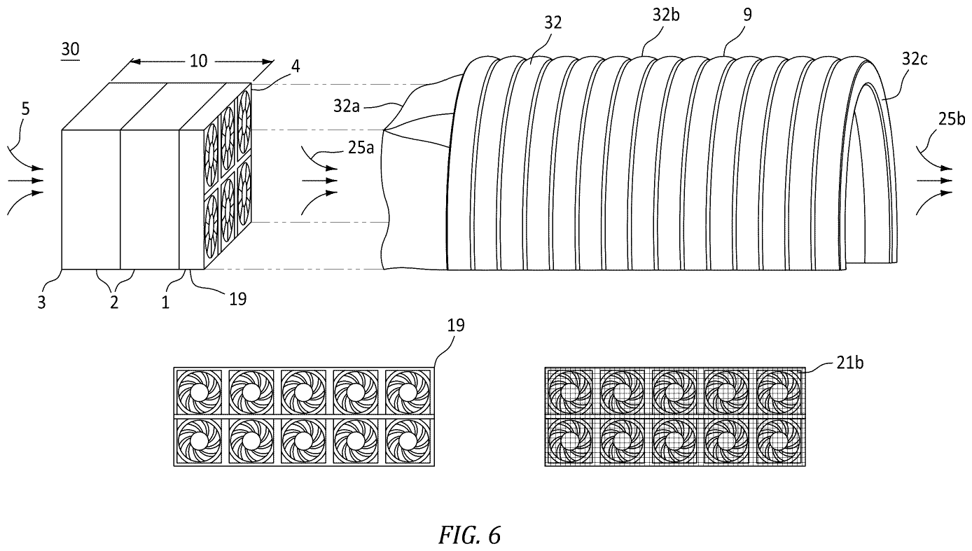

As shown in FIG. 5, the processing assembly may be coupled to the protrusion through an aperture in the protrusion. In one embodiment, the at least one filter comprises at least one pleat (33) oriented perpendicular to a facing direction of the user when the wearable personal respiratory, skin, and eye protection device is worn by the user. In this configuration, the at least one fan and the at least one filter are stacked together such that the at least one filter is larger than the at least one fan by at least about 1.5 inches on each side of the at least one axial fan, based on the pleat orientation. In such a configuration, the input airflow generated by the at least one axial fan will not (or minimally) bypass the filter, increasing the filtration efficiency. The specific pleat orientation and filter margin facilitate minimizing the filter leakage that occurs due to cutting the at least one filter from a larger panel filter as purchased. For instance, a panel filter as purchased has a frame (i.e., a border material) that surrounds the filter media. When the panel filter is cut to size, at least two sides of the frame need to be removed, leaving only the filter media at these exposed edges. The input airflow (5) generated by the at least one fan may bypass the filter at the exposed edges (i.e., the sides without the frame) as well as the sides with the frame unless the at least one pleat (33) is oriented perpendicular to a facing direction of the user when the wearable personal respiratory, skin, and eye protection device is worn by the user and the at least one filter is larger than the at least one fan by at least about 0.25 inches, about 0.50 inches, about 0.75 inches, about 1 inch, about 1.25 inches, about 1.50 inches, about 1.75 inches, about 2 inches, or more on each side of the at least one fan, based on the pleat orientation.

In an alternative embodiment, the at least one filter is a cylindrical filter cartridge that is stacked on top of the at least one fan and thus disposed at the air processing assembly inlet. For example, the cylindrical filter cartridge may be a TruSens™ Standard HEPA Filter for Z-2000 (manufactured by DuPont™). In this embodiment, input airflow generated by the at least one fan is pulled through the cylindrical filter cartridge by the at least one fan and into the inhalation zone. In this configuration, the interface between the at least one fan and the cylindrical filter cartridge may need to be sealed or substantially sealed. Any means known to the skilled artisan can seal the interface between the at least one fan and the cylindrical filter cartridge including acrylic sealants, silicone sealants, polyurethane sealants, butyl sealants, and polysulfide sealants. In one embodiment, tape is used to couple the at least one fan and the cylindrical filter cartridge, however, any fastener and adhesive can be used known to the skilled artisan. Additionally, such a configuration would negate the necessity of having to cut the at least one filter from a large panel filter and thus form a better seal between the cylindrical filter cartridge and the at least one fan.

Additionally, as shown in FIG. 5, the wearable personal respiratory, skin, and eye protection device may comprise a counterweight (7) for balancing the weight of the air processing assembly in order to provide additional comfort to the user. For example, the air processing assembly may cause discomforting pressure on the forehead and lead to neck fatigue. The counterweight may be placed anywhere on the frame and made of any material known to the skilled artisan that can achieve this purpose. In one embodiment, the counterweight may be a power source (22) such as a battery (e.g., a 12-volt battery), or a controller (8).

The power source may be electrically connected to a controller (8) by a connection (14a) and the controller is electrically connected to the at least one fan by a connection (14b). However, a power source of the personal respiratory, skin, and eye protection device is not limited to a battery and may alternatively use solar power or another power source. In one embodiment, the controller may comprise a regulator for manually adjusting one or more settings of the wearable personal respiratory, skin, and eye protection device. For example, the one or more settings may be one or more of activating and deactivating power from the power source and controlling the speed of the output airflow (25a) generated by the at least one fan. As shown in FIG. 2, in one embodiment, the controller is coupled to the frame such that the regulator is accessible to the user while the personal respiratory, skin, and eye protection device is worn.

### B. Non-Wearable Personal Respiratory, Skin, and Eve Protection Device

In another aspect of the present invention and as shown in FIG. 6, the air processing assembly (10) can be implemented in a personal respiratory, skin, and eye protection device (30) for enclosing the user without being worn or otherwise attached to the user for close-range and/or long-range vapor and aerosolized particle contamination protection.

In one embodiment, the frame (9) comprises a canopy (32) having a canopy inlet (32a) coupled to the air processing assembly outlet (4), a canopy outlet (32c) for exhausting air (25b) introduced into the canopy, and a canopy body (32b) between the canopy inlet and the canopy outlet.

In one embodiment, the at least one fan of the air processing assembly may comprise two or more fans arranged in parallel (19) that are stacked with the at least one filter. In one embodiment, the at least one filter and the at least one fan can be any combination of filter and fan previously recited to include any filter and fan configurations and any filter materials. For example, the at least one fan may comprise two or more rows of two or more fans arranged in parallel, preferably two rows of five or more fans arranged in parallel. In one embodiment, the air processing assembly outlet guard (21b) protects the head of the user or another body part from coming into contact with a skewed fan blade of the one or more fans. The air processing assembly outlet guard is properly sized and/or spaced to minimally obstruct output airflow (25a) generated by the at least one fan so as to minimize the turbulent airflow within the canopy. In one or more embodiments, the laminar output airflow (25a) generated by the at least one fan is substantially laminar.

In one embodiment, the distance between the canopy inlet and the canopy outlet is suitable to enclose the entire height of a user. In another embodiment, the distance between the canopy inlet and the canopy outlet ranges between about 6 inches to about 6 feet, preferably between about 6 inches and about 3 feet. Most importantly, in this embodiment the canopy should enclose the nose and mouth of the user and therefore the canopy body should be capable of accommodating the user when a user fully places their head into the canopy body through the canopy outlet. In this embodiment, a width and a height of the canopy should also be appropriately sized to accommodate the user. In one embodiment, the canopy is sized such that a distance ranging from about 6 inches to about 1.5 feet between the user and an interior of the canopy (i.e., lateral walls and ceiling).

In one embodiment, the canopy body is made of a semi-permeable material selected from the group consisting of cardboard, polymer fabric, sheet metal, plexiglass, and combinations of one or more of the foregoing. The transparency of the canopy body can also vary based on application. For example, in a hospital setting where a doctor needs to observe the patient, a more transparent material would be desired. However, to enable the user to sleep and have added privacy, in embodiments, it would be desirable to be less transparent. In one embodiment, the canopy body contains and guides the output airflow generated by the at least one fan out of the canopy through the canopy outlet. In one embodiment, the canopy body protects the user by substantially preventing aerosolized particle air contamination, vapor contamination, or both from entering the canopy.

In one embodiment, the canopy body comprises a ceiling, one or more sidewalls, and optionally, a floor. In this instance, the floor is a surface on which the user lays on, e.g., in the prone position, in the supine position, or in the fetal position.

In one embodiment, the canopy inlet and the canopy outlet are substantially the same size and are concentrically arranged. In another embodiment, a slope of the canopy (i.e., the ceiling of the canopy) deviates about 25 degrees or less, about 20 degrees or less, about 15 degrees or less, about 10 degrees or less, about 5 degrees or less, or about 2 degrees or less with respect to the stacking direction of the at least one fan and the at least one filter and/or with respect to a direction parallel to the height of the user when in the supine position. In this configuration, vapor and aerosolized particle contamination in the ambient air is less likely to circulate into the canopy body through the canopy outlet. For example, if a height of the canopy body was larger than a height of the canopy inlet, the rapid expansion (or contraction) of volume can cause turbulent airflow within the canopy body or at the canopy outlet.

In one embodiment, the canopy inlet is coupled to the air processing assembly outlet such that of the air introduced into the canopy, substantially only air filtered by the at least one filter is introduced into the canopy. Any means known to the skilled artisan can seal or substantially seal the interface between the air processing assembly outlet and the canopy inlet including acrylic sealants, silicone sealants, polyurethane sealants, butyl sealants, and polysulfide sealants. In one embodiment, tape is used to couple the air processing assembly outlet and the canopy inlet, however, any fastener and adhesive can be used known to the skilled artisan.

Although not depicted, in one embodiment, the air processing assembly is generally disposed such that the at least one fan generates a substantially laminar output airflow substantially perpendicular to a surface supporting the user (e.g., the floor). In this instance, the user may be sitting, standing, or laying down (e.g., in the prone position, in the supine position or in the fetal position). In one embodiment, the user may be an infant or child in a crib and unable to wear an N95 respirator or gas mask. In one embodiment, the air processing assembly is suspended from a ceiling, a wall, or another surface object known to the skilled artisan and thus the canopy does not contact the floor. In another embodiment, the canopy contacts the floor, but output airflow generated by the at least one fan is able to exit through the canopy outlet via spacers between the canopy outlet and the floor.

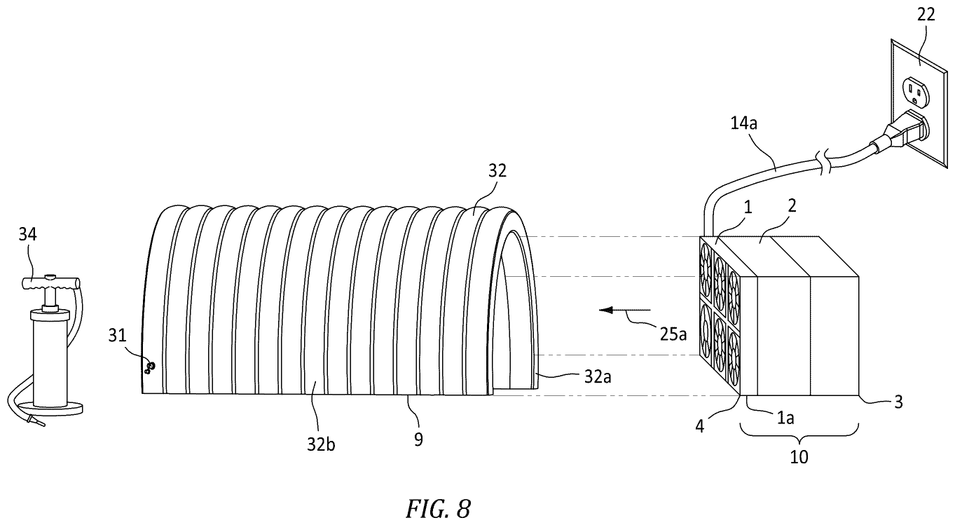

As depicted in FIG. 7, in an embodiment (i.e., the respiratory, skin, and eye protection sleeping device), the air processing assembly is disposed such that the at least one fan generates a substantially laminar output airflow (25a) parallel to a surface supporting the user (e.g., the floor). This embodiment is ideal when the user is laying down (e.g., in the prone position, in the supine position or in the fetal position while sleeping). Shared sleeping quarters (e.g. bunks or beds aboard ships and in prisons) have been shown to amplify aerosolized transmission (cross-infection) due to maximal duration and minimal distance of inhalation exposure. One of the major constraints in places like berths (i.e., sleeping arrangements) on aircraft carriers, battleships, and submarines is the amount of space to insert air purifiers is very constrained. Furthermore, to reach an ACH target (e.g. 12 ACH), the portable air purifiers are bulky (space-consuming) because they need to be provisioned in proportion to room volume as described above. In this embodiment, the personal respiratory, skin, and eye protection device can protect the sailor/passenger enclosed within the canopy as well as add communal air cleaning to shared sleeping quarters. For example, a network effect will occur when more sailors use the personal respiratory, skin and eye protection device, since a greater volume of air within shared sleeping quarters will get filtered. The personal respiratory, skin, and eye protection device of this embodiment can also be used in other shared sleeping situations such as military barracks, travel on trains and airplanes, in hostels, and patient rooms in hospitals. The personal respiratory, skin, and eye protection device can further be implemented for home use when there are sick household members, especially if there is a shared bed arrangement.

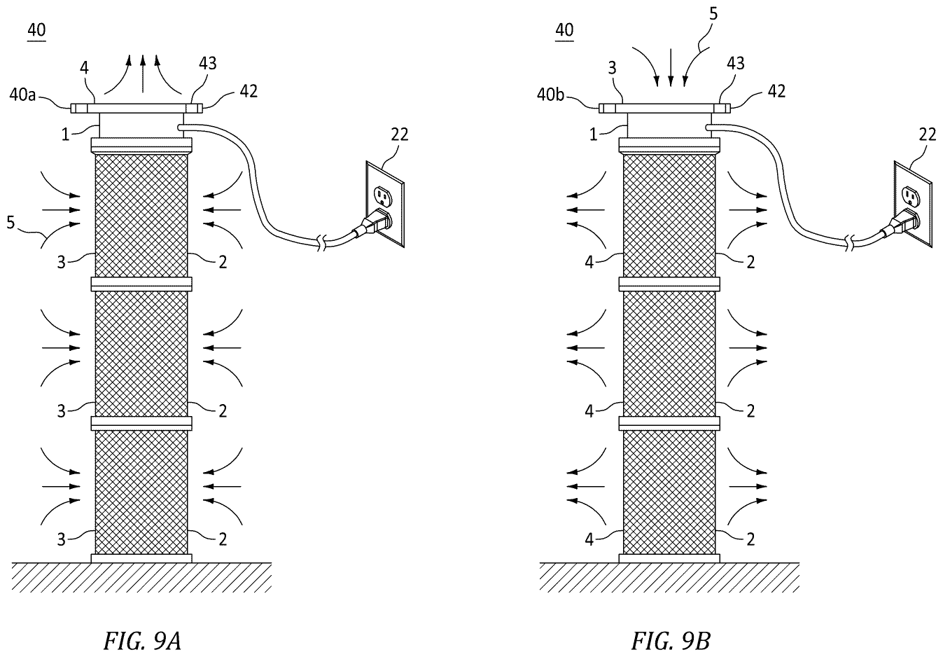

As shown in FIG. 8, in some embodiments the canopy body may comprise at least one air valve (31) coupled to at least one inflatable air chamber (not depicted) embedded within walls of the canopy body. In this embodiment, the canopy is capable of inflating via the at least one air valve by either a manual hand pump (34), an automatic pump, an oral inflation tube, or any means known to the skilled artisan. In this embodiment, the canopy body comprises a polymer fabric selected from the group consisting of polyvinyl chloride, vinyl, nylon, latex, polychloroprene, mylar, and one or more of the foregoing. In an embodiment, the respiratory, skin, and eye protection device is a self-supporting structure when the canopy is inflated. For example, in this embodiment, when inflated, the canopy is able to stand on the surface supporting the user without having to secure the canopy to a wall, ceiling, or nearby object. This embodiment is particularly useful when expedient employment of the personal respiratory, skin, and eye protection device is required. In this embodiment, when in a deflated state, the volume of the canopy is minimized, making it easier to transport and travel with the personal respiratory, skin, and eye protection device.

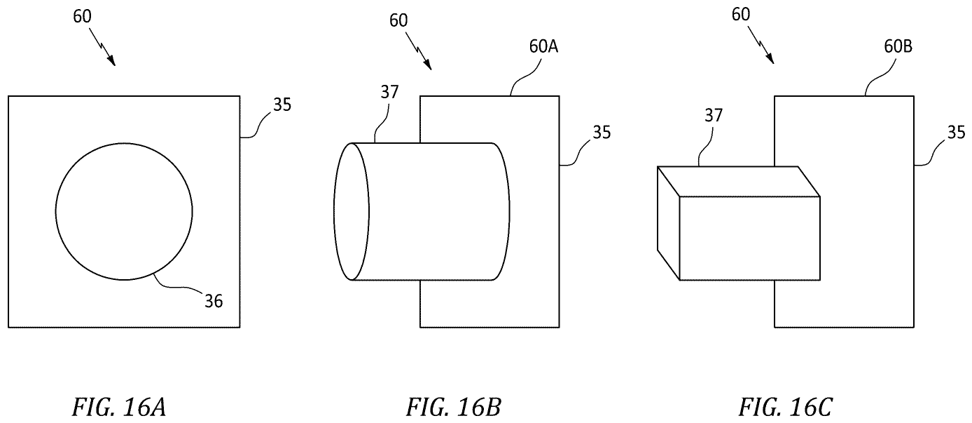

In one embodiment, the at least one fan is disposed at the air processing assembly outlet and the at least one filter is disposed at the air processing assembly inlet. In such an embodiment, as shown in FIGS. 16B-C, the at least one fan may have a fan outlet shroud (60) in order to improve the measured clean air delivery rate (CADR) by 10-20%. The inventor discovered that the fan outlet shroud enhances airflow through the filter (e.g., when airflow is pulled through the filter) by reducing flow recirculation (from outlet to inlet) and eddies at the fan blade tips, while inducing and enhancing air mixing in the room.

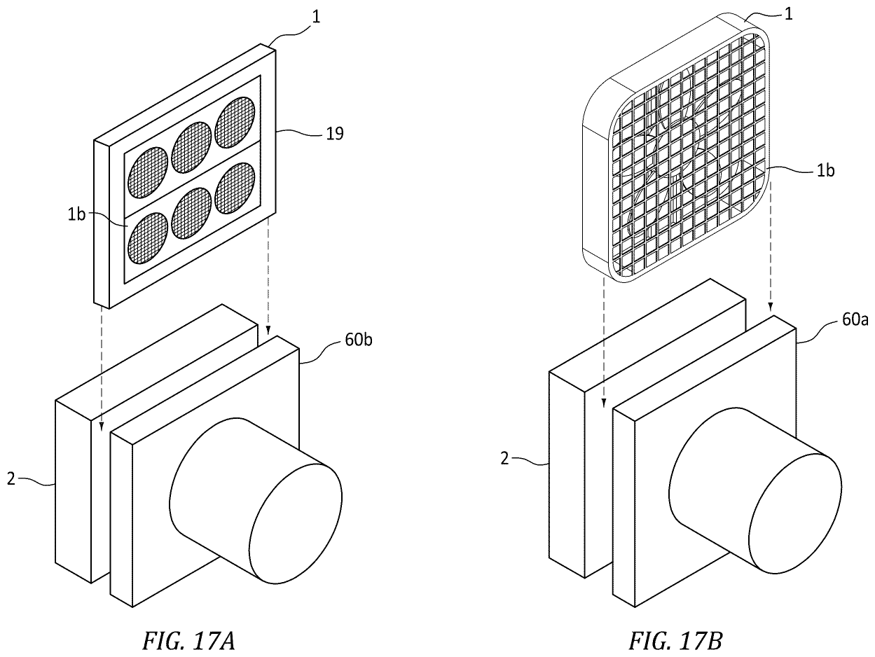

In one embodiment, the fan outlet shroud for the at least one fan comprises a base plate (35), as shown in FIG. 16A, for covering the outlet of at least one fan (lb). In this embodiment, a center of the base plate comprises a circular aperture (36) and a diameter of the circular aperture is smaller than a diameter of the outlet of at least one fan. As shown in FIGS. 16B-C, in this embodiment, an extension (37) is attached to the base plate at the circular aperture forming a sealed or substantially sealed connection. Any means known to the skilled artisan can seal and/or couple the interface between the base plate and the extension, including acrylic sealants, silicone sealants, polyurethane sealants, butyl sealants, and polysulfide sealants. In one embodiment, the base plate and the extension are welded together, however, any fastener and adhesive can be used known to the skilled artisan. In this embodiment, the extension comprises a channel extending the length of the extension substantially through the center of the extension and the at least one fan generates an output airflow (25a) through the channel and the circular aperture. In one embodiment, the circular aperture diameter ranges from about 10 to about 20 inches and the channel length ranges from about 6 to 20 about inches. In one embodiment, the circular aperture diameter and the channel length are substantially the same size. In one embodiment, as shown in FIG. 16C, the fan outlet shroud (60b) has an extension that is either a cube or a rectangular prism. In another embodiment, as shown in FIG. 16B, the fan outlet shroud (60a) has an extension that is a cylinder. In one embodiment, the circular aperture diameter and a channel inner diameter are substantially the same. In some embodiments, the base plate and extension can be made of any material known to the skilled artisan to include cardboard, sheet metal, polycarbonate, polyethylene, polypropylene, acrylonitrile butadiene styrene (ABS), polyvinyl chloride (PVC), and any combination of one or more of the foregoing. As shown in FIG. 17A, in one embodiment, the at least one fan is an array of fans (19) comprising two or more fans arranged in parallel. As shown in FIG. 17B, in another embodiment, the at least one fan is a box fan.

In one embodiment, a kit is provided comprising the personal respiratory, skin, and eye protection device and the fan outlet shroud (60) for the at least one fan.

As shown in FIG. 7, the power source (22) is electrically connected to a controller (8) by a connection (14a) and the controller is electrically connected to the at least one fan by an electrical connection (not depicted). The power source may be alternating current (AC) power but may also use a DC power source (e.g., a battery), photovoltaic power, or another power source known to the skilled artisan. In one embodiment, the controller may be disposed in an interior of the canopy so as to be accessible to the user while within the canopy. In one embodiment, the interior of the canopy may also comprise lights that are electrically connected to the controller and the power source in order to provide lighting within the canopy for the user to read and perform other activities. In one embodiment, the controller may comprise a regulator for manually controlling one or more settings of the personal respiratory, skin, and eye protection device. For example, the one or more settings may be one or more of activating and deactivating power from the power source, controlling the airflow speed of the output airflow (25a) generated by the at least one fan, and activating and deactivating power to the interior lights. In another embodiment, the controller may be disposed on an exterior of the canopy. For example, when the personal respiratory, skin, and eye protection device is utilized in the hospital, a medical attendant can manually control the one or more settings while the patient is incapacitated, sleeping, or otherwise unavailable.

### 3. Modular Filter Assembly

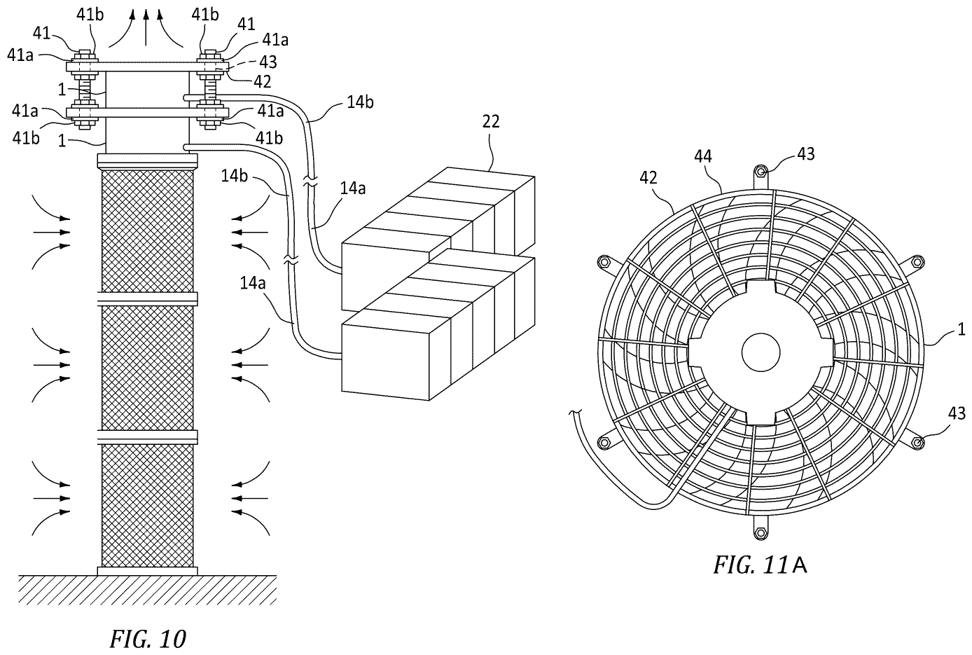

As shown in FIGS. 9A-9B, in one embodiment, the air processing assembly (10) can be implemented in a modular filter assembly (40) that utilizes minimal floorspace, consumes minimal power, and generates minimal noise while able to achieve maximal clean air delivery rates, especially in environments that may contain vapor and aerosol contamination. This embodiment of a modular filter assembly is particularly useful and optimized for suppressing vapor and aerosol spikes simultaneously indoor where floorspace is limited, power is expensive and/or limited, and noise generated becomes disruptive.

In one embodiment, the present invention relates generally to a modular filter assembly for filtering contamination from ambient air in the immediately surrounding environment, comprising:
at least one fan;
at least one filter,
wherein at least one of the at least one filter comprises an aerosolized particle filter,
wherein at least one of the at least one filter comprises a vapor contamination filter, wherein the vapor contamination filter comprises activated carbon;
at least one inlet for receiving ambient air from the immediately surrounding environment; and
at least one outlet for releasing filtered air into the surrounding environment,
wherein the at least one filter reduces contaminated air in the immediately surrounding environment,
wherein the vapor contamination filter is configured to achieve a vapor contamination filtration efficiency of about 50% or greater for one or more of Novichok nerve agent (A232), thickened venomous nerve agent (TVX), sulfur mustard agent (HD), thickened sulfur mustard agent (THD), soman nerve agent (GD), and sarin nerve agent (GB), and
wherein a substantial amount of the air released into the immediately surrounding environment from the modular filter assembly outlet has been filtered by the at least one filter.

In one embodiment, the present invention also relates generally to a modular filter assembly for filtering contamination from ambient air in the surrounding environment, comprising:
at least one fan;
at least one cylindrical filter, wherein a cross-sectional shape of the cylindrical filter is one of substantially circular, substantially square, substantially triangular or any other similar cross-sectional shape,
wherein at least one of the at least one cylindrical filter comprises an aerosolized particle filter.
wherein at least one of the at least one cylindrical filter comprises a vapor contamination filter, wherein the vapor contamination filter comprises activated carbon;
at least one inlet for receiving ambient air from the surrounding environment;
at least one outlet for releasing filtered air into the surrounding environment;
wherein the at least one fan is stacked with at least one cylindrical filter,
wherein the airspeed is about 500 feet per minute or greater as measured at the at least one outlet,
wherein the airspeed is about 10 feet per minute or greater as measured at the at least one inlet,
wherein the at least one cylindrical filter is configured to achieve an aerosolized particle contamination filtration efficiency of about 50% or greater for particles having a size of about 0.3 μm,
wherein the at least one cylindrical filter is configured to achieve a vapor contamination filtration efficiency of about 50% or greater, and
wherein a substantial amount of the air released into the immediately surrounding environment from the modular filter assembly outlet has been filtered by the at least one filter.

In one embodiment, the at least one filter and the at least one fan can be any combination of filter and fan previously recited to include any filter and fan configurations and any filter materials.

The present invention further relates generally to a method for filtering contamination from ambient air in the immediately surrounding environment, comprising:
generating a negative pressure within a modular filter assembly to draw ambient air into the assembly through an air inlet, wherein the negative pressure being generated by at least one fan;
receiving ambient air from the immediately surrounding environment through at least one inlet of the modular filter assembly;
processing the ambient air through at least one filter of the modular filter assembly, wherein at least one of the at least one filter comprises an aerosolized particle filter,
wherein at least one of the at least one filter comprises a vapor contamination filter, wherein the vapor contamination filter comprises activated carbon,
wherein the vapor contamination filter is configured to achieve a vapor contamination filtration efficiency of about 50% or greater for one or more of Novichok nerve agent (A232), thickened venomous nerve agent (TVX), sulfur mustard agent (HD), thickened sulfur mustard agent (THD), soman nerve agent (GD), and sarin nerve agent (GB);
releasing filtered air into the immediately surrounding environment via at least one outlet of the modular filter assembly,
wherein a substantial amount of about 75, about 80, about 85, about 90, about 95, or about 99 percent (%) or more of the air released into the immediately surrounding environment from the modular filter assembly outlet has been filtered by the at least one filter to remove aerosolized particle contamination and vapor contamination.

In one embodiment, the modular filter assembly comprises an air processing assembly (10) that further comprises an air processing assembly inlet (3) (i.e., modular filter assembly inlet) for receiving ambient air, an air processing assembly outlet (4) (i.e., a modular filter assembly outlet), and at least one fan (1) stacked on top of at least one filter (2) between the modular filter assembly inlet and the modular filter assembly outlet.

In one embodiment, the at least one filter and the at least one fan can be any combination of filter and fan previously recited to include any filter and fan configurations and any filter materials.

In one embodiment, as shown in FIG. 9A, the modular filter assembly (40a) generates an input airflow (5) via the at least one fan such that air is pulled through the at least one filter. In another embodiment, as shown in FIG. 9B, the modular filter assembly (40b) generates an input airflow (5) via the at least one fan such that air is pushed through the at least one filter.

In one embodiment, any power source (22) previously discussed can be used to energize the at least one fan.

In one embodiment, the at least one filter reduces contaminated air in the surrounding environment and comprises a vapor contamination filter configured to achieve a vapor contamination filtration efficiency of about 50% or greater, preferably about 75%, more preferably about 80%, even more preferably about 85%, even more preferably about 90%, even more preferably about 95%, most preferably about 99% or greater of one or more of Novichok nerve agent (A232), thickened venomous nerve agent (TVX), sulfur mustard agent (HD), thickened sulfur mustard agent (THD), soman nerve agent (GD), and sarin nerve agent (GB).

In one embodiment, the at least one filter comprises an aerosolized contamination filter configured to achieve an aerosolized contamination filtration efficiency of about 50% or greater for particles having a size of about 0.3 μm, preferably about 75%, more preferably about 80%, even more preferably about 85%, even more preferably about 90%, even more preferably about 95%, most preferably about 99% or greater.

The dimensions described herein exclude minor protrusions and surface features, including handles, knobs, mounting flanges, fasteners, ducts, shrouds, external ribs, and ornamental elements that do not materially contribute to the structural or functional bulk of the device. Unless otherwise specified, the dimensions also exclude external components such as the power supply, switches, removable parts, cords (e.g., power cords), packaging, and accessories.

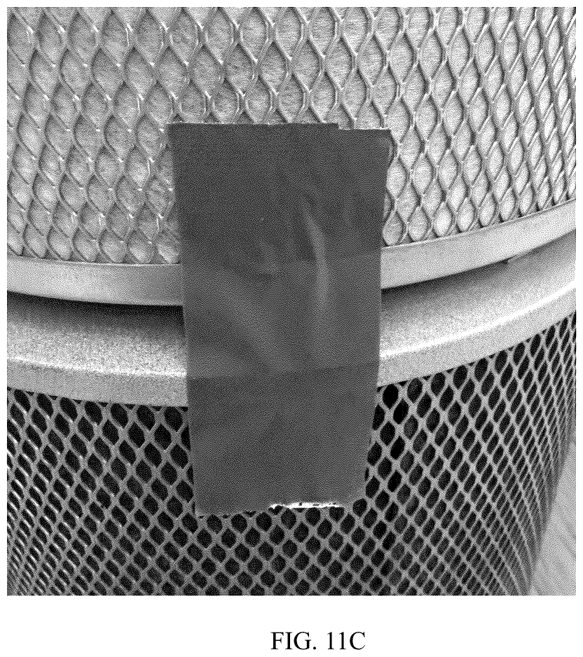

As shown in FIG. 11A, in one embodiment, the at least one fan comprises at least one axial fan such as a radiator fan (44). Since radiator fans have a high level of output airflow compared to other fans, they are particularly beneficial for achieving a high clean air delivery rate. In one embodiment, each radiator fan is capable of generating an output airflow ranging from about 0 and about 1,275 cubic feet per minute (CFM) at a static pressure ranging from about 0 to about 1 millimeters of water (mm H₂O) while drawing a current ranging from about 10.8 amps to about 12.7 amps.

As shown in FIG. 11B, in one embodiment, the at least one fan comprises a mixed-flow fan (44a). Since mixed-flow fans have a high level of output airflow compared to other fans of similar diameter, they are particularly beneficial for achieving a high clean air delivery rate. In one embodiment, each mixed-flow fan is capable of generating an output airflow ranging from greater than about 0 to about 1,600 cubic feet per minute (CFM) at a noise generated of less than about 60 dBA while having a power consumption of about 250 watts or less. In one embodiment, the mixed-flow fan has a diameter of up to about 60 inches. In other embodiments, the mixed-flow fan has a diameter ranging from about 4 to about 24 inches or about 6 to about 16 inches, or about 8 to about 12 inches.

In one embodiment, the mixed-flow fan comprises at least one impeller or blade. In one embodiment, the at least one impeller or blade has a diameter of up to about 60 inches. In other embodiment, the at least one impeller or blade has a diameter ranging from about 4 to about 24 inches, or about 6 to about 16 inches, or about 8 to about 12 inches.

In another embodiment, the at least one fan is an array of fans comprising two or more fans arranged in parallel. In another embodiment, the at least one fan comprises two or more stacked fans.

In one embodiment, the modular filter assembly consumes a maximum power of about 360 watts or less, preferably about 250 watts or less, more preferably about 100 watts or less, even more preferably about 70 watts or less, and most preferably about 35 watts or less. In one embodiment, the modular filter assembly generates an audible noise of about 90 decibels (dBA) or less, about 80 decibels (dBA) or less, about 70 decibels (dBA) or less, preferably about 60 decibels (dBA) or less, and even more preferably about 40 dBA or less. In one embodiment, the modular filter assembly consumes a maximum power of about 10 watts to about 360 watts, preferably about 20 watts to about 250 watts more preferably about 35 watts to about 70 watts. In one embodiment, the modular filter assembly has a footprint ranging from about 4×about 4 to about 24×about 24 inches, preferably about 6×about 6 to about 20×about 20 inches, even more preferably about 6×about 6 to about 16×about 16 inches, and has a height ranging from about 20 to about 100 inches, more preferably about 20 to about 60 inches. In one embodiment, the dimensions of the modular filter assembly do not exceed about 30 inches by about 30 inches by about 30 inches. In another embodiment, the dimensions of the modular filter assembly do not exceed about 30 inches by about 30 inches by about 45 inches. In another embodiment, the dimensions of the modular filter assembly do not exceed about 30 inches by about 30 inches by about 70 inches.

In one embodiment, the modular filter assembly has a clean air delivery rate of about 100 CFM or greater as measured using air changes per hour with a test aerosol comprised of particles having a size of about 0.3 microns in a test room having a size of about 2,000 cubic feet or greater,
wherein the clean air delivery rate is about 100 CFM or greater as measured using air changes per hour with a test vapor in a test room having a size of about 2,000 cubic feet or greater,
wherein the modular filter assembly consumes about 35 watts or less,
wherein at least one fan generates less than about 70 dBA as measured at a point within about 9 inches of the at least one fan, and
wherein the dimensions of the modular filter assembly do not exceed about 30 inches by about 30 inches by about 45 inches. This is important because floorspace and height occupied by the modular filter assembly are competing with other objects in the room (e.g., furniture, shelves, etc.) and minimization of the footprint and volume enables achieving the target CADR/ACH within the room.

In one embodiment, in the modular filter assembly described herein, the clean air delivery rate is about 250 CFM or greater as measured using air changes per hour with a test aerosol comprised of particles having a size of about 0.3 microns in a test room having a size of about 2,000 cubic feet or greater,
wherein the clean air delivery rate is about 250 CFM or greater as measured using air changes per hour with a test vapor comprised of particles having a size of about 0.3 microns in a test room having a size of about 2,000 cubic feet or greater, wherein the modular filter assembly consumes about 250 watts or less,
wherein at least one fan generates less than about 90 dBA as measured at a point within about 9 inches of the at least one fan, and
wherein the dimensions of the modular filter assembly do not exceed about 30 inches by about 30 inches by about 30 inches.

In one embodiment, in the modular filter assembly described herein, the clean air delivery rate is about 200 CFM or greater as measured using air changes per hour with a test aerosol comprised of particles having a size of about 0.3 microns in a test room having a size of about 2,000 cubic feet or greater,
wherein the clean air delivery rate is about 200 CFM or greater as measured using air changes per hour with a test vapor comprised of particles having a size of about 0.3 microns in a test room having a size of about 2,000 cubic feet or greater,
wherein the modular filter assembly consumes about 70 watts or less,
wherein at least one fan generates less than about 70 dBA as measured at a point within about 9 inches of the at least one fan, and
wherein the dimensions of the at least one substantially cylindrical filter and at least one fan do not exceed about 30 inches by about 30 inches by about 70 inches.

In one embodiment, in the modular filter assembly described herein, the clean air delivery rate is about 400 CFM or greater as measured using air changes per hour with a test aerosol comprised of particles having a size of about 0.3 microns in a test room having a size of about 2,000 cubic feet or greater,
wherein the clean air delivery rate is about 400 CFM or greater as measured using air changes per hour with a test vapor comprised of particles having a size of about 0.3 microns in a test room having size of about 2,000 cubic feet or greater,
wherein the modular filter assembly consumes about 250 watts or less,
wherein at least one fan generates less than about 90 dBA as measured at a point within about 9 inches of the at least one fan, and
wherein the dimensions of the modular filter assembly do not exceed about 30 inches by about 30 inches by about 70 inches.

The inventor has surprisingly found that the modular filter assembly with such a configuration takes up less floor space and volume, generates less noise, and is about 35 times more power-efficient than prior art such as collective protection (COLPRO).

In one embodiment, the at least one filter comprises two or more stacked filters, wherein a seal is interposed between each of the two or more stacked filters for sealing or substantially sealing an interface therebetween. In one embodiment, the seal can be formed from any of the sealing materials previously recited. For example, in one embodiment tape can be used to seal the interface between two adjacently stacked filters by wrapping the tape around the peripheral interface. In this embodiment, the at least one filter may comprise a base plate or another stabilizing mechanism (not depicted) to help balance and maintain the modular filter assembly in an upright orientation as shown in FIGS. 9A and 9B.

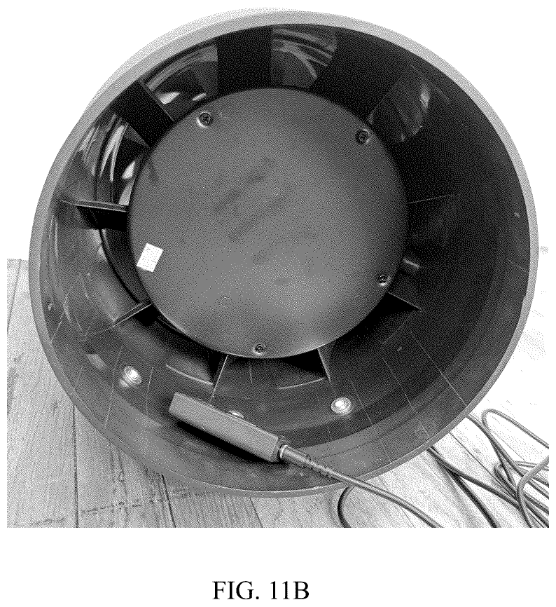

In one embodiment, as shown in FIG. 10, the at least one fan comprises two or more stacked fans. In one embodiment, the modular filter assembly comprises at least one threaded fastener (41) (e.g., a threaded rod) for releasably interconnecting each fan, wherein each threaded fastener is coupled to a periphery of each fan and maintains a distance of about 0.01 inches or more, about 0.1 inches or more, about 0.2 inches or more, about 0.3 inches or more, about 0.4 inches or more, about 0.5 inches or more, about 0.75 inches or more, or about 1 inch or more is interposed between each fan. In one embodiment, each fan has a flange (42) with one or more apertures (43). When two or more fans are stacked, these apertures on adjacent flanges can be aligned such that a threaded fastener (41) is able to be inserted through two or more concentrically aligned apertures. In this embodiment, the spacing between adjacent fans can be maintained by the threaded fastener by using at least one washer (41a) and at least one nut (41b) to fasten each fan to the threaded fastener in place relative to one another in order to maintain the spaced distance.

In another embodiment, the weight (gravity) of the at least one fan and/or at least one filter is used to seal the interfaces between fans and filters around their respective peripheries formed by contact between the respective surfaces. In another embodiment as shown in FIG. 11C, one or more pieces of tape, plastic, metal, or any other piece of a material with tensile strength can be attached to tightly join or couple the cylindrical surfaces of the at least one fan and/or at least one filter, which are about the same shape and diameter, by applying pressure across the peripheral interface to substantially seal the interface therebetween in a material-efficient manner. In another embodiment, as shown in FIG. 11D, an L-shaped bracket, which may be attached with adhesive, tape (or other means known to the skilled artisan), can be used to tightly connect cylindrical surfaces to annular surfaces of the at least one fan and/or at least one filter of differing diameters, which by applying pressure across the peripheral interface, substantially seals the interface therebetween in a material-efficient manner.

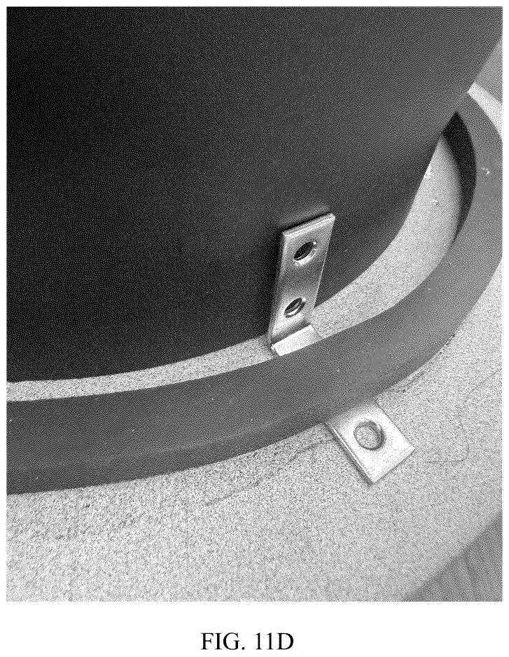

In one embodiment, as shown in FIG. 12, the at least one filter is a cylindrical filter. In one embodiment, the cylindrical filter is a cartridge filter. The cylindrical filter may have a cross-sectional shape that is one of substantially circular, substantially square, substantially triangular or any other similar cross-sectional shape known to the skilled artisan.

In one embodiment, each cylindrical filter comprises a vapor contamination filter layer (46) concentrically arranged with the aerosolized contamination filter layer (47). In one embodiment, the vapor contamination filter layer has a thickness ranging from about 1 to about 5 inches. In one embodiment, the cylindrical filter further comprises a pre-filter layer (48) to filter larger contaminants. In one embodiment, the inner most concentric layer is the vapor contamination filter layer when input airflow is being pulled through the at least one filter by the at least one fan (as shown in FIG. 9A). In another embodiment (not depicted), the inner most concentric layer is the pre-filter layer or the aerosolized contamination filter layer when input airflow is being pushed through the at least one filter by the at least one fan (as shown in FIG. 9B). In one embodiment, the aerosolized contamination filter and the vapor contamination filter are comprised in the same filter. In another embodiment, aerosolized particle filter and the vapor contamination filter are comprised in different filters. In one embodiment, the cylindrical filter is an M98 filter. In one embodiment, the cylindrical filter has a maximum diameter of about 8 inches to about 30 inches, preferably of about 10 inches to about 22 inches. In one embodiment, substantially all of the filter layers of the cylindrical filter collectively have a maximum diameter of about 8 inches to about 30 inches, preferably of about 10 inches to about 22 inches.

In one embodiment, the at least one cylindrical filter exchanges air with the immediately surrounding environment at an airspeed exceeding about 10 feet per minute or greater, preferably about 20 feet per minute or greater, more preferably about 30 feet per minute or greater, even more preferably about 50 feet per minute or greater, as measured within about 3 inches of the vertices of an equilateral triangle with side of length between about 7 inches and about 26 inches whose plane is substantially perpendicular to the cylindrical filter axis and within one inch of where the at least one cylindrical filter exchanges air with the immediately surrounding environment. Note an equilateral triangle with a side length of between about 7 inches and about 26 inches has vertices on a circle of diameter between about 8 inches and about 30 inches. By “immediately surrounding environment,” what is meant is a region of ambient air within about 5 feet, about 4.75 feet, about 4.50 feet, about 4.25 feet, about 4.00 feet, about 3.75 feet, about 3.50 feet, about 3.25 feet, about 3 feet, about 2.75 feet, about 2.50 feet, about 2.25 feet, about 2.00, about 1.75 feet, about 1.50, about 1.25 feet, or about 1.00 foot of the modular filter assembly and outside of the modular filter assembly.

In one embodiment, the at least one fan exchanges air with the immediately surrounding environment at an airspeed exceeding about 250 feet per minute or greater, preferably about 500 feet per minute or greater, more preferably about 1,000 feet per minute or greater, even more preferably about 2,000 feet per minute or greater as measured within about 3 inches of the vertices of an equilateral triangle with a side length of between about 7 inches and about 26 inches whose plane is substantially perpendicular to the cylindrical filter axis and within one inch of where the at least one fan exchanges air with the immediately surrounding environment.

In one embodiment, the clean air delivery rate of the modular filter assembly is about 100 CFM or greater, preferably about 200 CFM or greater, more preferably about 500 CFM or greater, and even more preferably about 700 CFM or greater as measured using air changes per hour with a test aerosol comprised of particles at about 0.3 microns in a test room having a size of about 2,000 cubic feet or greater.

In one embodiment, the clean air delivery rate of the modular filter assembly is about 100 CFM or greater, preferably about 200 CFM of greater, more preferably about 400 CFM or greater, and even more preferably about 500 CFM or greater as measured using air changes per hour with a test vapor in a test room having a size of about 2,000 cubic feet or greater.

In one embodiment a spacer tube (not depicted) for maintaining a distance greater than about 0.01 inches is interposed between each fan of the two or more stacked fans. In another embodiment, a spacer tube (not depicted) for maintaining a distance of about 0.01 inches or more, about 0.1 inches or more, about 0.2 inches or more, about 0.3 inches or more, about 0.4 inches or more, about 0.5 inches or more, about 0.75 inches or more, or about 1 inch or more is interposed between each filter of the two or more stacked filters. In one embodiment, the spacer tube is a tube having an inner diameter slightly larger than the outer diameter of the at least one filter and/or the at least one fan. In this embodiment, when filters and/or fans are stacked, an end of each adjacent filter and/or fan is inserted into an end of the spacer tube. In some embodiments, a spacer tube maybe comprised of cardboard, plastic, or other rigid or flexible material. In some embodiments, tape or another sealant is used to seal the interface between each end of the spacer tube and the respective end of the at least one filter and/or the at least one fan. In one embodiment, the spacer tube is a carboard tube.

In one embodiment, the at least one fan of the modular filter assembly may have a fan outlet shroud (60) (as shown in FIGS. 16B-C and previously recited) when input airflow is being pulled through the at least one filter by the at least one fan (as shown in FIG. 9A).

In one embodiment, a kit is provided comprising the modular filter assembly and the fan outlet shroud for the at least one fan.

In one embodiment, a kit is provided for the modular filter assembly comprising at least one filter, at least one fan, optionally at least one L-bracket, optionally at least one piece of a material with tensile strength, optionally at least one spacer tube, optionally at least one threaded fastener, and optionally at least one washer, and optionally at least one nut.

### 4. Wall-Adjacent Portable Air Cleaner

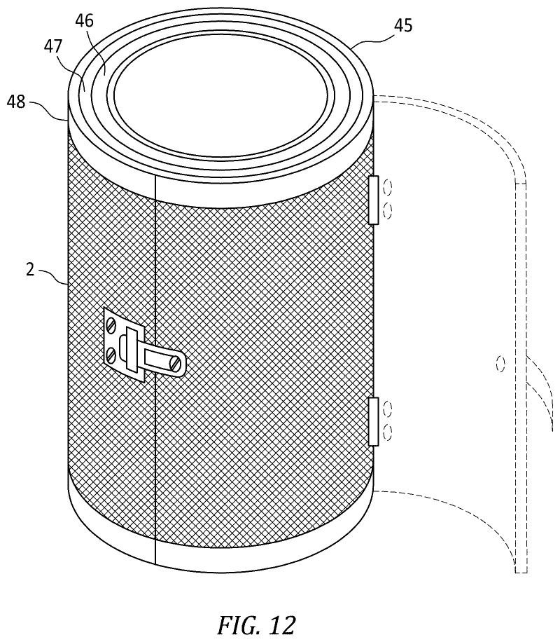

In FIGS. 13A-13B, a wall-adjacent portable air cleaner (i.e., a stackable assembly) is depicted that is stackable for maximizing floorspace efficiency in constrained spaces with about 15% more clean air delivery rate (CADR) as compared to the prior art. The prior art utilizes axial fans and filters on four or more sides of a cube (known as a Corsi-Rosenthal box) but in addition to consuming floorspace by not enabling stacking, its clean air delivery rate (CFM) is significantly reduced when one of the filters is also positioned near or adjacent to a wall or in a corner due to rapid recirculation between of air exiting the fan and entering the filter, resulting in suboptimal mixing of air within the room. The wall-adjacent portable air cleaner improves floor-space efficiency, especially when stacked vertically. The wall-adjacent portable air cleaner is able to protect occupants in a room from aerosol and vapor contamination.

In one embodiment, the wall-adjacent portable air cleaner comprises two lateral components (51), a front component (52) comprising at least one front seal capable of sealing or substantially sealing an interface between the front component and the two lateral components, and a back surface (53) that does not comprise an aerosolized contamination filter.

In one embodiment, a periphery of the back surface optionally comprises a back seal for sealing or substantially sealing an interface between the back surface and the wall (56), a top plate (54) comprising a top seal for sealing or substantially sealing an interface between the top plate, the two lateral components, and the front component, and a bottom plate (55) comprising a bottom seal for sealing or substantially sealing an interface between the bottom plate, the two lateral components, and the front component. In one embodiment, the seal can be formed from any of the sealing materials previously recited.

In one embodiment, the top plate (54) is plate that is not capable of filtering aerosolized contamination such as a piece of plywood, sheet metal, or any material known to the skilled artisan that would be suitable for this intended purpose but significantly less expensive than the cost of the filter.

In one embodiment, the back surface (53) is either an open face or a plate that is not capable of filtering aerosolized contamination such as a piece of plywood or sheet metal but significantly less expensive than the cost of the filter. As the skilled artisan would appreciate, by eliminating this aerosolized contamination filter (on back surface, top plate, and/or bottom plate) compared to a cube with filters on four of five sides, a significant a cost savings can be realized while still achieving high clean air delivery rates.

In one embodiment, at least one of the two lateral components and the front component comprises at least one filter (2) and at least one fan (1). In one embodiment, the at least one fan comprises an axial fan.

In one embodiment, the at least one filter and the at least one fan can be any combination of filter and fan previously recited to include any filter and fan configurations and any filter materials.

In one embodiment, the at least one fan can be a case fan, a box fan, two or more fans arranged in parallel, or any combinations of the foregoing. In one embodiment, the at least one axial fan has a fan speed ranging from about 200 to about 3,300 rotations per minute (rpm), wherein the at least one fan generates a volumetric output airflow rate ranging from about 45 to about 90 cubic feet per minute (CFM), and wherein the at least one fan generates a static pressure ranging from about 2 to about 5 millimeters of water (mm H₂O).

In one embodiment, any power source (22) previously discussed can be used to energize the at least one fan.

In one embodiment, as shown in FIGS. 13A-B, the wall-adjacent portable air cleaner (40a) generates an input airflow (5) and an output airflow (25a) via the at least one fan such that air is pulled through the at least one filter. However, in another embodiment, the wall-adjacent portable air cleaner may generate an input airflow (5) via the at least one fan such that air is pushed through the at least one filter.

As shown in FIG. 13A, in one embodiment, the front component comprises the at least one fan. In another embodiment, as shown in FIG. 13B, one of the two lateral components comprises the at least one fan. Compared to the embodiment in FIG. 13A, the embodiment in FIG. 13B can result in about 15% or more of an increased clean air delivery rate (CADR) due to more optimal mixing of air in the room compared to an alternative embodiment where all fans and filters are otherwise equivalent.

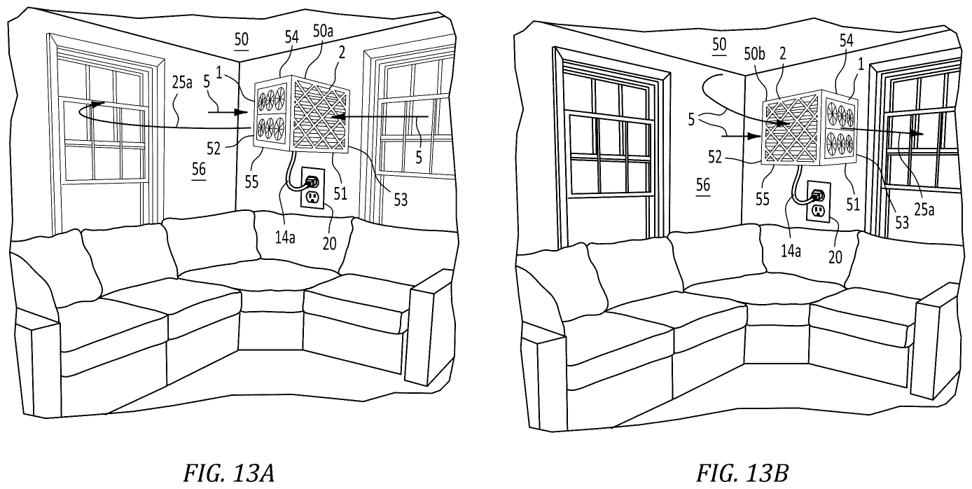

As shown in FIG. 14, the wall-adjacent portable air cleaner is stackable. In one embodiment, the wall-adjacent portable air cleaner may further comprise a wall attachment mechanism to anchor the wall-adjacent portable air cleaner to the wall. Any bracket or fastener known to the skilled artisan can be used as the wall attachment mechanism.

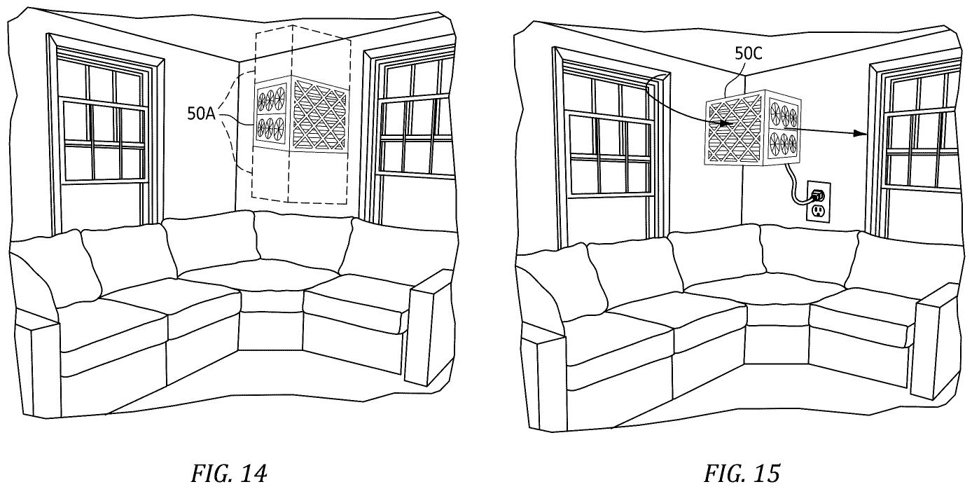

In one embodiment, as depicted in FIG. 15, the wall-adjacent portable air cleaner (50c) may be placed in the corner of the room to take greater advantage of the floor space. In such an embodiment, one of the two lateral components comprises a lateral plate (i.e., not capable of filtering aerosolized contamination but significantly less expensive than the cost of the filter) comprising a lateral seal capable of sealing or substantially sealing an interface between the bottom plate, the front component, and the top plate, such the other of the two lateral components comprises the at least one fan. In this embodiment, the lateral plate of the wall-adjacent portable air cleaner is disposed against the wall.

In one embodiment, the lateral plate is a plate that is not capable of filtering aerosolized contamination such as a piece of plywood, sheet metal, or any material known to the skilled artisan that would be suitable for this intended purpose but significantly less expensive than the cost of the filter.

In one embodiment, the at least one fan of the wall-adjacent portable air cleaner may have a fan outlet shroud (60) (as shown in FIGS. 16B-C and previously recited) when input airflow is being pulled through the at least one filter by the at least one fan (as shown in FIGS. 13A-B), the addition of which can further result in about 15% or more of an increased clean air delivery rate (CADR) due to more optimal mixing of air in the room compared to an alternative embodiment where all fans and filters are otherwise equivalent.

In one embodiment, a kit is provided comprising the wall-adjacent portable air cleaner and the fan outlet shroud for the at least one fan.

### 5. Hazardous Material Containment Apparatus

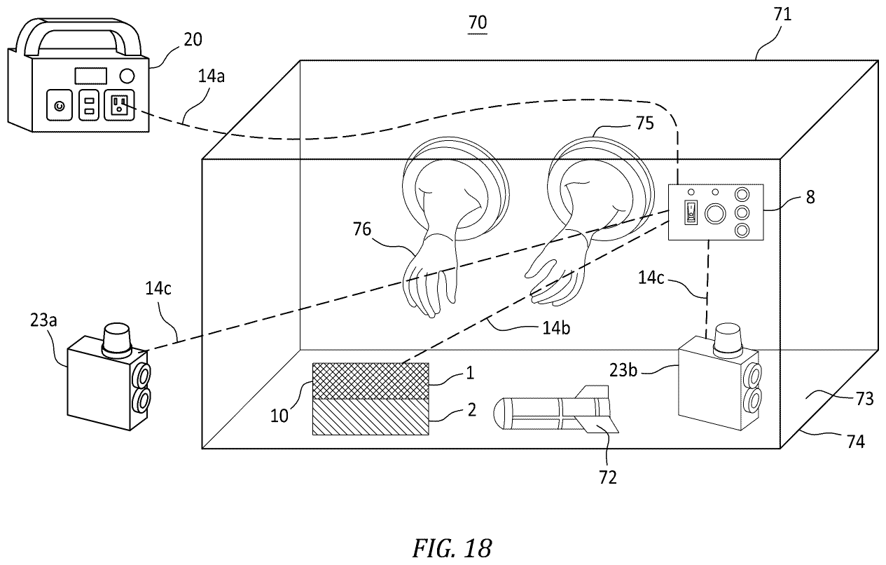

As shown in FIG. 18, in one embodiment, the air processing assembly (10) or one or more of the respiratory, skin, and eye protection devices previously recited can be implemented in a containment apparatus (70) for enclosing a hazardous material emitting air contamination. The air containment apparatus is at least semi-transparent, loosely or tightly sealed box with an air processing assembly system to redundantly suppress vapors or aerosol emanating from a contaminated, off gassing, or leaky object/spill on the ground or otherwise that cannot be touched, either indoors or outdoors.

A benefit to using such a containment apparatus is that it can allow visibility of the hazardous object, while suppressing vapor or aerosol spikes from contaminated or leaky object instances where the hazardous object cannot be defused, sealed, packed, and shipped easily until an explosive ordnance disposal (EOD) team or a hazardous material (HAZMAT) team is available.

The containment apparatus can reduce the risk for a disposal technician and those nearby who are lacking personal protective equipment by temporarily preventing leaks from an unexploded ordnance (UXO) or shell while the disposal technician formulates a plan to permanently defuse/seal the UXO.

In both a military and civilian setting, the containment apparatus would also be able to suppress vapor or aerosol spikes from the contaminated or leaky object identified inside COLPRO or SIP (indoors) without requiring contact, until emergency services or a disposal unit is available.

In one embodiment, the containment apparatus for enclosing a hazardous material emitting air contamination comprises an enclosure (71) for isolating the hazardous material (72) comprising at least three closed faces comprising at least a semi-transparent or a transparent material such that a sealed or substantially sealed connection is formed between each of the at least three closed faces, and an open face (73) for receiving the hazardous material when a periphery (74) of the open face contacts a surface supporting the hazardous material.

The enclosure may take any suitable shape and is not limited to the examples shown or described herein. For instance, the enclosure may be dome-shaped, cylindrical, rectangular, spherical, conical, polygonal, or an irregular or composite geometry. In some embodiments, the enclosure may include a domed upper portion to accommodate internal components or to facilitate airflow, fluid dynamics, or structural strength. The choice of enclosure shape may vary depending on design preference, functional requirements, or spatial constraints, and does not limit the scope of the invention. In one embodiment, the periphery of the open face comprises a sealant for forming a sealed or substantially sealed connection between the enclosure and the surface. In one embodiment, the seal can be formed from any of the sealing materials previously recited. In at least one embodiment, the sealant is selected from the group consisting of tape, duct tape, adhesive, caulking, gasketing, and one or more of the foregoing.

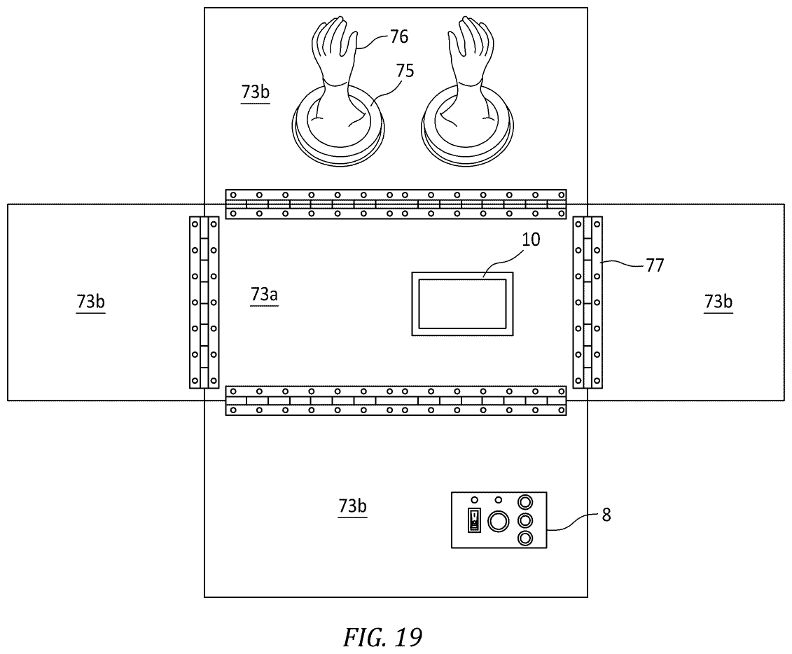

In one embodiment, the containment apparatus further comprises an air processing assembly (10) disposed on (as shown in FIG. 19) or enclosed within (as shown in FIG. 18) the enclosure comprising an air processing assembly inlet for receiving contaminated air in the enclosure, an air processing assembly outlet, and at least one fan (1) and at least one filter (2) coupled together between the air processing assembly inlet and the air processing assembly outlet, and substantially all air released from the air processing assembly outlet has been filtered by the at least one filter. In one embodiment, the at least one fan comprises an axial fan.

In one embodiment, the at least one filter and the at least one fan can be any combination of filter and fan previously recited to include any filter and fan configurations and any filter materials. In another embodiment, the air processing assembly is a Healthmate Plus™ (manufactured by Austin Air™). In at least one embodiment, the at least one fan generates an output airflow ranging from about 50 to about 400 cubic feet per minute (CFM).

In one embodiment, any power source (22) previously discussed can be used to energize the at least one fan.

In one embodiment, the at least one filter reduces contaminated air in the enclosure and comprises a vapor contamination filter configured to achieve a vapor contamination filtration efficiency of about 50% or greater, preferably about 95% or greater, for one or more of Novichok nerve agent (A232), thickened venomous nerve agent (TVX), sulfur mustard agent (HD), thickened sulfur mustard agent (THD), soman nerve agent (GD), and sarin nerve agent (GB).

In at least one embodiment, the at least three closed faces have a thickness ranging from about ¼ inch to about 4 inches. In one embodiment, the at least three closed faces are made of a material selected from the group consisting of acrylic, polycarbonate, polyethylene terephthalate glycol (PETG), polystyrene, and combinations of the foregoing.

In one embodiment, at least one of the at least three closed faces comprises at least one aperture (75) and at least one glove (76) disposed within the enclosure and coupled to a periphery of the at least one aperture such that a sealed or substantially sealed connection is formed between the at least one glove and the enclosure at the at least one aperture. In at least one embodiment, an operator of the containment apparatus disposed external to the enclosure is capable of inserting at least a hand into the enclosure through the at least one aperture and the at least one glove in order to better assess the hazardous material (e.g., manipulate a tool inside the enclosure).

As shown in FIG. 19, in at least one embodiment, the at least three closed faces comprise a top face (73a) and four lateral faces (73b) and the top face is opposite the open face such that each lateral face comprises a hinge connection (77) with the top face. In this embodiment, the enclosure is foldable to enable easy transport and expedient setup. In an embodiment where the air processing assembly is disposed on the enclosure such that either the air processing assembly outlet or the air processing assembly inlet is disposed outside of the enclosure and either the air processing assembly outlet or the air processing assembly inlet is disposed inside of the enclosure, a negative pressure can be generated within the enclosure to help seal or substantially seal the interface between the open face and the surface supporting the hazardous material.

In one embodiment, the at least one fan of the containment apparatus may have a fan outlet shroud (60) (as shown in FIGS. 16B-C and previously recited) when input airflow is being pulled through the at least one filter by the at least one fan.

In one embodiment, a kit is provided comprising the containment apparatus and the fan outlet shroud for the at least one fan.

### 6. Respiratory, Skin, and Eye Protection Device Operation and Monitoring

In one or more embodiments of the respiratory, skin, and eye protection device previously recited, the power source (22) is electrically connected to a controller (8) by a connection (14a) and the controller is electrically connected to the at least one fan by an electrical connection (14b). The power source may be alternating current (AC) power or may use a DC power source (e.g., a battery), photovoltaic power, or another power source known to the skilled artisan.

In one or more embodiments, previously recited, the controller may be disposed on an exterior of the respiratory, skin, and eye protection device so as to be accessible to a user. The controller may comprise a regulator for manually controlling one or more settings of the respiratory, skin, and eye protection device. For example, the one or more settings may be one or more of activating and deactivating power from the power source and, controlling the speed of the output airflow (25a) generated by the at least one fan and/or the speed of the at least one fan.

One or more embodiments of the respiratory, skin, and eye protection device previously recited may comprise one or more sensors electrically connected to the controller and optionally, an output. In one embodiment, the output is an array of light and/or audible indicators (8b) for displaying a light or generating a noise to alert the user when an event occurs. In another embodiment, the output is an onboard display (8c) such as a monitor that can provide a textual and/or graphical display based on the nature of the event. In another embodiment, a signal is transmitted through one or more networks to a remote computer system when an event occurs.

### A. Slow-Spin Protection Circuit

In one or more embodiments of the respiratory, skin, and eye protection device previously recited, a slow-spin protection circuit (SSPC) is utilized to prevent damage to a fan motor of the at least one fan. In one or more embodiments, the at least one fan comprises at least one axial fan. In another embodiment, the at least one fan comprises a mixed-flow fan. The SSPC also prevents injury to a user of the respiratory, skin, and eye protection device from excessive heat generated during a short-circuit.

When a foreign substance (i.e., debris) such as a small stone, a twig, or the like is caught in the fan and rotation of the fan is locked or slowed, so-called motor lock occurs in which the drive of the at least one fan motor is either stopped or slowed.

When the motor lock occurs, the electric current that flows in the at least fan motor is increased and a lock current (an electric current that flows in the motor at the time of overload: abnormal current) flows, which may cause damage to a fan motor and the like of the at least one fan motor, overheating, or injury to the user.

In this case, when an electric current that is equal to or higher than a fixed value keeps flowing even after a specified time has passed, measures are taken such as to incorporate a lock current control circuit which stops or reduces electric conduction to the at least one fan motor and thus prevents the lock current from being outputted from the fan motor to prevent the fan motor and the like from being damaged or from overheating.

In one or more embodiments of the respiratory, skin, and eye protection device previously recited, the one or more sensors may comprise one or more current sensors to detect a current value of the motor of the at least one fan.

In one or more embodiments, the one or more current sensors is electrically connected to the controller (8) by a connection (14c) which may be a wired or a wireless connection.

In regards to the SSPC, the one or more current sensors serving as a current detecting means compares a current value of the load current that flows in the at least one fan motor and a threshold current value, and when an abnormality is detected, a switch or a fuse breaks the circuit or reduces the current flow between the at least one fan motor and the power supply after a set time exceeding the time it normally takes for the at least one fan to reach its full speed from zero revolutions per minute.

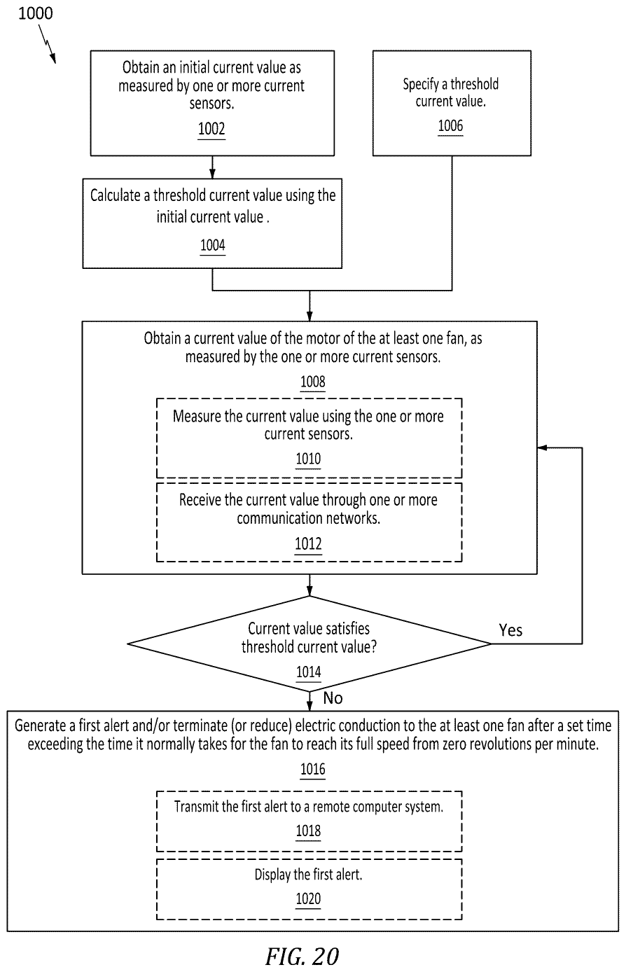

FIG. 20 is a flowchart showing an SSPC method (1000) of operating and monitoring one or more embodiments of the respiratory, skin, and eye protection device previously recited. The method (1000) may be performed by controller (8) (i.e., a computer system) that includes one or more processors and memory (e.g., a non-transitory computer-readable medium) storing instructions for execution by the one or more processors. The instructions include instructions for performing the method (1000).

In some embodiments of the method (1000), an initial current value of the fan motor is determined (1002) using one or more current sensors. A threshold current value is calculated (1004) using the initial current value. The initial current value may be taken by the one or more current sensors or may be combinations of repeated measurements taken by the one or more current sensors (as described below for step 1008). For example, the initial current value may be averages (e.g., means, geometric means, mean squares) or other statistical functions of the repeated measurements. The initial current value may be measured in the same manner as the current value of step 1008 (below). Alternatively, the threshold current value may be specified (1006).

As part of monitoring the one or more embodiments of the respiratory, skin, and eye protection device previously recited, a current value of the motor of the at least one fan is determined (1008) by one or more current sensors (e.g., the one or more current sensors of step 1002) (e.g., electrically connected to the motor of the at least one fan). For example, the one or more current sensors include (e.g., are) one or more amperage meters but the one or more current sensors can be any known sensor known to the skilled artisan capable of detecting a current in a fan motor. The current value may be an individual measurement taken by the one or more current sensors, or may be an average (e.g., mean, geometric mean, mean square) or other statistical functions of repeated measurements taken by the one or more current sensors.

In some embodiments, the method (1000) includes measuring (1010) the current value using the one or more current sensors. For example, in some embodiments, the computer system that performs the method (1000), and thus determines the current value, is communicatively coupled (e.g., by one or more communication busses) to the one or more current sensors and receives the current value from the one or more current sensors. In some embodiments, the current value is received (1012) from the one or more current sensors through one or more communication networks. In some embodiments, the current value may be determined (1008) after the current value has been calculated (1004) or specified (1006).

In some embodiments, a determination is made (1014) as to whether the current value satisfies (e.g., is less than) the threshold current value after a set time exceeding the time it normally takes for the at least one fan to reach its full speed from zero revolutions per minute (e.g., between about 1 and about 60 seconds). If the current value satisfies the threshold current value (1014—Yes), the method 1000 reverts to step (1008) and monitoring one or more embodiments of recited respiratory, skin, and eye protection devices continues. In response to a determination that the current value does not satisfy (e.g., is greater than, or equal to) the threshold current value (1014—No), in some embodiments a first alert is generated and/or electric conduction to the at least one fan is terminated (or reduced) if the current value does not satisfy the threshold current value after a set time exceeding the time it normally takes for the at least one fan to reach its full speed from zero revolutions per minute (i.e., between about 1 and about 60 seconds) (1016).

In some embodiments, the first alert is transmitted to a remote computer system (1018). For example, the computer system that performs the method (1000), and thus that generates the first alert, is a first computer system that transmits the first alert to a second computer system (e.g., a server system; a user's computer system device) remote from the first computer system for display by the second computer system.

In some embodiments, the first alert is displayed (1020). For example, the computer system that performs the method (1000), and thus that generates the first alert, includes a display; the computer system displays the first alert on the display. In some embodiments, the computer system may both display the first alert and transmit the first alert to a remote computer system. In some embodiments, the display may also be on onboard display on the one or more embodiments of recited respiratory, skin, and eye protection devices and/or an array of light and/or audible indicators.

In some embodiments, when it is determined that the current value does not satisfy the threshold current value, a signal is transmitted to a switch to terminate or reduce the electric conduction to the at least one fan motor either immediately when the current value does not satisfy the threshold current value or after a set amount of time of the current value not satisfying the threshold current value (e.g., exceeding the time it normally takes for the at least one fan to reach its full speed from zero revolutions per minute).

In some embodiments, when it is determined that the current value does not satisfy the threshold current value (e.g., is higher than the threshold current value), a signal is transmitted to adjust the speed of the at least one fan either immediately when the current value does not satisfy the threshold current value or after a set amount of time of the current value not satisfying the threshold current value (e.g., exceeding the time it normally takes for the at least one fan to reach its full speed from zero revolutions per minute).

In some embodiments, when the respiratory, skin, and eye protection device comprises two or more fans, a current value of the motor of each fan is determined by the one or more current sensors. If it is determined that the current value of one or more of the fans does not satisfy the threshold current value and the current value of one or more of the fans satisfies the threshold current value, then a signal is selectively transmitted to effectuate only the one or more of the fans that do not satisfy the threshold current value.

In some embodiments, a flowmeter (e.g., anemometer) is disposed at the at least one fan outlet and is used in conjunction with or instead of the current sensor to verify that the at least one fan is functioning properly (i.e., that the fan is generating the expected output airflow).

In one embodiment, the one or more sensors is a sensor for detecting one or more of a fouling amount of the at least one filter and a current of the at least one fan. In one embodiment, the controller is configured to adjust the speed of the at least one fan based on when one or more of a filter fouling threshold of the at least one filter is exceeded and the current threshold of the at least one fan is exceeded in relation to the set amount of time. In one embodiment, the one or more sensor that is capable of detecting the fouling amount of the at least one filter comprises a sensor disposed within the at least one filter and a sensor disposed external to the at least one filter. In one embodiment, the at least one filter is a cylindrical filter.

### B. Aerosol/Vapor Protection Circuit

In one or more embodiments of the respiratory, skin, and eye protection device previously recited, an aerosol/vapor protection circuit (AVPC) is utilized to monitor at least one aerosol/vapor agent in real-time and to identify the presence of these aerosol/vapor agents. In one embodiment, the AVPC provides an immediate alert before significant exposure occurs and allow for protective measures to be taken. As defined herein, an aerosol/vapor agent is either a vapor agent, an aerosol agent, or both a vapor agent and an aerosol agent.

Two or more embodiments of the respiratory, skin, and eye protection device previously recited can also be used as part of a network to facilitate and enhance early warning as well as support communal protection from aerosol/vapor agents.

In one or more embodiments of the respiratory, skin, and eye protection device previously recited, the one or more sensors may comprise at least one aerosol/vapor detection sensor (23) to detect the presence and/or the concentration of select aerosol/vapor agents including but not limited to Novichok nerve agent (A232), thickened venomous nerve agent (TVX), sulfur mustard agent (HD), thickened sulfur mustard agent (THD), soman nerve agent (GD), sarin nerve agent (GB), and one or more of the foregoing.

In one or more embodiments, the at least one aerosol/vapor detection sensor is electrically connected to the controller (8) by a connection (14c) which may be a wired or a wireless connection.

In one or more embodiments of the respiratory, skin, and eye protection device previously recited, the one or more sensors may be at least one aerosol/vapor detection sensor (23a) disposed external to the respiratory, skin, and eye protection device. For example, in some embodiments the at least one aerosol/vapor detection sensor (23a) is disposed external to an enclosure (17) as shown in FIG. 18. In another embodiment, at least one aerosol/vapor detection sensor (23a) is disposed external to the modular filter assembly to detect one or more of a presence of a specific vapor air contaminant and a total vapor air contamination concentration external to the modular filter assembly.

In another embodiment, at least one aerosol/vapor detection sensor (23a) is disposed external to the modular filter assembly to detect one or more of a presence of a specific aerosol air contaminant and a total aerosol air contamination concentration external to the modular filter assembly.

In one or more embodiments of the respiratory, skin, and eye protection device previously recited, the one or more sensors may be at least one aerosol/vapor detection sensor (23b) disposed internal to the respiratory, skin, and eye protection device. For example, in some embodiments, the at least one aerosol/vapor detection sensor (23b) is disposed internal to an enclosure (17) as shown in FIG. 18.

In one or more embodiments of the respiratory, skin, and eye protection device previously recited, the one or more sensors may be at least one aerosol/vapor detection sensor (23) disposed internal to the least one filter.

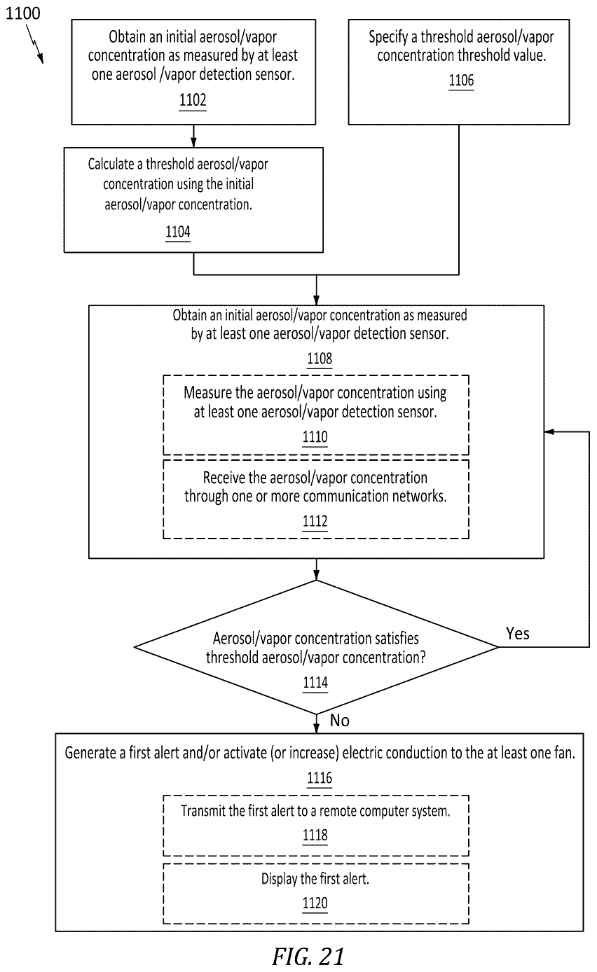

FIG. 21 is a flowchart showing an AVPC method (1100) of operating and monitoring one or more embodiments of the respiratory, skin, and eye protection device previously recited using at least one aerosol/vapor detection sensor. The method (1100) may be performed by controller (8) (i.e., a computer system) that includes one or more processors and memory (e.g., a non-transitory computer-readable medium) storing instructions for execution by the one or more processors. The instructions include instructions for performing the method (1100).

In some embodiments of the AVPC method (1100), an initial concentration of one or more aerosol/vapor agents are determined (1102) using at least one aerosol/vapor detection sensor. In some embodiments, a threshold concentration of one or more aerosol/vapor agents is calculated (1104) using the initial concentration of one or more aerosol/vapor agents. In some embodiments, the initial concentration of one or more aerosol/vapor agents may be taken by the at least one aerosol/vapor detection sensor or may be combinations of repeated measurements taken by the at least one aerosol/vapor detection sensor (as described below for step 1108). For example, the initial concentration of one or more aerosol/vapor agents may be averages (e.g., means, geometric means, mean squares) or other statistical functions of the repeated measurements. In some embodiments, the initial concentration of one or more aerosol/vapor agents may be measured in the same manner as the concentration of the one or more aerosol/vapor agents of step (1108) (below). Alternatively, the threshold concentration of one or more aerosol/vapor agents may be specified (1106).

In one embodiment, the threshold concentration of the one or more aerosol/vapor agents are as follows based on the chemical warfare agent (CWA) aerosol/vapor challenge levels established by the Department of the Air Force Instruction 10-2503:

| | CWA Vapor Challenge Levels |
|---|---|
| Agent | (mg-min/m³) |
| A232 | 6 |
| TVX | 12 |
| HD | 268 |
| THD | 160 |
| GD | 734 |
| GB (Sarin) | 100 |

In one or more embodiments, the threshold concentration of the one or more aerosol/vapor agents are based on about 1/10th the chemical warfare agent (CWA) vapor challenge levels established by the Department of the Air Force Instruction 10-2503:

| | CWA Vapor Challenge Levels |
|---|---|
| Agent | (mg-min/m³) |
| A232 | 0.6 |
| TVX | 1.2 |
| HD | 26.8 |
| THD | 16.0 |
| GD | 73.4 |
| GB (Sarin) | 10.0 |

In still other embodiments, the threshold concentration of the one or more aerosol/vapor agents are based on about 1/100th or about 1/1000th the chemical warfare agent (CWA) vapor challenge levels established by the Department of the Air Force Instruction 10-2503, or any fraction thereof.

As part of monitoring the one or more embodiments of recited respiratory, skin, and eye protection devices, in some embodiments, a concentration of the one or more aerosol/vapor agents is determined (1108) by at least one aerosol/vapor detection sensor (e.g., the at least one aerosol/vapor detection sensor of step 1102). In some embodiments, the at least one aerosol/vapor detection sensor may be located within the vicinity of the user, e.g., within a few feet, or may be disposed further away as part of a network, e.g., located on the military base. In at least one embodiment, the at least one aerosol/vapor detection sensor is physically coupled to one or more embodiments of recited respiratory, skin, and eye protection devices and in other embodiments, the at least one aerosol/vapor detection sensor is wirelessly detached.

For example, the at least one aerosol/vapor detection sensor includes (e.g., is) one or more Joint Chemical Agent Detector (JCAD) (also known as the M4A1) or Aerosol and Vapor Chemical Agent Detector (AVCAD) but can be any known chemical detection sensor known to the skilled artisan such as an ion mobility spectroscopy (IMS) detector, mass spectrometry detector, electrochemical detector an electrochemical detector, catalytic bead detector, photoionization detector, and infrared gas detector. The concentration of the one or more aerosol/vapor agents may be an individual measurement taken by the at least one aerosol/vapor detection sensor, or may be an average (e.g., mean, geometric mean, mean square) or other statistical functions of repeated measurements taken by the at least one aerosol/vapor detection sensor.

In some embodiments, the method (1100) includes measuring (1110) the concentration of the one or more aerosol/vapor agents using the at least one aerosol/vapor detection sensor. For example, the computer system that performs the method (1100), and thus determines the concentration of the one or more aerosol/vapor agents, is communicatively coupled (e.g., by one or more communication busses) to the at least one aerosol/vapor detection sensor and receives the concentration of the one or more aerosol/vapor agents from the at least one aerosol/vapor detection sensor. In some embodiments, the concentration of the one or more aerosol/vapor agents is received (1112) from the at least one aerosol/vapor detection sensor through one or more communication networks. In some embodiments, the concentration of the one or more aerosol/vapor agents may be determined (1108) after the concentration of the one or more aerosol/vapor agents has been calculated (1104) or specified (1106).

In some embodiments, a determination is made (1114) as to whether the concentration of the one or more aerosol/vapor agents satisfies (e.g., is less than) the threshold concentration of the one or more aerosol/vapor agents. If the concentration of the one or more aerosol/vapor agents satisfies the threshold concentration of the one or more aerosol/vapor agents (1114—Yes), the method (1100) reverts to step (1108) and monitoring one or more embodiments of recited respiratory, skin, and eye protection devices continues. In response to a determination that the concentration of the one or more aerosol/vapor agents does not satisfy (e.g., is greater than or equal to) the threshold concentration of the one or more aerosol/vapor agents (1014—No), in some embodiments, a first alert is generated and/or electric conduction is activated (or increased) to the at least one fan (1116).

In some embodiments, the first alert is transmitted to a remote computer system (1118). For example, the computer system that performs the method (1100), and thus that generates the first alert, is a first computer system that transmits the first alert to a second computer system (e.g., a server system; a user's computer system device) remote from the first computer system for display by the second computer system.

In some embodiments, the first alert is displayed (1120). For example, the computer system that performs the method (1100), and thus that generates the first alert, includes a display; the computer system displays the first alert on the display. In some embodiments, the computer system may both display the first alert and transmit the first alert to a remote computer system. In some embodiments, the display may also be on onboard display on the one or more embodiments of recited respiratory, skin, and eye protection devices and/or an array of light and/or audible indicators.

In some embodiments, when it is determined that the concentration of the one or more aerosol/vapor agents does not satisfy the threshold concentration of the one or more aerosol/vapor agents (e.g., is higher than the threshold concentration), a signal is transmitted to activate (or increase) electric conduction to the motor of at least one fan of the respiratory, skin, and eye protection device and/or to increase the speed of the output airflow (25a) generated by the at least one fan and/or the speed of the at least one fan (e.g., the rotation rate) in order to protect the user and/or other personnel who could be harmed by the detected aerosol/vapor agent. In one embodiment, the controller adjusts the speed of the at least one fan when one or more of the presence of a vapor air contaminant is detected external to the respiratory, skin, and eye protection device and the total vapor air contamination concentration threshold is exceeded external to the respiratory, skin, and eye protection device.

In one or more embodiments, the at least one fan comprises an axial fan. In another embodiment, the at least one fan comprises a mixed-flow fan. In one embodiment, the at least one filter and the at least one fan can be any combination of filter and fan previously recited to include any filter and fan configurations and any filter materials.

### EXAMPLES

The following examples further illustrate preferred embodiments of the respiratory, skin, and eye protection device.

### Example 1

A wearable personal respiratory, skin, and eye protection device as shown in FIG. 2 was assembled. A rectangular shaped aperture was formed in the brim of a standard baseball cap such that no brim material was left at the tip of the brim (U-shaped). The filter utilized was a Filtrete 20×20×1 AC Furnace Air Filter (manufactured by 3M) with a MERV rating value of 13. The filter was cut to a size of about 5 inches to about 5 inches to fit inside brim aperture. The axial fan utilized was the Arctic™ P12™ Case Fan. The width and length of the filter were larger than the width and length of the axial fan. The fan was stacked on top of the filter and the filter was coupled to the aperture to form the air processing assembly. The fan of the air processing assembly was tilted towards the user such that the airflow generated by the at least one axial fan would be tilted towards the user. The filter was sealed to the brim using tape and the fan was coupled to the filter using tape. The axial fan was powered by a 12-volt lithium-ion battery. The filter media of the filter was folded into a series of pleats.

The pleat orientation of the filter was such that the pleats are oriented parallel to a facing direction of the user when the wearable personal respiratory, skin, and eye protection device is worn by the user.

### Example 2

A similar personal respiratory, skin, and eye protection device was assembled as in Example 1 except an Arctic™ P12™ Max Case Fan was used was used instead of an Arctic™ P12™ Case Fan.

### Example 3

A similar personal respiratory, skin, and eye protection device was assembled as in Example 1 except two stacked filters were used of the same size and an Arctic™ P12™ Max Case Fan was used was used instead of an Arctic™ P12™ Case Fan. The Arctic™ P12™ Max Case Fan was stacked on top of the two filters.

### Example 4

A personal respiratory, skin, and eye protection device as shown in FIG. 3 was assembled. A rectangular shaped aperture was formed in the brim of a standard baseball cap such that no brim material was left at the tip of the brim (U-shaped). The filter utilized was a HEPA filter. The filter was cut to a size of about 5 inches to about 5 inches to fit inside brim aperture. Two stacked Arctic™ P12™ Max Case Fans were utilized. The width and length of the filter were larger than the width and length of the two axial fans stacked together. The two axial fans were stacked on top of the filter and the filter was coupled to the aperture. The filter was sealed to the brim using tape, the fan was coupled to the filter using tape, and the two axial fans were coupled to each other using tape. A half-face shield (i.e., the face shield covers from the top of the forehead down to the tip of the nose or the bottom lip) was coupled and sealed to the brim and the HEPA filter using tape. The axial fan was powered by a 12-volt lithium-ion battery.

### Example 5

A similar wearable personal respiratory, skin, and eye protection device was assembled as in Example 1 except the filter was cut to a size of about 5 inches to about 7 inches such that the filter was about 1.5 inches longer on either side of the axial fan when the axial fan is stacked on top of the filter.

The pleat orientation of the filter was also changed such that the pleats were oriented perpendicular to a facing direction of the user when the wearable personal respiratory, skin, and eye protection device is worn by the user.

### Example 6

A respiratory, skin, and eye protection sleeping device as shown in FIG. 7 was assembled. The canopy was formed out of a 24 inch×12 inch×6 inch cardboard box with the bottom of the cardboard box removed by a box cutter (i.e., the side opposite of the top with opening flaps). The canopy therefore had a ceiling, two lateral sides, and a floor. The air processing assembly was made by stacking first filter, a second filter, and an array of axial fans (arranged in order from the air processing assembly inlet to the air processing assembly outlet) into a second 24 inch×12 inch×6 inch cardboard box. The array of axial fans was formed using two rows of five Arctic™ P12™ Case Fans in parallel. The first filter was a Filtrete 12×24×1 AC Furnace Air Filter (manufactured by 3M) with a MERV rating value of 13. The second filter was a 12×24×4 Nordic Pure AC Furnace Filter (manufactured by Nordic Pure) with a MERV rating value of 13. The air processing assembly outlet guard, made of hardware cloth sized 0.5 inches, was disposed at the air processing assembly outlet and connected to the holes on corners of the axial fans using cable ties to hold them in place. Tape was used to seal the interfaces between the filters and the second cardboard box and between the open flaps of the first cardboard box and second cardboard box. Bedding was arranged on the floor of the canopy. The axial fans were powered by a 12-volt lithium-ion battery.

### Example 7

A fan outlet shroud and air processing assembly combination as shown in FIG. 17A was assembled. A 20-inch×20-inch base plate as shown in FIG. 16A was made from cardboard. An aperture of about 12 inches diameter was cut in the center of the base plate. An extension was made out of a cylindrical cardboard tube having a diameter of about 12 inches and a length of 6 inches was disposed concentrically on top of the base plate at the aperture. Tape was used to seal the interface between the extension and the base plate.

An air processing assembly was assembled by stacking a filter and an array of axial fans made of three rows of Arctic™ P12™ Case Fans in parallel, two rows of three fans on either side of one row of four fans, for a total of 10 fans. The filter was a 20×20×5 AC Healthy Climate Air Filter (manufactured by Lennox) with a MERV rating value of 13. The fan outlet shroud was then stacked with the air processing assembly such that the extension was disposed facing away from the air processing assembly outlet (i.e., the at least one axial fan outlet). Tape was used to seal the interfaces between the axial fans of the array of axial fans and between the air processing assembly outlet and the base plate. The axial fans were powered by a 12-volt lithium-ion battery.

### Example 8

A similar fan outlet shroud and air processing assembly combination as prepared in Example 7 was assembled except the fan outlet shroud extension extended 10-inches long as a cube with height and width 20 inches as shown in FIG. 16C.

### Example 9

A modular filter assembly as shown in FIG. 10 was assembled. The air processing assembly was made by stacking a radiator fan on top of a filter. In this instance, the radiator fan was a Spal 30101522 Puller Fan and the filter was the cylindrical filter cartridge used in a Healthmate Plus™ portable air cleaner (manufactured by Austin Air). It is noted that this filter comprises a HEPA filter with about 15 pounds of activated carbon. The radiator fan was powered by a 12-volt automotive battery. The diameter of the radiator fan and the diameter of the cylindrical filter cartridge were within 2 inches of each other. Tape was used to seal the interface between the fan and the filter around their periphery with a spacer tube in between made of cardboard about 2 inches thick wrapped around the circumference of the fan and filter. The radiator fan was oriented such that the generated air would be pulled through the filter and exhaust through the fan.

### Example 10

A similar modular filter assembly as prepared in Example 9 was assembled except two stacked radiator fans were used with spacer tubes in between made of plastic about 4 inches thick wrapped around the circumference of the fan and filter, and the two fans. Tape was used to seal the interface between both fans, between fan and filter, and respective spacer tubes in between around their periphery. In an alternative embodiment, the fans were aligned concentrically such that the four apertures (i.e., holes) in each fan housing (i.e., the flange) were also aligned, a threaded rod was inserted in each set of aligned holes, a washer and nut were used to couple each threaded rod to both a top and bottom of each flange at each aperture, the two fans were coupled to one another, cardboard was wrapped around the circumference of both fans, and tape was used to seal the interface between the two fans.

### Example 11

A similar modular filter assembly as prepared in Example 10 was assembled except four stacked radiator fans were used.

### Example 12

A similar modular filter assembly as prepared in Example 10 was assembled except eight stacked radiator fans were used and the spacer tubes between fans were made of cardboard about 2 inches thick.

### Example 13

A similar modular filter assembly as prepared in Example 10 was assembled except two stacked filters were used.

### Example 14

A similar modular filter assembly as prepared in Example 11 was assembled except two stacked filters were used.

### Example 15

A similar modular filter assembly as prepared in Example 11 was assembled except two of these assemblies were used in parallel.

### Example 16

A similar modular filter assembly as prepared in Example 10 was assembled except three stacked filters were used.

### Example 17

A similar modular filter assembly as prepared in Example 11 was assembled except three stacked filters were used.

### Example 18

A similar modular filter assembly as prepared in Example 10 was assembled except four stacked filters were used.

### Example 19

A similar modular filter assembly as prepared in Example 12 was assembled except three stacked filters were used.

### Example 20

A similar modular filter assembly as prepared in Example 9 was assembled except two stacked filters were used and two of these assemblies were used in parallel.

### Example 21

A similar modular filter assembly as prepared in Example 13 was assembled except two of these assemblies were used in parallel.

### Example 22

A similar modular filter assembly as prepared in Example 11 was assembled except four stacked filters were used.

### Example 23

A similar modular filter assembly as prepared in Example 10 was assembled except four of these assemblies were used in parallel.

### Example 24

A similar modular filter assembly as prepared in Example 14 was assembled except two of these assemblies were used in parallel.

### Example 25

A wall-adjacent portable air cleaner, similar to as shown in FIG. 13A, was assembled. A Nordic Pure 20×20×4 AC Furnace Air Filter with a MERV rating value of 13, was used for each of the two lateral components. The front component was an array of axial fans formed using two rows of five Arctic™ P12™ Case Fans in parallel. The top plate and the bottom plate were each a piece of cardboard and the back surface, adjacent to the wall, was an open surface (e.g., no plate or filter). All respective interfaces were sealed with tape. The wall-adjacent portable air cleaner was mounted to the wall. A 12-volt DC power source was used for the wall-adjacent portable air cleaner. In this configuration, the output airflow generated was perpendicular to the wall.

### Example 26

A wall-adjacent portable air cleaner, similar to as shown in FIG. 13B, was assembled. A Nordic Pure 20×20×4 AC Furnace Air Filter with a MERV rating value of 13, was used for one of the two lateral components and for the front component. One of the two lateral components was an array of axial fans formed using two rows of five Arctic™ P12™ Case Fans in parallel. The top plate and the bottom plate were each a piece of cardboard and the back surface, adjacent to the wall, was an open surface (e.g., no plate or filter). All respective interfaces were sealed with tape. The wall-adjacent portable air cleaner was mounted to the wall. A 12-volt DC power source was used for the wall-adjacent portable air cleaner. In this configuration, the output airflow generated was parallel to the wall.

### Example 27

A hazardous material containment apparatus, similar to as shown in FIG. 18, was assembled. The enclosure was a 3 foot×3 foot×3 foot plexiglass box made of 2-inch material. The bottom of the box was an open face. The interfaces between top and lateral components of the box were sealed with tape. A Healthmate Plus™ (manufactured by Austin Air™) was used as the air processing assembly and was disposed on the ground. The enclosure was placed on top of the air processing assembly so that bottom edges of the lateral components of the box contacted the ground and the enclosure surrounded the air processing assembly.

### Example 28

A similar hazardous material containment apparatus as prepared in Example 27 was assembled except tape was used to seal the interface between the enclosure and the ground.

### Example 29

A Healthmate Plus™ (manufactured by Austin Air™) portable air cleaner was used that included a fan having three discrete speed settings with 3 as the maximum. In operation, air is exchanged with the surrounding environment substantially horizontally on one vertical side of the air cleaner (instead of vertically), potentially allowing recirculation of air between outlet to the inlet. The portable air cleaner had a footprint of about 15 inches by about 15 inches, excluding the power cord, and had a vertical height of about 23 inches.

In Examples 30-33, weight (gravity) was used to seal the interfaces between the fans and filters around their respective peripheries formed by contact between the respective surfaces.

### Example 30

A modular filter assembly as shown in FIG. 10 was assembled. The modular filter assembly was made by stacking a mixed-flow fan on top of a filter situated on a floor. The mixed-flow fan was an AC Infinity 10-inch Cloudline™ Pro S10 duct fan and the filter was the cylindrical filter cartridge used in a Healthmate Plus™ portable air cleaner (manufactured by Austin Air™). This filter included a HEPA filter with about 10 pounds of activated carbon or more. The mixed-flow fan was powered by a 120-volt alternating current, and included a switch that permits adjustment to ten discrete speed settings from lowest (1) to maximum (10). The diameter of the mixed-flow fan was about 10 inches and air is exchanged with the surrounding environment upward within a circle substantially perpendicular to the central axis of the cylindrical filter and to the rotational axis of the fan. The diameter of the mixed-flow fan and the diameter of the cylindrical filter cartridge were within about 4 inches of each other. The weight of the mixed-flow fan (gravity) was used to seal the interface between the fan and the filter around their periphery, as well as the filter and the floor, formed by contact between the respective surfaces. The mixed-flow fan was oriented such that the generated airflow would be pulled through the filter and exhaust through the fan. The modular filter assembly had a footprint of about 14 inches by about 14 inches and had a vertical height of about 29 inches.

### Example 31

A similar modular filter assembly as prepared in Example 30 was assembled except that two stacked cylindrical filters were used. The modular filter assembly had a footprint of about 14 inches by about 14 inches and had a vertical height of about 43 inches.

### Example 32

A similar modular filter assembly as prepared in Example 31 was assembled except that two stacked mixed-flow fans were used. The portable air cleaner had a footprint of about 14 inches by about 14 inches and had a vertical height of about 57 inches.

### Example 33

A similar modular filter assembly as prepared in Example 30 was assembled except that three stacked cylindrical filters were used. The portable air cleaner had a footprint of about 14 inches by about 14 inches and had a vertical height of about 57 inches.

### Example 34

A modular filter assembly as shown in FIG. 10 was assembled. The modular filter assembly was made by stacking (in order from top to bottom) a mixed-flow fan, a cylindrical aerosolized particle filter, a cylindrical vapor filter, on a floor surface. The mixed-flow fan was an AC Infinity™ 10-inch Cloudline™ Pro S10 duct fan, the aerosolized particle filter was a square cylindrical filter (AC-AFB10 Air Filter Box, 10-inch manufactured by AC Infinity™), and the vapor contamination filter was a circular cylindrical filter of diameter about 10 inches (AC-DCF10, Duct Carbon Filter, Australian Charcoal, 10-Inch manufactured by AC Infinity™). The vapor contamination filter comprised activated carbon of about 10 pounds of activated carbon or more. The mixed-flow fan was powered by a 120-volt alternating current, and includes a switch that permits adjustment to ten discrete speed settings from lowest (1) to maximum (10). The diameter of the mixed-flow fan was about 10 inches where air is exchanged with the surrounding environment upward within a circle substantially perpendicular to the cylindrical filter axis of the cylindrical filter and to the rotational axis of the fan. The diameter of the mixed-flow fan and the diameter of the cylindrical filters were within about 4 inches of each other. Duct tape was used to seal the interface between the mixed flow fan and the aerosolized particle filter around their periphery since they did not fit securely, and would have toppled over without applying tape to seal the interface therebetween. The weight (gravity) of the mixed-flow fan and the aerosolized particle filter was used to seal the interface between the aerosolized particle filter and the vapor filter formed by contact between the respective surfaces. The mixed-flow fan was oriented such that the generated air would be pulled through the filter and exhaust through the fan. The floorspace occupied by the modular filter assembly fit within about 14 inches by about 14 inches and the vertical height was about 60 inches.

### Comparative Example 1

A similar wearable personal respiratory, skin, and eye protection device was assembled as in Example 3 except the air processing assembly was tilted away from the user by inserting a spacer between the forehead and the filters such that the airflow generated by the at least one axial fan would be tilted away from the user.

### Comparative Example 2

A similar respiratory, skin, and eye protection sleeping device was assembled as in Example 6 except the canopy was removed.

### Comparative Example 3

A similar fan outlet shroud and air processing assembly combination as prepared in Example 7 was assembled except the fan outlet shroud did not have an extension.

### EXPERIMENTS

In the following experiments, the air changes per an hour (ACH) of air filtration was measured using the process as described in “Pentagon Found Daily, Metagenomic Detection of Novel Bioaerosol Threats to Be Cost-Prohibitive: Can Virtualization and AI Make It Cost-Effective?,” authored by Devabhaktuni Srikrishna, the subject matter of which is herein incorporated by reference in its entirety.

### Experiment 1

A series of tests were conducted using the personal respiratory, skin, and eye protection devices of Examples 1-4 and Comparative Example 1.

In the first test, the user wore the wearable personal respiratory, skin, and eye protection device of Example 1 as shown in FIG. 2. Using a decibel meter, an ambient noise level was taken which measured between 34 to 39 dBA, when measured within about 3 inches from an ear of the user. The fan was then activated and another noise level measurement was taken. The airflow speed of the output airflow generated by the fan was tested within the inhalation zone at nose-level was also measured using an anemometer.

In order to determine the aerosol filtration efficiency of the personal respiratory, skin, and eye protection device for particles having a size of 0.3 μm, a Temptop PMD 331 ISO calibrated aerosol counter was used. An input reading was taken using the aerosol counter above the user and an output reading was taken within the inhalation zone (at nose level), for particles having a size of 0.3 μm.

Similar tests were conducted with the wearable personal respiratory, skin, and eye protection devices of Examples 2-4 and Comparative Example 1.

The results of these experiments are shown in the table below:

| Respiratory, | | Fan | | | |
|---|---|---|---|---|---|
| skin, and Eye | Noise | Airflow | Input | Output | Filtration |
| Protection | Measured | Speed | (particles | (particles | Efficiency |
| Device | (dbA) | (ft/min) | per liter) | per liter) | (%) |
| Example 1 | 41 | 157 | 22,051 | 3,566 | 84 |
| Example 2 | 58 | 354 | 35,613 | 8,253 | 76 |
| Example 3 | 57 | 276 | 8,340 | 265 | 97 |
| Example 4 | 63 | 216 | 4,783 | 34 | 99 |
| Comparative | 57 | 354 | 8,115 | 1,877 | 77 |
| Example 1 | | | | | |

The testing results show that the filtration efficiency is a function of filter capability at a given fan airflow speed. For instance, using the wearable personal respiratory, skin, and eye protection device of Example 1, a higher filtration efficiency was achieved at a lower fan airflow speed (as compared with Example 2), using the same filter. However, an even greater filtration efficiency was achieved in Experiment 3 when using two filters at a higher fan airflow speed. When using the wearable personal respiratory, skin, and eye protection device of Example 4, a superior filtration efficiency of 99% was achieved using a HEPA filter and a half-face shield. However, a noise level of 63 dBA may be unacceptable in some applications. In comparing the wearable personal respiratory, skin, and eye protection device of Example 3 and Comparative Example 1, the filtration efficiency was adversely impacted when the airflow generated by the axial fan was tilted away from the face of the user.

### Experiment 2

Tests were conducted using the personal respiratory, skin, and eye protection devices of Example 1 and Example 5.

The wearable personal respiratory, skin, and eye protection device of Example 1 (having parallel pleats) was orientated on a flat surface so that the bottom surface of the filter having the pleats was visible (i.e., surface closest to the inhalation zone). The fan was then activated to generate an output airflow. A Temptop PMD 331 ISO calibrated aerosol counter was used to measure the concentration of particles having a size of 0.3 μm. The concentration of 0.3 μm particles was measured to be 33,899 particles per liter on the edge of the filter closest the face of the user and was measured to be 540 particles per liter on an edge of the filter perpendicular to this edge (on the same filter surface).

Similar testing steps were used with the wearable personal respiratory, skin, and eye protection device of Example 5 (having perpendicular pleats). The concentration of 0.3 μm particles was measured to be 1,864 particles per liter on the edge of the filter closest the face of the user and was measured to be 1,709 particles per liter on an edge of the filter perpendicular to this edge (on the same filter surface).

The testing results show that the pleated filters oriented parallel to the facing direction of the user may cause the generated by the at least one axial fan to leak around the filter where it is cut, resulting in low filtration. Furthermore, the seal between the axial fan and the filter can be improved by orienting the pleats perpendicular to the facing direction of the user and adding a margin of about 1.5 inches or sizing the filter such that the filter extends past the axial fan in the direction of the pleats on both ends.

### Experiment 3

A series of tests were conducted using the respiratory, skin, and eye protection sleeping devices of Example 6 and Comparative Example 2.

In the first test, the user entered the respiratory, skin, and eye protection sleeping device of Example 6 as shown in FIG. 7. Using a decibel meter, an ambient noise level (i.e., when the fans were deactivated) was taken which measured at 39 dBA, when measured within about 3 inches from an ear of the user. The fans were then activated, and another noise level reading was taken which measured at 58 dBA. The airflow speed of the output airflow generated by the fan was tested within the inhalation zone at nose-level was also measured using an anemometer which measured at 138 ft/min.

In order to determine the aerosol filtration efficiency of the respiratory, skin, and eye protection sleeping device for particles of various seizes, a Temptop PMD 331 ISO calibrated aerosol counter was used. An input reading was taken using the aerosol counter outside of respiratory, skin, and eye protection sleeping device and an output reading was taken within the inhalation zone (at nose level), for particles having various sizes.

Similar aerosol filtration efficiency tests were conducted with the respiratory, skin, and eye protection sleeping device of Comparative Example 2.

The results of the filtration efficiency test with the respiratory, skin, and eye protection sleeping device of Example 6 (with the canopy) are shown in the table below:

| Particle Size | Input (particles | Output (particles | Filtration Efficiency |
|---|---|---|---|
| (μm) | per liter) | per liter) | (%) |
| 0.3 | 7,357 | 434 | 94 |
| 0.5 | 3,741 | 224 | 94 |
| 0.7 | 863 | 58 | 93 |
| 1.0 | 427 | 37 | 91 |

The results of the filtration efficiency test with the respiratory, skin, and eye protection sleeping device of Comparative Example 2 (without the canopy) are shown in the table below:

| | Input | Output | Filtration |
|---|---|---|---|
| Particle | (particles | (particles per | Efficiency |
| Size | per liter | liter) | (%) |
| 0.3 | 7,357 | 1,574 | 78 |
| 0.5 | 3,741 | 812 | 78 |
| 0.7 | 863 | 220 | 75 |
| 1.0 | 427 | 112 | 74 |

The testing results show removing the canopy that covers the user of the respiratory, skin, and eye protection sleeping device drops the filtration efficiency of particles sized 0.3 μm from about 94% to about 78%. To put this in perspective, the canopy increases the respiratory, skin, and eye protection by threefold. Without the canopy, the aerosolized particles are able to entrain or diffuse into the inhalation zone of the user from above and from the sides. The canopy helps to prevent ambient aerosolized particles from diffusing into the inhalation zone by allowing substantially laminar output airflow generated by the at least one axial fan to flow into the inhalation zone, but without interfering with the side-to-side head movement or breathing of the user.

### Experiment 4

A series of tests were conducted using the fan outlet shroud and air processing assembly combinations of Examples 7-8 and Comparative Example 3.

Using the same indoor space, the air changes per an hour (ACH) of air filtration was independently measured for each fan outlet shroud and air processing assembly combination.

The results of these tests are shown in the table below:

| Respiratory, Skin, and Eye Protection Device | ACH |
|---|---|
| Example 7 | 6.2 |
| Example 8 | 6.8 |
| Comparative Example 3 | 5.4 |

The test results demonstrate that adding the extension to the fan outlet shroud increased the ACH of the air processing assembly by about 11-20%.

### Experiment 5

A series of tests were conducted using the modular filter assemblies of Examples 9-24 in comparison with the Healthmate Plus™ portable air cleaner (manufactured by Austin Air). It is noted that the Healthmate Plus™ portable air cleaner can generate an airflow ranging between 75 and 400 CFM and the Spal 30101522 Puller Fan utilized in the present invention has a max airflow of 1328 CFM.

Using the same indoor space, the air changes per an hour (ACH) of air filtration was independently measured for the Healthmate Plus™ portable air cleaner and modular filter assemblies of Examples 9-24. The results of the tests are shown in the table below:

| Respiratory, Skin and Eye Protection Device | ACH |
|---|---|
| Healthmate Plus ™ | 2.95 |
| Example 9 (1 fan × 1 filter) | 4.80 |
| Example 10 (2 fans × 1 filter) | 6.20 |
| Example 11 (4 fans × 1 filter) | 6.70 |
| Example 12 (8 fans × 1 filter) | 8.70 |
| Example 13 (2 fans × 2 filters) | 12.35 |
| Example 14 (4 fans × 2 filter) | 13.75 |
| Example 15 (Two 4 fans × 1 filter) | 15.90 |
| Example 16 (2 fans × 3 filters) | 16.45 |
| Example 17 (4 fans × 3 filters) | 16.60 |
| Example 18 (2 fans × 4 filters) | 16.80 |
| Example 19 (8 fans × 3 filters) | 17.80 |
| Example 20 (Two 1 fan × 2 filters) | 18.10 |
| Example 21 (Two 2 fans × 2 filters) | 20.85 |
| Example 22 (4 fans x 4 filters) | 21.00 |
| Example 23 (Four 2 fans × 1 filter) | 22.05 |
| Example 24 (Two 4 fans × 2 filters) | 23.00 |

The test results how that the present invention, using only one radiator fan and one filter (Example 9), had an improved ACH of greater than 63% over the prior art (Healthmate Plus™). Furthermore, the present invention using, eight stacked fans with three stacked filters (Example 19), had an improved ACH of greater than about 503% over the prior art.

### Experiment 6

A series of tests were conducted using the wall-adjacent portable air cleaner of Examples 25 and 26. Using the same indoor space, the air changes per an hour (ACH) of air filtration was independently measured for the wall-adjacent portable air cleaner of Examples 25 and 26. The results of the tests are shown in the table below:

| Respiratory, Skin, and Eye Protection Device | ACH |
|---|---|
| Example 25 (airflow perpendicular to wall) | 5.85 |
| Example 26 (airflow parallel to wall) | 6.75 |

The test results show that the wall-adjacent portable air cleaner of the present invention had about a 15% improvement in ACH when changing the direction of the out airflow generated by the at least one axial fan to be parallel to the wall (e.g., Example 26).

### Experiment 7

A series of tests were conducted using the hazardous material containment apparatuses of Examples 27 and 28.

In the first series of tests, an aerosol seal test was performed to determine the seal of the hazardous material containment apparatus in relation to ambient aerosol. First the air processing assembly of Example 27 (without the ground seal) was energized (i.e., the at least one fan generated an airflow). A Temptop PMD 331 ISO calibrated aerosol counter was placed inside the enclosure and 1,100 particles per liter of aerosols at 0.3 μm were detected. Unless otherwise stated, all particle counts will be reported in this experiment as number of particles per liter at 0.3 μm. Next the air processing assembly of Example 28 (with the ground seal) was tested in a similar manner and 205 particles per liter of aerosols were detected. The ambient aerosol concentration was detected to be 21,992 particles per liter.

Based on aerosol seal tests, it was determined that since ambient aerosols are omnipresent in large quantities, the bottom of the enclosure permits aerosol leakage from outside the enclosure to inside the enclosure. It was also observed that about a 95% reduction in aerosols was achieved by running the air processing assembly inside the enclosure, even without sealing the enclosure to the ground (due outside-in leakage). It was further observed that about a 99% reduction in aerosols was achieved by running the air processing assembly inside the enclosure, after sealing it to the ground (further limiting outside-in leakage).

In the second series of tests, a vapor seal test was performed to determine the seal of the hazardous material containment apparatus in relation to a vapor generated within the enclosure. First, a Temptop M10 volatile organic compound meter was placed inside the enclosure and 5.00 milligrams per cubic meter (mg/m³) of volatile organic gas was generated within the enclosure. The air processing assembly of Example 27 (without the ground seal) was energized (i.e., the at least one fan generated an airflow). Temptop M10 volatile organic compound meter was placed outside the enclosure and 3.54 mg/m³ of volatile organic gas was detected outside of the enclosure while 5.00 mg/m³ of volatile organic gas was detected inside the enclosure. Next the air processing assembly of Example 28 (with the ground seal) was tested in a similar manner and 0.01 mg/m³ of volatile organic gas was detected outside of the enclosure while 0.82 mg/m³ of volatile organic gas was detected inside the enclosure.

Based on vapor seal tests, it was determined that since there are no (negligible) ambient vapors, unlike the aerosol seal test, the leakage of vapors from inside the enclosure to outside the enclosure can actually be measured directly adjacent to the enclosure. In contrast to the aerosol seal test, it was observed that without sealing the enclosure to the ground, the vapors produced inside the enclosure were not effectively prevented from escaping the enclosure with the air processing assembly (e.g., almost no reduction, 3.54 mg/m³ of volatile organic gas versus 5.00 mg/m³ of volatile organic gas). It was also observed that about a 98% reduction in vapors was achieved by running the air processing assembly inside the enclosure, after sealing it to the ground (further limiting inside-out leakage).

### Test Protocol:

In Experiment 8, the air filtration in air changes per an hour (ACH) was measured for a test aerosol and a test vapor using the following procedure in an unsealed, leaky test room having a volume measured to be about 2,961 cubic feet with windows and doors closed and the ventilation system disabled. The clean air delivery rate was estimated in cubic feet per minute (CFM). As noted herein, the use of a larger test room of about 3,000 cubic feet permits observation of the mixing effects from higher airspeed at the fan inlet or outlet where air is exchanged with the surrounding environment.

Test aerosols were generated by burning marshmallow in the test room (to generate smoke particulates). Test aerosol concentration was measured by optical particle counter (OPC) using a Temtop™ PMD 331™ calibrated by the manufacturer. The aerosol filtration efficiency of the filtered airflow when air passes through the filter when the fan of the modular filter assembly is in operation was measured within about 3 inches of the modular filter assembly outlet on a circle (of diameter about 10 inches) substantially perpendicular to the central axis of the cylindrical filter and to the rotational axis of the fan, using the test aerosol (comprised of particles at about 0.3 microns) relative to the test aerosol concentration outside the immediately surrounding environment. The aerosol filtration efficiency was estimated by the following formula:

$$Efficiency = 1 - ( \frac{aerosol concentration at outlet}{aerosol concentration in surrounding environment} )$$

Similarly, a test vapor was generated by allowing about 30 to about 60 milliliters of alcohol (vodka) to evaporate in the test room. Test vapor concentration was measured by photoionization detector (PID) using a TSI™ Omnitrak™ with volatile organic compound (VOC) module calibrated by the manufacturer. The vapor filtration concentration of the filtered airflow when air passes through the filter when the modular filter assembly is in operation was measured with test vapor within 3 inches of the outlet within a circle (of diameter about 10 inches) substantially perpendicular to the central axis of the cylindrical filter and to the rotational axis of the fan, relative to the test vapor concentration outside the immediately surrounding environment. The vapor filtration efficiency was estimated by the following formula:

$$Efficiency = 1 - ( \frac{vapor concentration at outlet}{vapor concentration in surrounding environment} )$$

The air changes per hour (ACH) for test aerosol and test vapors, respectively are determined based on the shape of the decay curve and asymptote of measurements from the OPC and PID in the test room. This test procedure to measure ACH is similar to but modified from the procedure described in “Pentagon Found Daily, Metagenomic Detection of Novel Bioaerosol Threats to Be Cost-Prohibitive: Can Virtualization and AI Make It Cost-Effective?,” written by Devabhaktuni Srikrishna.

The mathematical model for test aerosol or vapor concentration can be expressed in the following differential equation:

$$C ( t ) = \frac{E}{λ V} + [ C ( 0 ) - \frac{E}{λ V} ] {e}^{- λ t}$$

$$where :$$

$$C ( t ) = concentration of aerosol or vapor at time t$$

$$C ( 0 ) = initial concentration of aerosol or vapor at time 0$$

$$E = rate of aerosol or vapor “ leak ” into room ( per hour ) e . g . sourced \\ \\ from outside the test room or from desorption inside the test room$$

$$V = volume of test room$$

$$λ = ACH$$

$$e = base of the natural logarithm$$

All measurements were input into Google Sheets and compared to the model for ambient aerosol decay with different values of ACH and indoor aerosol leak rate as applicable. The aerosol concentration measurements representing C(t) were fitted by a computer program written in Python to obtain the best approximation for ACH(λ) and the rate of indoor leak (E/V) by minimizing the sum of percent error across each measurement. The volume (V) was estimated to be about 2,961 cubic feet per minute, from which the clean air delivery rate (CADR) for the test aerosol or test vapor was estimated by the following formula:

$$CADR = \frac{λ \times V}{60}$$

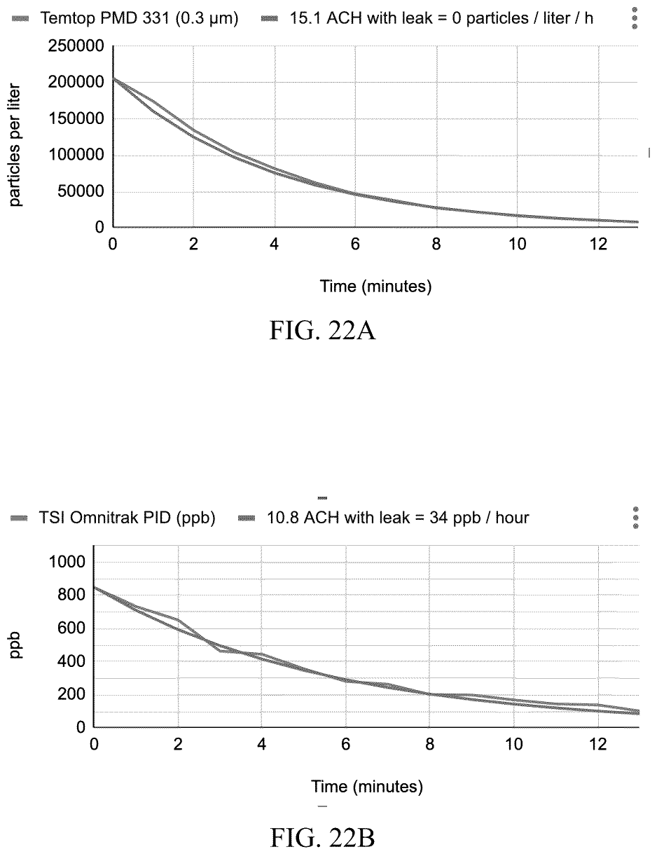

For illustration, the decay curve and fit minimizing the sum of percent error for aerosol and vapor measurements, respectively, is shown in FIGS. 22A-B for Test 8, described in more detail below.

Noise was measured for each test using an iPhone app by the National Institute for Occupational Safety and Health (NIOSH) at about a 9-inch distance from at least one fan perpendicular to the direction of the output airflow. Power consumed during each test was measured using a Kill-A-Watt™ device.

Since the cylindrical filter and fan were approximately radially symmetric, airspeed was substantially similar at points on a circle concentric with the central axis of the cylindrical filter. Airspeed was measured where air is exchanged between the mixed-flow fan and the surrounding environment at a point within 3 inches of the modular filter assembly outlet on a circle (of diameter about 10 inches) whose plane is substantially perpendicular to the central axis of the cylindrical filter and rotational axis of the fan, using a BTMETER™ BT-100™ Handheld Anemometer. Airspeed was measured at a point within 1 inch of where the cylindrical filter exchanges air with the immediately surrounding environment, also using a BTMETER™ BT-100™ Handheld Anemometer.

### Experiment 8

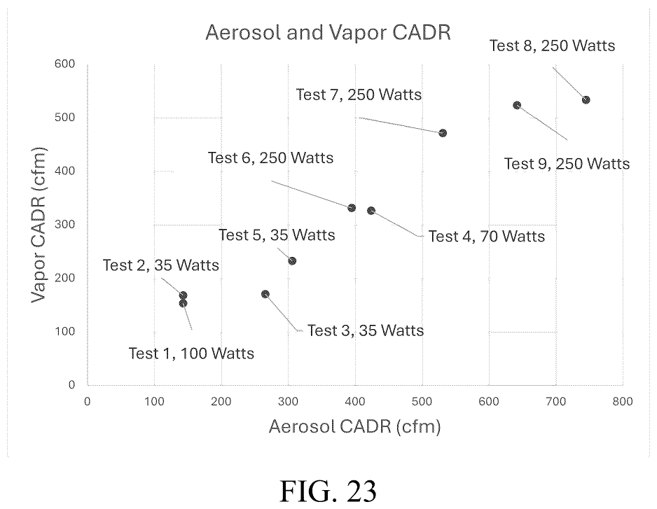

A series of tests were conducted using, comparatively, the Healthmate Plus™ portable air cleaner of Example 29 and the modular filter assemblies of the present invention (Examples 30-34). The modular filter assemblies of Examples 30-33 achieved a test aerosol filtration efficiency of about 87% and a test vapor filtration efficiency of about 96%. The modular filter assemblies of Example 34 achieved a test aerosol filtration efficiency of about 84% and a test vapor filtration efficiency of about 89%. In Examples 30-34, the airspeed was about 10 feet per minute or greater as measured within about 3 inches of the vertices of an equilateral triangle with side of length between about 7 inches and about 26 inches whose plane is substantially perpendicular to the central axis of the at least one substantially cylindrical filter and within one inch of where the at least one substantially cylindrical filter exchanges air with the immediately surrounding environment. In Examples 30-34, the airspeed was about 500 feet per minute or greater as measured within about 3 inches of the vertices of an equilateral triangle with side of length between about 7 inches and about 26 inches whose plane is substantially perpendicular to the central axis of the at least one substantially cylindrical filter and within one inch of where the at least one fan exchanges air with the immediately surrounding environment. The vapor and aerosol CADR measurements were derived from the ACH measured in the test room having a volume of about 2,961 cubic feet. The test results are shown in the table below, and based on the data in the table below, FIG. 23 charts the simultaneous change in vapor and aerosol CADR measurements across Test 1 to Test 9 alongside the power consumed (in the data labels):

| | | | Aerosol CADR | Vapor CADR | Airspeed | | |
|---|---|---|---|---|---|---|---|
| | | Fan | (estimated | (estimated | at Fan | | |
| | Example (length × | Speed | from ACH | from ACH | (feet per | Noise | Power |
| Test | width × height) | Setting | measured) | measured) | minute) | (dBA) | (watts) |
| 1 | Example 29: | 3 | 143 CFM | 153 CFM | n/a | 68 | 100 |
| | Healthmate Plus ™ | | (2.9/hour) | (3.1/hour) | | | |
| | (15″ × 15″ × 23″) | | | | | | |
| 2 | Example 30: | 4 | 143 CFM | 168 CFM | 630 | 63 | 35 |
| | 1 fan × 1 filter | | (2.9/hour) | (3.4/hour) | | | |
| | (14″ × 14″ × 29″) | | | | | | |
| 3 | Example 31: | 4 | 266 CFM | 170 CFM | 807 | 63 | 35 |
| | 1 fan × 2 filter | | (5.4/hour) | (3.45/hour) | | | |
| | (14″ × 14″ × 43″) | | | | | | |
| 4 | Example 32: | 4 | 424 CFM | 326 CFM | 1,142 | 65 | 70 |
| | 2 fan × 2 filter | | (8.6/hour) | (6.6/hour) | | | |
| | (14″ × 14″ × 57″) | | | | | | |
| 5 | Example 34: | 4 | 306 cfm | 232 cfm | 905 | 63 | 35 |
| | 1 fan × 2 filter | | (6.2/hour) | (4.7/hour) | | | |
| | (14″ × 14″ × 60″) | | | | | | |
| 6 | Example 30: | 10 | 395 CFM | 331 CFM | 1,595 | 83 | 250 |
| | 1 fan × 1 filter | | (8.0/hour) | (6.7/hour) | | | |
| | (14″ × 14″ × 29″) | | | | | | |
| 7 | Example 31: | 10 | 531 CFM | 471 CFM | 1,870 | 83 | 250 |
| | 1 fan × 2 filter | | (10.75/hour) | (9.6/hour) | | | |
| | (14″ × 14″ × 43″) | | | | | | |
| 8 | Example 33: | 10 | 745 CFM | 533 CFM | 2,146 | 83 | 250 |
| | 1 fan × 3 filter | | (15.1/hour) | (10.8/hour) | | | |
| | (14″ × 14″ × 58″) | | | | | | |
| 9 | Example 34: | 10 | 642 cfm | 523 cfm | 1,811 | 84 | 250 |
| | 1 fan × 2 filter | | (13.0/hour) | (10.6/hour) | | | |
| | (14″ × 14″ × 60″) | | | | | | |

The invention described by Examples 30-34 utilized no more floorspace than the prior art, Example 29. The test results show that the present invention, using only one mixed-flow fan with the same filter as in Example 29, on speed 4 (e.g., Test 2), consumed about a third of the power with similar CADR and about 5 dB less noise as the prior art (e.g., Test 1) and, on speed 10 (e.g., Test 6), delivered over double the CADR of the prior art (e.g., Test 1). The present invention using two fans with two stacked filters, on speed 4 (e.g., Test 4), consumed only about 70% of the power but produced over double the CADR as the prior art (e.g., Test 1). The present invention using one fan, on speed 10, with two (e.g., Test 7) or three (e.g., Test 8) stacked filters delivered over triple the CADR compared to the prior art (e.g., Test 1).

As compared to the Fan Filter Assembles (FFAs) of the prior art, the present invention (e.g., Tests 2-9) utilized no more floorspace with an order of magnitude lower power consumption to deliver about the same CADR. The present invention (e.g., Test 4) consumed only 70 watts and is about the same CADR as the FFA-400 but about 35 times more power-efficient in terms of CFM per watt.

As thus should now be understood by those skilled in the art, the present invention overcomes all of the aforementioned deficiencies while also providing the advantages mentioned herein as well as those advantages that should be understood by those skilled in the art.

Other advantages and objectives are deemed to be apparent from the disclosure herein. It should also be appreciated that the present invention can be implemented and utilized in numerous ways. While the present invention has been described with respect to preferred embodiments, those skilled in the art will readily appreciate that various changes and/or modifications can be made to the invention without departing from the scope of the invention.

Disclaimer: the resources and information from the disclosure herein and for informational purposes only and should not be construed as professional advice. The disclosure herein is intended to complement, not substitute, the advice of an individual's doctor. An individual should seek independent professional advice from a person who is licensed and/or qualified in the applicable area. No action should be taken based upon any information contained in the disclosure herein. Use of the content described herein is at an individual's own risk. The inventor is not associated with any of the manufacturers mentioned in the disclosure herein. The assignee takes no responsibility and assumes no liability for any content in the disclosure herein.

### Additional Embodiments

Clause 1: A modular filter assembly for filtering contamination from ambient air in the surrounding environment defined to be a region of ambient air within about 3 feet of the modular filter assembly and outside the modular filter assembly, comprising:
at least one fan with a maximum diameter less than about 30 inches as measured perpendicular to the rotational axis of the at least one fan;
at least one substantially cylindrical filter with maximum diameter between about 8 inches and about 30 inches, wherein the at least one substantially cylindrical filter comprises an aerosolized particle filter,
wherein at least one of the at least one substantially cylindrical filter comprises a vapor contamination filter, wherein the vapor contamination filter comprises activated carbon;
at least one inlet for receiving ambient air from the surrounding environment;
at least one outlet for releasing filtered air into the surrounding environment;
wherein the at least one fan is stacked with the at least one substantially cylindrical filter, wherein a cross-sectional shape of the substantially cylindrical filter is one of substantially circular, substantially square, substantially triangular or any other similar cross-sectional shape known to the skilled artisan, wherein a rotational axis of the at least one fan is substantially parallel to a central axis of the at least one substantially cylindrical filter,
wherein at least one point of the inlet and at least one point of the outlet are within about 30 inches of the central axis of the at least one substantially cylindrical filter,
wherein the airspeed is about 500 feet per minute or greater as measured within about 3 inches of the vertices of an equilateral triangle with side of length between about 7 inches and about 26 inches whose plane is substantially perpendicular to the central axis of the at least one substantially cylindrical filter and within about one inch of where the at least one fan exchanges air with the immediately surrounding environment,
wherein the airspeed is about 10 feet per minute or greater as measured within about 3 inches of the vertices of an equilateral triangle with side of length between about 7 inches and about 26 inches whose plane is substantially perpendicular to the central axis of the at least one substantially cylindrical filter and within one inch of where the at least one substantially cylindrical filter exchanges air with the immediately surrounding environment,
wherein the airspeed as measured simultaneously at another point in the immediately surrounding environment is less than about 10 feet per minute,
wherein the at least one fan substantially generates a filtered airflow at the outlet that has been substantially filtered by the at least one substantially cylindrical filter,
wherein the filtration efficiency of the filtered airflow is about 50% or greater as measured with a test aerosol comprised of particles having a size of about 0.3 microns relative to the test aerosol concentration outside the immediately surrounding environment, and
wherein the filtration efficiency of the filtered airflow is about 50% or greater as measured with test vapor relative to the test vapor concentration outside the immediately surrounding environment.
Clause 2: The modular filter assembly of Clause 1,
wherein the clean air delivery rate is about 100 CFM or greater as measured using air changes per hour with a test aerosol comprised of particles having a size of about 0.3 microns in a test room having a size of about 2,000 cubic feet or greater,
wherein the clean air delivery rate is about 100 CFM or greater as measured using air changes per hour with a test vapor in a test room having a size of about 2,000 cubic feet or greater,
wherein the modular filter assembly consumes about 35 watts or less,
wherein at least one fan generates less than about 70 dBA as measured at a point within about 9 inches of the at least one fan, and
wherein the dimensions of the modular filter assembly do not exceed about 30 inches by about 30 inches by about 45 inches
Clause 3: The modular filter assembly of Clause 1 or Clause 2,
wherein the clean air delivery rate is about 250 CFM or greater as measured using air changes per hour with a test aerosol comprised of particles having a size of about 0.3 microns in a test room having a size of about 2,000 cubic feet or greater,
wherein the clean air delivery rate is about 250 CFM or greater as measured using air changes per hour with a test vapor comprised of particles having a size of about 0.3 microns in a test room having a size of about 2,000 cubic feet or greater, wherein the modular filter assembly consumes about 250 watts or less,
wherein at least one fan generates less than about 90 dBA as measured at a point within about 9 inches of the at least one fan, and
wherein the dimensions of the modular filter assembly do not exceed about 30 inches by about 30 inches by about 30 inches.
Clause 4: The modular filter assembly of any of Clauses 1 to 3,
wherein the clean air delivery rate is about 200 CFM or greater as measured using air changes per hour with a test aerosol comprised of particles having a size of about 0.3 microns in a test room having a size of about 2,000 cubic feet or greater,
wherein the clean air delivery rate is about 200 CFM or greater as measured using air changes per hour with a test vapor comprised of particles having a size of about 0.3 microns in a test room having a size of about 2,000 cubic feet or greater,
wherein the modular filter assembly consumes about 70 watts or less,
wherein at least one fan generates less than about 70 dBA as measured at a point within about 9 inches of the at least one fan, and
wherein the dimensions of the at least one substantially cylindrical filter and at least one fan do not exceed about 30 inches by about 30 inches by about 70 inches.
Clause 5: The modular filter assembly of any of Clauses 1 to 4,
wherein the clean air delivery rate is about 400 CFM or greater as measured using air changes per hour with a test aerosol comprised of particles having a size of about 0.3 microns in a test room having a size of about 2,000 cubic feet or greater,
wherein the clean air delivery rate is about 400 CFM or greater as measured using air changes per hour with a test vapor comprised of particles having a size of about 0.3 microns in a test room having size of about 2,000 cubic feet or greater,
wherein the modular filter assembly consumes about 250 watts or less,
wherein at least one fan generates less than about 90 dBA as measured at a point within about 9 inches of the at least one fan, and
wherein the dimensions of the modular filter assembly do not exceed about 30 inches by about 30 inches by about 70 inches.
Clause 6: The modular filter assembly of any of Clauses 1 to 5, wherein the activated carbon filter comprises activated carbon impregnated with an impregnant selected from the group consisting of copper, silver, zinc, molybdenum, triethylenediamine (TEDA), zeolite, potassium iodine, and combinations of one or more of the foregoing.
Clause 7: The modular filter assembly of any of Clauses 1 to 6, wherein the test vapor is one or more of Novichok nerve agent (A232), thickened venomous nerve agent (TVX), sulfur mustard agent (HD), thickened sulfur mustard agent (THD), soman nerve agent (GD), and sarin nerve agent (GB).
Clause 8: The modular filter assembly of any of Clauses 1 to 7, wherein the at least one fan comprises a mixed-flow fan.
Clause 9: The modular filter assembly of any of Clauses 1 to 8, wherein the at least one fan comprises two or more stacked fans, wherein a seal is interposed between each of the two or more stacked fans for substantially sealing an interface therebetween.
Clause 10: The modular filter assembly of any of Clauses 1 to 9, wherein the at least one filter comprises two or more stacked filters, wherein a seal is interposed between each of the two or more stacked filters for substantially sealing an interface therebetween.
Clause 11: The modular filter assembly of any of Clauses 1 to 10, wherein the activated carbon that comprises the vapor contamination filter comprises at least about 10 pounds of activated carbon.
Clause 12: The modular filter assembly of any of Clauses 1 to 11, wherein the vapor contamination filter has a thickness ranging from about 1 to about 5 inches.
Clause 13: The modular filter assembly of any of Clauses 1 to 12, wherein the at least one substantially cylindrical filter comprises an M98 filter.
Clause 14: The modular filter assembly of any of Clauses 1 to 13, further comprising a controller comprising a regulator for manually activating or deactivating power from a power source electrically connected to the controller and the at least one fan.
Clause 15: The modular filter assembly of any of Clauses 1 to 14, further comprising at least one sensor for detecting one or more chemical, biological, radiation, nuclear, and explosive (CBRNE) contaminants.
Clause 16: The modular filter assembly of any of Clauses 1 to 15, further comprising at least one external sensor for detecting one or more of a presence of a specific vapor air contaminant and a total vapor air contamination concentration external to the modular filter assembly.
Clause 17: The modular filter assembly of any of Clauses 1 to 16, wherein the at least one fan is in signal communication with the controller, wherein the controller adjusts the speed of the at least one fan when one or more of the presence of a vapor air contaminant is detected external to the modular filter assembly and the total vapor air contamination concentration threshold is exceeded external to the modular filter assembly.
Clause 18: The modular filter assembly of any of Clauses 1 to 17, further comprising:
at least one sensor for detecting one or more of a fouling amount of the at least one substantially cylindrical filter and a current of the at least one fan; and
wherein the controller adjusts the speed of the at least one fan based on when one or more of a filter fouling threshold of the at least one substantially cylindrical filter is exceeded and the current threshold of the at least one fan is exceeded in relation to the set amount of time.
Clause 19: The modular filter assembly of any of Clauses 1 to 18, wherein the at least one sensor is capable of detecting the fouling amount of the at least one substantially cylindrical filter comprises a sensor disposed within the at least one substantially cylindrical filter and a sensor disposed external to the at least one substantially cylindrical filter.
Clause 20: The modular filter assembly of any of Clauses 1 to 19, further comprising at least one external sensor for detecting one or more of a presence of a specific aerosol air contaminant and a total aerosol air contamination concentration external to the modular filter assembly.
Clause 21: The modular filter assembly of any of Clauses 1 to 20,
wherein the clean air delivery rate is about 125 CFM or greater as measured using air changes per hour with a test aerosol comprised of particles having a size of about 0.3 microns in a test room having a size of about 2,000 cubic feet or greater,
wherein the clean air delivery rate is about 125 CFM or greater as measured using air changes per hour with a test vapor in a test room having a size of about 2,000 cubic feet or greater, and
wherein the dimensions of the modular filter assembly do not exceed about 30 inches by about 30 inches by about 30 inches.
Clause 22: The modular filter assembly of any of Clauses 1 to 21,
wherein the clean air delivery rate is about 150 CFM or greater as measured using air changes per hour with a test aerosol comprised of particles having a size of about 0.3 microns in a test room having a size of about 2,000 cubic feet or greater, and
wherein the clean air delivery rate is about 150 CFM or greater as measured using air changes per hour with a test vapor in a test room having a size of about 2,000 cubic feet or greater.
Clause 23: The modular filter assembly of any of Clauses 1 to 22,
wherein the clean air delivery rate is about 300 CFM or greater as measured using air changes per hour with a test aerosol comprised of particles having a size of about 0.3 microns in a test room having a size of about 2,000 cubic feet or greater, and
wherein the clean air delivery rate is about 300 CFM or greater as measured using air changes per hour with a test vapor comprised of particles having a size of about 0.3 microns in a test room having a size of about 2,000 cubic feet or greater.
Clause 24: The modular filter assembly of any of Clauses 1 to 23,
wherein the clean air delivery rate is about 300 CFM or greater as measured using air changes per hour with a test aerosol comprised of particles having a size of about 0.3 microns in a test room having a size of about 2,000 cubic feet or greater, and
wherein the clean air delivery rate is about 300 CFM or greater as measured using air changes per hour with a test vapor comprised of particles having a size of about 0.3 microns in a test room having a size of about 2,000 cubic feet or greater.
Clause 25: The modular filter assembly of any of Clauses 1 to 24,
wherein the clean air delivery rate is about 450 CFM or greater as measured using air changes per hour with a test aerosol comprised of particles having a size of about 0.3 microns in a test room having a size of about 2,000 cubic feet or greater,
wherein the clean air delivery rate is about 450 CFM or greater as measured using air changes per hour with a test vapor comprised of particles having a size of about 0.3 microns in a test room having size of about 2,000 cubic feet or greater, and
wherein the dimensions of the modular filter assembly do not exceed about 30 inches by about 30 inches by about 45 inches.
Clause 26: The modular filter assembly of any of Clauses 1 to 25,
wherein the clean air delivery rate is about 500 CFM or greater as measured using air changes per hour with a test aerosol comprised of particles having a size of about 0.3 microns in a test room having a size of about 2,000 cubic feet or greater, and
wherein the clean air delivery rate is about 500 CFM or greater as measured using air changes per hour with a test vapor comprised of particles having a size of about 0.3 microns in a test room having size of about 2,000 cubic feet or greater.
Clause 27: The modular filter assembly of any of Clauses 1 to 26, wherein the modular filter assembly consumes about 35 watts or less.
Clause 28: A modular filter assembly for filtering contamination from ambient air, comprising:
a modular filter assembly inlet for receiving ambient air;
a modular filter assembly outlet; and
at least one radiator fan stacked with at least one filter between the modular filter assembly inlet and the modular filter assembly outlet,
wherein the at least one filter comprises one or more filter cartridges,
wherein each of the one or more filter cartridges comprises a vapor contamination filter layer,
wherein the vapor contamination filter layer comprises an activated carbon layer,
wherein the at least one filter is configured to achieve a vapor contamination filtration efficiency of about 50% or greater,
wherein a seal is interposed between the at least one filter and the at least one radiator fan to substantially seal an interface therebetween; and
wherein the modular filter assembly substantially releases air in a surrounding environment that has been filtered by the at least one filter.
Clause 29: The modular filter assembly of Clause 28, wherein each of the one or more filter cartridges is a cylindrical filter cartridge.
Clause 30: The modular filter assembly of Clause 28 or Clause 29, wherein the activated carbon layer that comprises the vapor contamination filter layer of each filter cartridge comprises at least about 15 pounds of activated carbon.
Clause 31: The modular filter assembly of any of Clauses 28 to 30, wherein the vapor contamination filter layer of each filter cartridge has a thickness ranging from about 1 to about 5 inches.
Clause 32: The modular filter assembly of any of Clauses 28 to 31, wherein the at least one radiator fan is configured to generate an air flow of between about 0 and about 1275 cubic feet per minute (CFM) at a static pressure ranging from about 0 to about 1 millimeters of water (mm H₂O).
Clause 33: The modular filter assembly of any of Clauses 28 to 32, wherein the at least one radiator fan comprises two or more stacked radiator fans, wherein a seal is interposed between each of the two or more stacked filters for substantially sealing an interface therebetween.
Clause 34: The modular filter assembly of any of Clauses 28 to 33, wherein the at least one filter comprises two or more stacked filters, wherein a seal is interposed between each of the two or more stacked filters for substantially sealing an interface therebetween.
Clause 35: The modular filter assembly of any of Clauses 28 to 34, wherein a spacer tube is interposed between the at least one filter and the at least one radiator fan while maintaining the substantially sealing interface therebetween.
Clause 36: The modular filter assembly of any of Clauses 28 to 35, wherein a spacer tube is interposed between each of the two or more stacked radiator fans and between the at least one filter and the at least one radiator fan, wherein the spacer tube for maintaining a distance of at least about 1 inch between each of the two or more stacked radiator fans and between the at least one filter and the at least on radiator fan while maintaining the substantially sealing interface therebetween.
Clause 37: The modular filter assembly of any of Clauses 28 to 36, further comprising a threaded fastener arrangement for releasably interconnecting each radiator fan, wherein each threaded fastener is coupled to a periphery of the at least one radiator fan and maintains a distance of at least about 1 inch between each radiator fan.
Clause 38: A fan outlet shroud for a stacked filter and fan assembly comprising:
a base plate for covering an outlet of at least one axial fan, wherein a center of the base plate comprises a circular aperture, wherein a diameter of the circular aperture is smaller than a diameter of the outlet of at least one axial fan; and
an extension attached to the base plate at the circular aperture forming a sealed or substantially sealed connection, wherein the extension comprises a channel extending the length of the extension substantially through the center of the extension, wherein the at least one axial fan generates an airflow through the channel and the circular aperture.
Clause 39: The fan outlet shroud of Clause 38, wherein the circular aperture diameter ranges from about 10 to about 20 inches.
Clause 40: The fan outlet shroud of Clause 38 or Clause 39, wherein the channel length ranges from about 6 to 20 about inches.
Clause 41: The fan outlet shroud of any of Clauses 38 to 40, wherein the circular aperture diameter and the channel length are substantially the same size.
Clause 42: The fan outlet shroud of any of Clauses 38 to 41, wherein the extension is either a cube or a rectangular prism.
Clause 43: The fan outlet shroud of any of Clauses 38 to 42, wherein the extension is a cylinder.
Clause 44: The fan outlet shroud of any of Clauses 38 to 43, wherein the circular aperture diameter and a channel inner diameter are substantially the same.
Clause 45: The fan outlet shroud of any of Clauses 38 to 44, wherein the fan outlet shroud is usable with any Clause preceding Clause 38.

What is claimed is:

1. A modular filter assembly for filtering contamination from ambient air in the surrounding environment defined to be a region of ambient air within about 3 feet of the modular filter assembly and outside the modular filter assembly, comprising:
at least one fan with a maximum diameter less than about 30 inches as measured perpendicular to the rotational axis of the at least one fan;
at least one substantially cylindrical filter with maximum diameter between about 8 inches and about 30 inches, wherein at least one of the at least one substantially cylindrical filter comprises an aerosolized particle filter,
wherein at least one of the at least one substantially cylindrical filter comprises a vapor contamination filter, wherein the vapor contamination filter comprises activated carbon;
at least one inlet for receiving ambient air from the surrounding environment;
at least one outlet for releasing filtered air into the surrounding environment;
wherein the at least one fan is stacked with the at least one substantially cylindrical filter, wherein a cross-sectional shape of the substantially cylindrical filter is one of substantially circular, substantially square, substantially triangular or any other similar cross-sectional shape known to the skilled artisan, wherein a rotational axis of the at least one fan is substantially parallel to a central axis of the at least one substantially cylindrical filter,
wherein at least one point of the inlet and at least one point of the outlet are within about 30 inches of the central axis of the at least one substantially cylindrical filter,
wherein the airspeed is about 500 feet per minute or greater as measured within about 3 inches of the vertices of an equilateral triangle with side of length between about 7 inches and about 26 inches whose plane is substantially perpendicular to the central axis of the at least one substantially cylindrical filter and within one inch of where the at least one fan exchanges air with the immediately surrounding environment,
wherein the airspeed is about 10 feet per minute or greater as measured within about 3 inches of the vertices of an equilateral triangle with side of length between about 7 inches and about 26 inches whose plane is substantially perpendicular to the central axis of the at least one substantially cylindrical filter and within about one inch of where the at least one substantially cylindrical filter exchanges air with the immediately surrounding environment,
wherein the airspeed as measured simultaneously at another point in the immediately surrounding environment is less than about 10 feet per minute,
wherein the at least one fan substantially generates a filtered airflow at the outlet that has been substantially filtered by the at least one substantially cylindrical filter,
wherein the filtration efficiency of the filtered airflow is about 50% or greater as measured with a test aerosol comprised of particles having a size of about 0.3 microns relative to the test aerosol concentration outside the immediately surrounding environment, and
wherein the filtration efficiency of the filtered airflow is about 50% or greater as measured with test vapor relative to the test vapor concentration outside the immediately surrounding environment.

2. The modular filter assembly of claim 1,
wherein the clean air delivery rate is about 100 CFM or greater as measured using air changes per hour with a test aerosol comprised of particles having a size of about 0.3 microns in a test room having a size of about 2,000 cubic feet or greater,
wherein the clean air delivery rate is about 100 CFM or greater as measured using air changes per hour with a test vapor in a test room having a size of about 2,000 cubic feet or greater,
wherein the modular filter assembly consumes about 35 watts or less,
wherein at least one fan generates less than about 70 dBA as measured at a point within about 9 inches of the at least one fan, and
wherein the dimensions of the modular filter assembly do not exceed about 30 inches by about 30 inches by about 45 inches.

3. The modular filter assembly of claim 1,
wherein the clean air delivery rate is about 250 CFM or greater as measured using air changes per hour with a test aerosol comprised of particles having a size of about 0.3 microns in a test room having a size of about 2,000 cubic feet or greater,
wherein the clean air delivery rate is about 250 CFM or greater as measured using air changes per hour with a test vapor comprised of particles having a size of about 0.3 microns in a test room having a size of about 2,000 cubic feet or greater, wherein the modular filter assembly consumes about 250 watts or less,
wherein at least one fan generates less than about 90 dBA as measured at a point within about 9 inches of the at least one fan, and
wherein the dimensions of the modular filter assembly about 30 inches by about 30 inches by about 30 inches.

4. The modular filter assembly of claim 1,
wherein the clean air delivery rate is about 200 CFM or greater as measured using air changes per hour with a test aerosol comprised of particles having a size of about 0.3 microns in a test room having a size of about 2,000 cubic feet or greater,
wherein the clean air delivery rate is about 200 CFM or greater as measured using air changes per hour with a test vapor comprised of particles having a size of about 0.3 microns in a test room having a size of about 2,000 cubic feet or greater,
wherein the modular filter assembly consumes about 70 watts or less,
wherein at least one fan generates less than about 70 dBA as measured at a point within about 9 inches of the at least one fan, and
wherein the dimensions of the at least one substantially cylindrical filter and at least one fan do not exceed about 30 inches by about 30 inches by about 70 inches.

5. The modular filter assembly of claim 1,
wherein the clean air delivery rate is about 400 CFM or greater as measured using air changes per hour with a test aerosol comprised of particles having a size of about 0.3 microns in a test room having a size of about 2,000 cubic feet or greater,
wherein the clean air delivery rate is about 400 CFM or greater as measured using air changes per hour with a test vapor comprised of particles having a size of about 0.3 microns in a test room having size of about 2,000 cubic feet or greater,
wherein the modular filter assembly consumes about 250 watts or less,
wherein at least one fan generates less than about 90 dBA as measured at a point within about 9 inches of the at least one fan, and
wherein the dimensions of the modular filter assembly do not exceed about 30 inches by about 30 inches by about 70 inches.

6. The modular filter assembly of claim 1, wherein the activated carbon filter comprises activated carbon impregnated with an impregnant selected from the group consisting of copper, silver, zinc, molybdenum, triethylenediamine (TEDA), zeolite, potassium iodine, and combinations of one or more of the foregoing.

7. The modular filter assembly of claim 1, wherein the test vapor is one or more of Novichok nerve agent (A232), thickened venomous nerve agent (TVX), sulfur mustard agent (HD), thickened sulfur mustard agent (THD), soman nerve agent (GD), and sarin nerve agent (GB).

8. The modular filter assembly of claim 1, wherein the at least one fan comprises a mixed-flow fan.

9. The modular filter assembly of claim 1, wherein the at least one fan comprises two or more stacked fans, wherein a seal is interposed between each of the two or more stacked fans for substantially sealing an interface therebetween.

10. The modular filter assembly of claim 1, wherein the at least one filter comprises two or more stacked filters, wherein a seal is interposed between each of the two or more stacked filters for substantially sealing an interface therebetween.

11. The modular filter assembly of claim 1, wherein the activated carbon that comprises the vapor contamination filter comprises at least about 10 pounds of activated carbon.

12. The modular filter assembly of claim 1, wherein the vapor contamination filter has a thickness ranging from about 1 to about 5 inches.

13. The modular filter assembly of claim 1, wherein the at least one substantially cylindrical filter comprises an M98 filter.

14. The modular filter assembly of claim 1, further comprising a controller comprising a regulator for manually activating or deactivating power from a power source electrically connected to the controller and the at least one fan.

15. The modular filter assembly of claim 14, further comprising at least one sensor for detecting one or more chemical, biological, radiation, nuclear, and explosive (CBRNE) contaminants.

16. The modular filter assembly of claim 14, further comprising at least one external sensor for detecting one or more of a presence of a specific vapor air contaminant and a total vapor air contamination concentration external to the modular filter assembly.

17. The modular filter assembly of claim 14, wherein the at least one fan is in signal communication with the controller, wherein the controller adjusts the speed of the at least one fan when one or more of the presence of a vapor air contaminant is detected external to the modular filter assembly and the total vapor air contamination concentration threshold is exceeded external to the modular filter assembly.

18. The modular filter assembly of claim 14, further comprising:
at least one sensor for detecting one or more of a fouling amount of the at least one substantially cylindrical filter and a current of the at least one fan; and
wherein the controller adjusts the speed of the at least one fan based on when one or more of a filter fouling threshold of the at least one substantially cylindrical filter is exceeded and the current threshold of the at least one fan is exceeded in relation to the set amount of time.

19. The modular filter assembly of claim 18, wherein the at least one sensor is capable of detecting the fouling amount of the at least one substantially cylindrical filter comprises a sensor disposed within the at least one substantially cylindrical filter and a sensor disposed external to the at least one substantially cylindrical filter.

20. The modular filter assembly of claim 14, further comprising at least one external sensor for detecting one or more of a presence of a specific aerosol air contaminant and a total aerosol air contamination concentration external to the modular filter assembly.

21. The modular filter assembly of claim 2,
wherein the clean air delivery rate is about 125 CFM or greater as measured using air changes per hour with a test aerosol comprised of particles having a size of about 0.3 microns in a test room having a size of about 2,000 cubic feet or greater,
wherein the clean air delivery rate is about 125 CFM or greater as measured using air changes per hour with a test vapor in a test room having a size of about 2,000 cubic feet or greater, and
wherein the dimensions of the modular filter assembly do not exceed about 30 inches by about 30 inches by about 30 inches.

22. The modular filter assembly of claim 2,
wherein the clean air delivery rate is about 150 CFM or greater as measured using air changes per hour with a test aerosol comprised of particles having a size of about 0.3 microns in a test room having a size of about 2,000 cubic feet or greater, and
wherein the clean air delivery rate is about 150 CFM or greater as measured using air changes per hour with a test vapor in a test room having a size of about 2,000 cubic feet or greater.

23. The modular filter assembly of claim 3,
wherein the clean air delivery rate is about 300 CFM or greater as measured using air changes per hour with a test aerosol comprised of particles having a size of about 0.3 microns in a test room having a size of about 2,000 cubic feet or greater, and
wherein the clean air delivery rate is about 300 CFM or greater as measured using air changes per hour with a test vapor comprised of particles having a size of about 0.3 microns in a test room having a size of about 2,000 cubic feet or greater.

24. The modular filter assembly of claim 4,
wherein the clean air delivery rate is about 300 CFM or greater as measured using air changes per hour with a test aerosol comprised of particles having a size of about 0.3 microns in a test room having a size of about 2,000 cubic feet or greater, and
wherein the clean air delivery rate is about 300 CFM or greater as measured using air changes per hour with a test vapor comprised of particles having a size of about 0.3 microns in a test room having a size of about 2,000 cubic feet or greater.

25. The modular filter assembly of claim 5,
wherein the clean air delivery rate is about 450 CFM or greater as measured using air changes per hour with a test aerosol comprised of particles having a size of about 0.3 microns in a test room having a size of about 2,000 cubic feet or greater,
wherein the clean air delivery rate is about 450 CFM or greater as measured using air changes per hour with a test vapor comprised of particles having a size of about 0.3 microns in a test room having size of about 2,000 cubic feet or greater, and
wherein the dimensions of the modular filter assembly do not exceed about 30 inches by about 30 inches by about 45 inches.

26. The modular filter assembly of claim 5,
wherein the clean air delivery rate is about 500 CFM or greater as measured using air changes per hour with a test aerosol comprised of particles having a size of about 0.3 microns in a test room having a size of about 2,000 cubic feet or greater, and
wherein the clean air delivery rate is about 500 CFM or greater as measured using air changes per hour with a test vapor comprised of particles having a size of about 0.3 microns in a test room having size of about 2,000 cubic feet or greater.

27. A modular filter assembly for filtering contamination from ambient air, comprising:
a modular filter assembly inlet for receiving ambient air;
a modular filter assembly outlet; and
at least one radiator fan stacked with at least one filter between the modular filter assembly inlet and the modular filter assembly outlet,
wherein the at least one filter comprises one or more filter cartridges,
wherein each of the one or more filter cartridges comprises a vapor contamination filter layer,
wherein the vapor contamination filter layer comprises an activated carbon layer,
wherein the at least one filter is configured to achieve a vapor contamination filtration efficiency of about 50% or greater,
wherein a seal is interposed between the at least one filter and the at least one radiator fan to substantially seal an interface therebetween; and
wherein the modular filter assembly substantially releases air in a surrounding environment that has been filtered by the at least one filter.

28. The modular filter assembly of claim 27, wherein each of the one or more filter cartridges is a cylindrical filter cartridge.

29. The modular filter assembly of claim 27, wherein the activated carbon layer that comprises the vapor contamination filter layer of each filter cartridge comprises at least about 15 pounds of activated carbon.

30. The modular filter assembly of claim 4, wherein the modular filter assembly consumes about 35 watts or less.
